(19) United States
(12) Patent Application Publication
(10) Pub. No.: US 2026/0129657 A1
(43) Pub. Date: May 7, 2026

(54) METHOD AND APPARATUS FOR TRANSMISSION AND RECEPTION OF CONTROL INFORMATION REPETITION IN SATELLITE COMMUNICATION SYSTEM

(71) Applicant: SAMSUNG ELECTRONICS CO., LTD., Suwon-si (KR)

(72) Inventors: Sungjin PARK, Suwon-si (KR); Hyoungju JI, Suwon-si (KR); Kyungjun CHOI, Suwon-si (KR)

(21) Appl. No.: 19/382,150

(22) Filed: Nov. 6, 2025

(30) Foreign Application Priority Data
Nov. 6, 2024 (KR) 10-2024-0156164

(51) Int. Cl. H04W 72/232; H04W 24/08; H04W 84/06

(52) U.S. Cl. CPC H04W 72/232; H04W 24/08; H04W 84/06

(57) ABSTRACT

The disclosure relates to a 5G or 6G communication system for supporting a higher data transmission rate. According to an embodiment, a method performed by a user equipment (UE) in a communication system includes receiving a synchronization signal/physical broadcast channel (SS/PBCH) block including a primary synchronization signal (PSS), a secondary synchronization signal (SSS) and a physical broadcast channel (PBCH); identifying whether physical downlink control channel (PDCCH) corresponding to type0 PDCCH common search space (CSS) is repeated based on one PBCH payload bit included in PBCH payload of the PBCH; and monitoring the PDCCH based on the identification.

### CROSS-REFERENCE TO RELATED APPLICATION

This application is based on and claims priority under 35 U.S.C. § 119 to Korean Patent Application No. 10-2024-0156164 filed on Nov. 6, 2024 in the Korean Intellectual Property Office, the disclosure of which is incorporated by reference herein in its entirety.

### BACKGROUND

### 1. Field

The disclosure relates to an operation of a user equipment (UE) and a base station in a satellite communication system. More particularly, the disclosure relates to a data information transmission and reception method in a satellite communication system and an apparatus that may perform the same.

### 2. Description of Related Art

5th generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

The disclosed embodiment is to provide an apparatus and method that may effectively provide services in a mobile communication system.

The disclosed embodiment provides an apparatus and method that may effectively provide services in a mobile communication system.

According to an embodiment, a method performed by a user equipment (UE) in a communication system comprising: receiving a synchronization signal/physical broadcast channel (SS/PBCH) block including a primary synchronization signal (PSS), a secondary synchronization signal (SSS) and a physical broadcast channel (PBCH); identifying whether physical downlink control channel (PDCCH) corresponding to type0 PDCCH common search space (CSS) is repeated based on one PBCH payload bit included in PBCH payload of the PBCH; and monitoring the PDCCH based on the identification.

According to an embodiment, wherein in case that a value of the one PBCH payload bit is 1, the PDCCH is repeated, and wherein in case that the value of the one PBCH payload bit is 0, the PDCCH is not repeated.

According to an embodiment, wherein the PBCH payload includes a₀, a₁, a₂, . . . , a_{A-1} PBCH payload bits associated with a higher layer and a_{A}, a_{A+1}, a_{A+2}, . . . , a_{A+7} PBCH payload bits associated with a physical layer, and wherein the one PBCH payload bit corresponds to a_{A+7}.

According to an embodiment, wherein in case that the PDCCH is repeated, a same PDCCH candidate for aggregation level in two consecutive slots provides same information for downlink control information (DCI) with cyclic redundancy check (CRC) scrambled by a system information radio network temporary identifier (SI-RNTI).

According to an embodiment, wherein the PDCCH is received in a non-terrestrial network (NTN).

According to an embodiment, a user equipment (UE) in a communication system comprising: a transceiver; and a processor coupled with the transceiver and configured to: receive a synchronization signal/physical broadcast channel (SS/PBCH) block including a primary synchronization signal (PSS), a secondary synchronization signal (SSS) and a physical broadcast channel (PBCH); identify whether physical downlink control channel (PDCCH) corresponding to type0 PDCCH common search space (CSS) is repeated based on one PBCH payload bit included in PBCH payload of the PBCH; and monitor the PDCCH based on the identification.

According to an embodiment, wherein in case that a value of the one PBCH payload bit is 1, the PDCCH is repeated, and wherein in case that the value of the one PBCH payload bit is 0, the PDCCH is not repeated.

According to an embodiment, wherein the PBCH payload includes a₀, a₁, a₂, . . . , a_{A-1} PBCH payload bits associated with a higher layer and a_{A}, a_{A+1}, a_{A+2}, . . . , a_{A+7} PBCH payload bits associated with a physical layer, and wherein the one PBCH payload bit corresponds to a_{A+7}.

According to an embodiment, wherein in case that the PDCCH is repeated, a same PDCCH candidate for aggregation level in two consecutive slots provides same information for downlink control information (DCI) with cyclic redundancy check (CRC) scrambled by a system information radio network temporary identifier (SI-RNTI).

According to an embodiment, wherein the PDCCH is received in a non-terrestrial network (NTN).

According to an embodiment, a method performed by a base station in a communication system comprising: transmitting a synchronization signal/physical broadcast channel (SS/PBCH) block including a primary synchronization signal (PSS), a secondary synchronization signal (SSS) and a physical broadcast channel (PBCH), wherein one PBCH payload bit included in PBCH payload of the PBCH indicates whether physical downlink control channel (PDCCH) corresponding to type0 PDCCH common search space (CSS) is repeated; and transmitting the PDCCH.

According to an embodiment, wherein in case that a value of the one PBCH payload bit is 1, the PDCCH is repeated, and wherein in case that the value of the one PBCH payload bit is 0, the PDCCH is not repeated.

According to an embodiment, wherein the PBCH payload includes a₀, a₁, a₂, . . . , a_{A-1} PBCH payload bits associated with a higher layer and a_{A}, a_{A+1}, a_{A+2}, . . . , a_{A+7} PBCH payload bits associated with a physical layer, and wherein the one PBCH payload bit corresponds to a_{A+7}.

According to an embodiment, wherein in case that the PDCCH is repeated, a same PDCCH candidate for aggregation level in two consecutive slots provides same information for downlink control information (DCI) with cyclic redundancy check (CRC) scrambled by a system information radio network temporary identifier (SI-RNTI).

According to an embodiment, wherein the PDCCH is transmitted in a non-terrestrial network (NTN).

According to an embodiment, a base station in a communication system comprising: a transceiver; and a processor coupled with the transceiver and configured to: transmit a synchronization signal/physical broadcast channel (SS/PBCH) block including a primary synchronization signal (PSS), a secondary synchronization signal (SSS) and a physical broadcast channel (PBCH), wherein one PBCH payload bit included in PBCH payload of the PBCH indicates whether physical downlink control channel (PDCCH) corresponding to type0 PDCCH common search space (CSS) is repeated; and transmit the PDCCH.

According to an embodiment, wherein in case that a value of the one PBCH payload bit is 1, the PDCCH is repeated, and wherein in case that the value of the one PBCH payload bit is 0, the PDCCH is not repeated.

According to an embodiment, wherein the PBCH payload includes a₀, a₁, a₂, . . . , a_{A-1} PBCH payload bits associated with a higher layer and a_{A}, a_{A+1}, a_{A+2}, . . . , a_{A+7} PBCH payload bits associated with a physical layer, and wherein the one PBCH payload bit corresponds to a_{A+7}.

According to an embodiment, wherein in case that the PDCCH is repeated, a same PDCCH candidate for aggregation level in two consecutive slots provides same information for downlink control information (DCI) with cyclic redundancy check (CRC) scrambled by a system information radio network temporary identifier (SI-RNTI).

According to an embodiment, wherein the PDCCH is transmitted in a non-terrestrial network (NTN).

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates the basic structure of a time-frequency domain in a wireless communication system according to an embodiment of the disclosure.

FIG. 2 illustrates the structure of a frame, a subframe, and a slot in a wireless communication system according to an embodiment of the disclosure.

FIG. 3 illustrates an example of a configuration of a bandwidth part in a wireless communication system according to an embodiment of the disclosure.

FIG. 4 illustrates an example of control area configuration of a downlink control channel in a wireless communication system according to an embodiment of the disclosure.

FIG. 5 illustrates the structure of a downlink control channel in a wireless communication system according to an embodiment of the disclosure.

FIG. 6 illustrates a case in which a user equipment (UE) may have a plurality of physical downlink control channel (PDCCH) monitoring positions within a slot through a span in a wireless communication system, according to an embodiment of the disclosure.

FIG. 7 illustrates an example of base station (BS) beam allocation according to a transmission configuration indication (TCI) state configuration in a wireless communication system according to an embodiment of the disclosure.

FIG. 8 illustrates an example of a method of allocating TCI states for a physical downlink control channel (PDCCH) in a wireless communication system according to an embodiment of the disclosure.

FIG. 9 illustrates the TCI indication medium access control (MAC) control element (CE) signaling structure for a PDCCH demodulation reference signal (DMRS) in a wireless communication system according to an embodiment of the disclosure.

FIG. 10 illustrates an example of a beam configuration of a control resource set (CORESET) and a search space in a wireless communication system according to an embodiment of the disclosure.

FIG. 11 is a diagram for explaining a method for a base station and a UE to transmit and receive data in consideration of a downlink data channel and rate matching resources in a wireless communication system according to an embodiment of the disclosure.

FIG. 12 is a diagram for explaining a method for a UE to select a receivable control resource set in consideration of priority when receiving a downlink control channel in a wireless communication system according to an embodiment of the disclosure.

FIG. 13 illustrates an example of an aperiodic channel state information (CSI) reporting method according to an embodiment of the disclosure.

FIG. 14 illustrates an example of physical uplink shared channel (PUSCH) repetition transmission type B in a wireless communication system according to an embodiment of the disclosure.

FIG. 15 illustrates the wireless protocol structure of a base station and a UE in single cell, carrier aggregation (CA), and dual connectivity (DC) situations in a wireless communication system according to an embodiment of the disclosure.

FIG. 16 illustrates an example of antenna port constitution and resource allocation for cooperative communication in a wireless communication system according to an embodiment of the disclosure.

FIG. 17 illustrates an example of downlink control information (DCI) constitution for cooperative communication in a wireless communication system according to an embodiment of the disclosure.

FIG. 18 illustrates a procedure for a base station to control transmission power of a UE in a cellular system.

FIG. 19 illustrates a process for a UE to generate a Type-1 (semi-static) HARQ-ACK codebook according to an embodiment of the disclosure.

FIG. 20 illustrates a process for a UE to generate a Type-2 (dynamic) HARQ-ACK codebook according to an embodiment of the disclosure.

FIG. 21 illustrates the Earth orbital period of a communication satellite according to the altitude or height of a satellite according to an embodiment of the disclosure.

FIG. 22 illustrates PDCCH repetition transmission according to an embodiment of the disclosure.

FIG. 23 illustrates Type 0 PDCCH CSS resources in a situation in which a total of four SS/PBCH blocks may be transmitted and received according to an embodiment of the disclosure.

FIG. 24 illustrates PDCCH repetition transmission according to an embodiment of the disclosure.

FIG. 25 illustrates PDCCH repetition transmission according to an embodiment of the disclosure.

FIG. 26 illustrates PDCCH repetition transmission according to an embodiment of the disclosure.

FIG. 27 illustrates PDCCH repetition transmission according to an embodiment of the disclosure.

FIG. 28 illustrates PDCCH repetition transmission according to an embodiment of the disclosure.

FIG. 29 illustrates PDCCH repetition transmission according to an embodiment of the disclosure.

FIG. 30 illustrates PDCCH repetition transmission according to an embodiment of the disclosure.

FIG. 31A is a UE flowchart for performing PDCCH repetition reception according to an embodiment of the disclosure.

FIG. 31B is a base station flowchart for performing PDCCH repetition transmission according to an embodiment of the disclosure.

FIG. 32 is a diagram illustrating the structure of a UE in a wireless communication system according to an embodiment of the disclosure.

FIG. 33 is a diagram illustrating the structure of a base station in a wireless communication system according to an embodiment of the disclosure.

### DETAILED DESCRIPTION

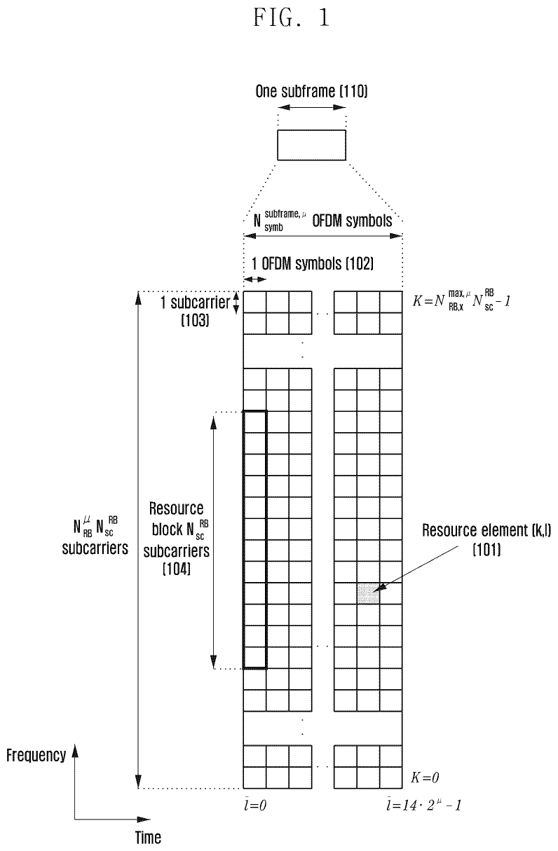

FIGS. 1 through 33, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure are described with reference to the accompanying drawings.

In describing embodiments, descriptions related to technical contents that are well-known in the art to which the disclosure pertains and are not directly associated with the disclosure will be omitted. Such an omission of unnecessary descriptions is intended to prevent obscuring of the main idea of the disclosure and more clearly convey the main idea.

Similarly, in the drawings, some components may be exaggerated, omitted, or schematically illustrated. Also, the size of each component does not completely reflect the actual size. In the drawings, identical reference numerals are assigned to identical or corresponding components.

The advantages and features of the disclosure and methods to achieve them will be apparent with reference to embodiments as described below in detail in conjunction with the accompanying drawings. However, the disclosure is not limited to the embodiments set forth below, but may be implemented in various different forms. The following embodiments are provided only to completely disclose and inform those skilled in the art of the scope of the disclosure, and the appended claims. Throughout the specification, the same or like reference numerals designate the same or like components. Also, in describing the disclosure, a detailed description of known functions or constitutions incorporated herein will be omitted when it is determined that the description may make the subject matter of the disclosure unnecessarily unclear. The terms that are described below are terms defined in consideration of the functions in the disclosure, and may be different according to users, intentions of the users, or customs. Therefore, the definitions of the terms should be made based on the contents throughout the specification.

In the following description, a base station (BS) is an entity that allocates resources to terminals, and may be at least one of a gNode B, an eNode B, a Node B, a BS, a wireless access unit, a BS controller, and a node on a network. A terminal may include a user equipment (UE), a mobile station (MS), a cellular phone, a smartphone, a computer, or a multimedia system capable of performing communication functions. In the disclosure, a “downlink (DL)” refers to a radio transmission link through which the BS transmits a signal to the terminal, and an “uplink” refers to a radio transmission link through which the terminal transmits a signal to the base station. Also, although the following description may be directed to a long term evolution (LTE) or LTE-A system by way of example, embodiments of the disclosure may also be applied to other communication systems having similar technical backgrounds or channel types to the embodiments of the disclosure. Examples of other communication systems may include 5G mobile communication technology (5G new radio (NR)) developed beyond LTE-A, and in the following description, “5G” may be a concept that covers exiting LTE, LTE-A, and other similar services. In addition, based on determinations by those skilled in the art, the disclosure may be applied to other communication systems through some modifications without significantly departing from the scope of the disclosure.

Herein, it will be understood that each block of flowchart illustrations and combinations of blocks in the flowchart illustrations may be implemented by computer program instructions. These computer program instructions may be provided to a processor of a general-purpose computer, a special purpose computer, or other programmable data processing apparatus to produce a machine, such that the instructions, executed via the processor of the computer or other programmable data processing apparatus, create a method for implementing the functions specified in the flowchart block(s). These computer program instructions may also be stored in a computer usable or computer-readable memory that may direct a computer or other programmable data processing apparatus to function in a particular manner, such that the instructions stored in the computer usable or computer-readable memory produce an article of manufacture including instruction implies that implement the function specified in the flowchart block(s). The computer program instructions may also be loaded onto a computer or other programmable data processing apparatus to cause a series of operational steps to be performed on the computer or other programmable apparatus to produce a computer implemented process such that the instructions executed on the computer or other programmable apparatus provide steps for executing the functions specified in the flowchart block(s).

Also, each block may represent a module, a segment, or a portion of code, which includes one or more executable instructions for executing the specified logical function(s). It should also be noted that in some alternative execution examples, the functions noted in the blocks may occur out of order. For example, two blocks shown in succession may in fact be performed simultaneously or the blocks may sometimes be performed in the reverse order, depending on the functionality involved.

Here, the term “unit” used herein refers to a software component or a hardware component, such as a field programmable gate array (FPGA) or an application specific integrated circuit (ASIC), which performs a predetermined function. However, the term “unit” does not always have a meaning limited to software or hardware. “unit” may be configured either to be stored in an addressable storage medium or to execute one or more processors. Therefore, “unit” includes, for example, components such as software components, object-oriented software components, class components, and task components, processes, functions, properties, procedures, sub-routines, segments of a program code, drivers, firmware, micro-codes, circuits, data, database, data structures, tables, arrays, and parameters. The components and functions provided by the “unit” may be combined into a smaller number of components and “units,”,” or further divided into additional components and “units.”.” In addition, the components and “units” may be implemented to reproduce one or more CPUs within a device or a security multimedia card. Also, the term “unit” in the embodiments may include one or more processors.

A wireless communication system has developed into a broadband wireless communication system that provides a high-speed and high-quality packet data service according to communication standards, for example, high-speed packet access (HSPA) of third generation partnership project (3GPP), LTE or evolved universal terrestrial radio access (E-UTRA), LTE-advanced (LTE-A), LTE-Pro, high rate packet data (HRPD) of 3GPP2, ultra mobile broadband (UMB), and 802.16e of the Institute of Electrical and Electronics Engineers (IEEE) beyond an initially provided voice-based service.

An LTE system, which is a representative example of the broadband wireless communication system, employs an orthogonal frequency division multiplexing (OFDM) scheme for downlink (DL), and employs a single carrier frequency division multiple access (SC-FDMA) scheme for uplink (UL). The uplink is a radio link through which a UE (or an MS) transmits data or a control signal to a base station (BS) (or an eNode B), and the downlink is a radio link through which the base station transmits data or a control signal to the UE. In the multiple access schemes as described above, time-frequency resources for carrying data or control information for each user are allocated and operated in a manner to prevent overlapping of the resources, that is, to establish orthogonality, to make it possible to identify data or control information of each user.

Snice a post-LTE communication system, that is, a 5G communication system, needs to be able to freely reflect various requirements of a user and a service provider, a service that satisfies the various requirements needs to be supported. Services that are considered for the 5G communication system include enhanced mobile broadband (eMBB), massive machine type communication (mMTC), and ultra reliability low latency communication (URLLC).

The eMBB aims to provide a further enhanced data transmission rate than a data transmission rate supported by LTE, LTE-A, or LTE-Pro. For example, in the 5G communication system, the eMBB needs to be able to provide a peak downlink data rate of 20 gigabits per second (Gbps) and a peak uplink data rate of 10 Gbps from the viewpoint of one base station. Also, the 5G communication system needs to provide not only a peak data rate but also an increased user-perceived data rate. In order to meet such requirements, improvement of various transmission/reception technologies, including a further improved multi input multi output (MIMO) transmission technology, is required. Also, while the current LTE system uses transmission bandwidths from a bandwidth of 2 GHz to a maximum bandwidth of 20 megahertz (MHz) to transmit signals, the 5G communication system uses a frequency bandwidth wider than 20 MHz in frequency bands of 3 to 6 GHz or 6 GHz or higher, whereby a data transmission rate required by the 5G communication system may be satisfied.

Also, in order to support an application service, such as the Internet of thing (IoT), mMTC is considered in the 5G communication system. The mMTC is required to support access of a large scale of UEs within a cell, improve coverage of a UE, increase a battery lifetime, and reduce the cost of the UE in order to efficiently provide IoT technology. Since the IoT is used in conjunction with various sensors and a variety of devices to provide communication functions, there is a need to support a large number of UEs (e.g., 1,000,000 UEs/km2) within a cell. Since the UE supporting the mMTC is highly likely to be located in a shaded area, such as a basement of a building, which a cell may not cover due to service characteristics, the mMTC may require wider coverage than other services provided by the 5G communication system. The UE supporting the mMTC needs to be produced at low cost and it is difficult to frequently exchange a battery of the UE. Thus, a long battery lifetime, for example, 10 to 15 years, may be required.

The URLLC is a cellular-based wireless communication service used for a specific (mission-critical) purpose. For example, services used for remote control of robots or machinery, industrial automation, unmanned aerial vehicles, remote health care, and emergency alerts may be considered. Accordingly, communication provided by the URLLC needs to provide very low latency and very high reliability. For example, services supporting the URLLC need to satisfy a radio access delay time (air interface latency) shorter than 0.5 milliseconds and also have requirements of a packet error rate of 10-5 or less. Accordingly, for services supporting the URLLC, the 5G system needs to provide a transmit time interval (TTI) smaller than that of other systems and also have design requirements of allocating a wide array of resources in a frequency band in order to guarantee reliability of a communication link.

Three services of 5G, that is, eMBB, URLLC, and mMTC, may be multiplexed and transmitted in one system. Here, in order to meet the different requirements of the respective services, different transmission/reception schemes and transmission/reception parameters may be used for the services. Of course, 5G is not limited to the above-described three service.

### [NR Time-Frequency Resources]

In the following, the frame structure of a 5G system is further described in detail with reference to drawings.

FIG. 1 illustrates the basic structure of a time-frequency domain that is a wireless resource area in which a data or control channel is transmitted in the 5G system.

In FIG. 1, a horizontal axis represents a time domain and a vertical axis represents a frequency domain. The basic unit of resources in the time domain and the frequency domain is a resource element (RE) 101 and may be defined as 1 orthogonal frequency division multiplexing (OFDM) symbol 102 in a time axis and 1 subcarrier 103 in a frequency axis. In the frequency domain,

$${N}_{SC}^{RB}$$

(e.g., 12) consecutive REs may correspond to one resource block (RB) 104.

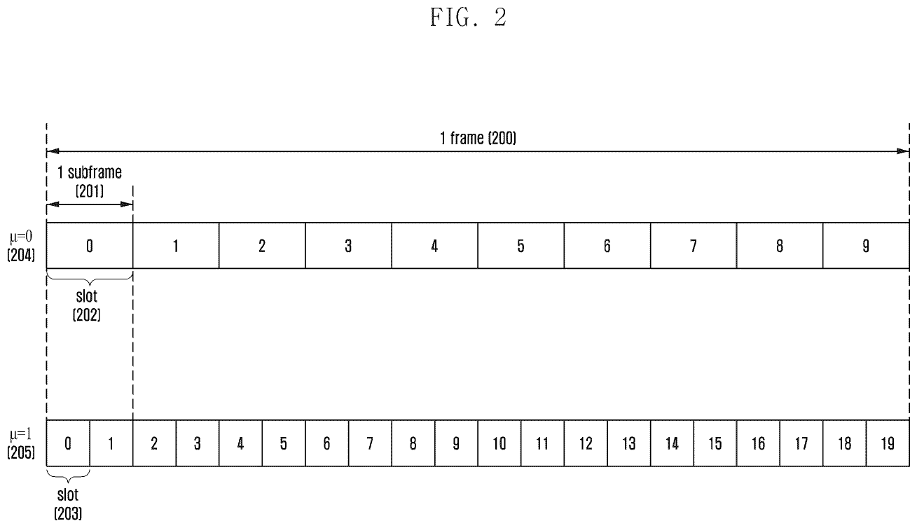

FIG. 2 illustrates the structure of a frame, a subframe, and a slot in a wireless communication system according to an embodiment of the disclosure.

FIG. 2 illustrates an example of the structure of a frame 200, a subframe 201, and a slot 202. One frame 200 may be defined as 10 milliseconds (ms). One subframe 201 may be defined as 1 ms, and accordingly one frame 200 may include a total of ten subframes 201. One slot 202, 203 may be defined as 14 OFDM symbols (i.e., the number of symbols

$${N}_{symb}^{slot}$$

per slot=14). One subframe 201 may include one or a plurality of slots 202 and 203, and the number of slots 202 and 203 per subframe 201 may vary depending on a subcarrier spacing configuration value μ (204, 205). The example of FIG. 2 illustrates a case in which μ=0 (204) and a case in which μ=1 (205) as the subcarrier spacing configuration value. One subframe 201 may include one slot 202 for μ=0 204, and one subframe 201 may include 2 slots 203 for μ=1 205. That is, the number

$$( {N}_{slot}^{subframe , μ} )$$

of slots per subframe may vary depending on the subcarrier spacing configuration value μ, and accordingly the number

$$( {N}_{slot}^{frame , μ} )$$

of slots per frame may vary. The number

$$( {N}_{slot}^{subframe , μ} )$$

and the number

$$( {N}_{slot}^{frame , μ} )$$

according to the subcarrier spacing configuration value μ may be defined as shown in Table 1 below.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Hereinafter, bandwidth part (BWP) configuration in the 5G communication system is described in detail with reference to the drawings.

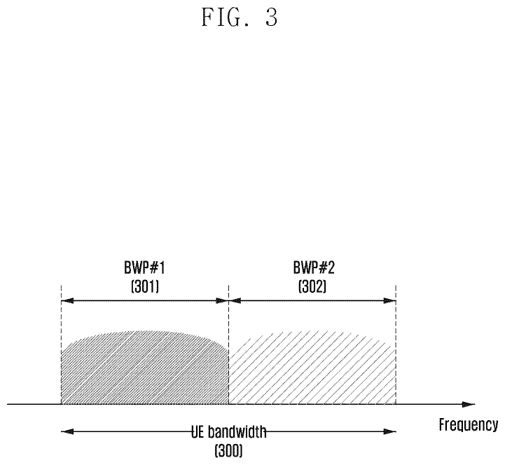

FIG. 3 illustrates an example of bandwidth part configuration in a wireless communication system according to an embodiment of the disclosure.

FIG. 3 shows an example in which a UE bandwidth 300 is configured as two bandwidth parts, that is, BWP #1 301 and BWP #2 302. A base station may configure one or a plurality of BWPs in a UE, and the following information provided below in Table 2 may be configured for each BWP.

TABLE 2

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, |

n4, n5},
(subcarrier spacing)

| | |
|---|---|
| cyclicPrefix | ENUMERATED { extended } |

```
      (cyclic prefix)
  }
```

Of course, the disclosure is not limited to the above-described examples, and various parameters related to a BWP as well as the configuration information may be configured in the UE. The information may be transmitted to the UE from the base station through higher layer signaling, for example, radio resource control (RRC) signaling. Among one or a plurality of configured BWPs, at least one BWP may be activated. Information indicating whether to activate the configured BWP may be semi-statically transferred from the base station to the UE through RRC signaling, or may be dynamically transferred through downlink control information (DCI).

According to some embodiments, the UE may receive a configuration of an initial BWP for initial access from the base station through a master information block (MIB) before RRC connection. More specifically, the UE may receive configuration information on a control area (hereinafter, control resource set (CORESET)) and a search space in which a physical downlink control channel (PDCCH) for receiving system information (which may correspond to remaining system information (RMSI) or system information block 1 (SIB1),) required for initial access through the MIB may be transmitted in an initial access stage. The control resource set and the search space configured as the MIB may be considered as identity (ID) 0. The base station may inform the UE of configuration information, such as frequency allocation information on control resource set #0, time allocation information, and numerology, through the MIB. Also, the base station may inform the UE of configuration information on a monitoring period and position of control resource set #0, that is, configuration information on search space #0 through the MIB. The UE may consider a frequency domain configured as control resource set #0 acquired from the MIB as an initial bandwidth part for initial access. Here, an ID of the initial BWP may be considered as 0.

The configuration for the BWP supported by the 5G system may be used for various purposes.

According to some embodiments, when a bandwidth supported by the UE is narrower than a system bandwidth, it may be supported through the BWP configuration. For example, the base station may configure a frequency location (configuration information 2) of the BWP in the UE such that the UE may transmit and receive data at a specific frequency location within the system bandwidth.

Also, according to some embodiments, to support different numerologies, the base station may configure a plurality of BWPs in the UE. For example, in order to support the UE to perform data transmission and reception using both subcarrier spacing of 15 kilohertz (kHz) and subcarrier spacing of 30 kHz, two BWPs may be configured as subcarrier spacings of 15 kHz and 30 kHz, respectively. Different BWPs may be frequency division-multiplexed, and in the case of transmitting and receiving data at a specific subcarrier spacing, a BWP configured at the corresponding subcarrier spacing may be activated.

Also, according to some embodiments, to reduce power consumption of the UE, the base station may configure BWPs having different sizes of bandwidths in the UE. For example, when the UE supports a very large bandwidth, for example, 100 MHz, and always transmits and receives data through the bandwidth, very high power may be consumed. Particularly, monitoring an unnecessary downlink control channel through a large bandwidth of 100 MHz in a state in which there is no traffic is very inefficient in terms of power consumption. In order to reduce power consumption of the UE, the base station may configure a BWP having a relatively narrow bandwidth, for example, 20 MHz. The UE may perform a monitoring operation in the bandwidth part of 20 MHz in a state in which there is no traffic, and if data is generated, may transmit and receive the data through the bandwidth part of 100 MHz according to an instruction from the base station.

In a method of configuring the BWP, UEs before RRC connection may receive configuration information on an initial bandwidth part through an MIB in an initial access stage. More specifically, the UE may receive a configuration of a control resource set (CORESET) for a downlink control channel in which DCI for scheduling a system information block (SIB) may be transmitted from an MIB of a physical broadcast channel (PBCH). A bandwidth of the control resource set configured as the MIB may be considered as an initial bandwidth part, and the UE may receive a physical downlink shared channel (PDSCH) in which the SIB is transmitted, through the configured initial bandwidth part. The initial BWP may be used not only for reception of the SIB but also for other system information (OSI), paging, or random access (RA).

### [BWP Change]

When one or more BWPs are configured in the UE, the base station may indicate a change (or switching or transition) in the BWPs to the UE using a BWP indicator field in DCI. For example, in FIG. 3, when a currently activated BWP of the UE is BWP #1 301, the base station may indicate BWP #2 302 to the UE through a BWP indicator in the DCI and the UE may perform a BWP change to BWP #2 302 indicated through the received BWP indicator in the DCI.

As described above, since the DCI-based BWP change may be indicated by the DCI for scheduling the PDSCH or the PUSCH, the UE needs to be able to receive or transmit the PDSCH or the PUSCH scheduled by the corresponding DCI in the changed BWP without any difficulty if the UE receives a BWP change request. To this end, requirements for a delay time (TBWP) required for the BWP change is specified in the standard, and may be defined, for example, as shown in Table 3 below.

TABLE 3

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
Note 2:
If the BWP switch involves changing of SCS, the BWP switch delay is determined by the larger one between the SCS before BWP switch and the SCS after BWP switch.

The requirements for the BWP change delay time support type 1 or type 2 according to UE capability. The UE may report a supportable BWP delay time type to the base station.

When the UE receives DCI including a BWP change indicator in slot n according to the requirements for the BWP change delay time, the UE may complete a change to a new BWP indicated by the BWP change indicator at a point in time that is not later than slot n+TBWP and may transmit and receive a data channel scheduled by the corresponding DCI in the changed new BWP. When the base station desires to schedule a data channel in the new BWP, the base station may determine time domain resource allocation for the data cannel in consideration of the BWP change delay time (TBWP) of the UE. That is, when scheduling the data channel in the new BWP, the base station may schedule the corresponding data channel after the BWP change delay time using a method of determining the time domain resource allocation for the data channel. Accordingly, the UE may not expect that the DCI indicating the BWP change indicates a slot offset (K0 or K2) value smaller than the BWP change delay time (TBWP).

If the UE receives DCI indicating the BWP change (e.g., DCI format 1_1 or 0_1), the UE may perform no transmission or reception during a time interval from a third symbol of a slot in which the PDCCH including the corresponding DCI is received to a start point of a slot indicated by a slot offset (K0 or K2) indicated through a time domain resource allocation field in the corresponding DCI. For example, if the UE receives DCI indicating the BWP change in slot n and a slot offset value indicated by the corresponding DCI is K, the UE may perform no transmission or reception from a third symbol of slot n to a symbol before slot n+K (i.e., last symbol of slot n+K−1).

### [SS/PBCH Block]

Hereinafter, a synchronization signal (SS)/PBCH block in a 5G system is described.

The SS/PBCH block may be a physical layer channel block including a primary synchronization signal (PSS), a secondary synchronization signal (SSS), and a PBCH. Detailed description thereof is made below:
PSS: It is a signal used as a reference of downlink time/frequency synchronization and provides some pieces of information of a cell ID;
SSS: It is a reference of downlink time/frequency synchronization and provides remaining cell ID information that the PSS does not provide. Additionally, the SSS may serve as a reference signal for demodulation of the PBCH;
PBCH: It provides necessary system information required for data channel and control channel transmission and reception of the UE. The necessary system information may include search space-related control information indicating radio resource mapping information of a control channel and scheduling control information for a separate data channel for transmitting system information; and
SS/PBCH block: The SS/PBCH block includes a combination of the PSS, the SSS, and the PBCH. One or a plurality of SS/PBCH blocks may be transmitted within a time of 5 ms, and each of the transmitted SS/PBCH blocks may be distinguished by index.

The UE may detect the PSS and the SSS in an initial access stage and decode the PBCH. The UE may acquire an MIB from the PBCH and may receive a configuration of control resource set (CORESET) #0 (corresponding to control resource set of which control resource set index is 0) from the acquired MIB. The UE may monitor control resource set #0 with the assumption that the selected SS/PBCH block and a demodulation reference signal (DMRS) transmitted in control resource set #0 are quasi co-located (QCLed). The UE may receive system information through downlink control information transmitted in control resource set #0. The UE may acquire configuration information related to a random access channel (RACH) required for initial access from the received system information. The UE may transmit a physical RACH (PRACH) to the base station in consideration of the selected SS/PBCH block index, and the base station receiving the PRACH may acquire the SS/PBCH block index selected by the UE. The base station may know which block is selected by the UE from among the SS/PBCH blocks and that control resource set #0 related thereto is monitored.

### [PDCCH: Related to DCI]

Hereinafter, downlink control information (DCI) in a 5G system is described in detail.

In the 5G system, scheduling information for uplink data (or physical uplink data channel (PUSCH)) or downlink data (or physical downlink data channel (PDSCH)) is transmitted from the base station to the UE through DCI. The UE may monitor a fallback DCI format and a non-fallback DCI format for the PUSCH or the PDSCH. The fallback DCI format may include a fixed field predefined between the base station and the UE, and the non-fallback DCI format may include a configurable field.

The DCI may be transmitted through a physical downlink control channel (PDCCH) via a channel coding and modulation process. A cyclic redundancy check (CRC) may be added to a DCI message payload and may be scrambled by a radio network temporary identifier (RNTI) corresponding to the identity of the UE. Depending on the purpose of a DCI message, for example, UE-specific data transmission, a power control command, or a random access response, different RNTIs may be used. That is, the RNTI is included in a CRC calculation process and transmitted, without being explicitly transmitted. If the DCI message transmitted through the PDCCH is received, the UE may identify the CRC through the allocated RNTI, and may recognize that the corresponding message is transmitted to the UE when the CRC is determined to be correct on the basis of the CRC identification result.

For example, DCI for scheduling a PDSCH for system information (SI) may be scrambled by an SI-RNTI. DCI for scheduling a PDSCH for a random access response (RAR) message may be scrambled by an RA-RNTI. DCI for scheduling a PDSCH for a paging message may be scrambled by a P-RNTI. DCI for notifying a slot format indicator (SF) may be scrambled by an SFI-RNTI. DCI for notifying transmit power control (TPC) may be scrambled with a TPC-RNTI. DCI for scheduling a UE-specific PDSCH or PUSCH may be scrambled by a cell RNTI (C-RNTI).

DCI format 0_0 may be used for fallback DCI for scheduling a PUSCH and, here, the CRC may be scrambled by a C-RNTI. DCI format 0_0 in which the CRC is scrambled by the C-RNTI may include, for example, information as shown in Table 4 below.

TABLE 4

-Identifier for DCI formats (DCI format identifier) - [1] bit
$– Frequency domain resource assignment ⌈ {log}_{2} ( {N}_{R B}^{UL , BWP} ( {N}_{R B}^{UL , BWP} + 1 ) / 2 ⌉ bits$
-Time domain resource assignment - X bits
-Frequency hopping flag - 1 bit.
-Modulation and coding scheme - 5 bits
-New data indicator - 1 bit
-Redundancy version - 2 bits
-HARQ process number - 4 bits
-TPC command for scheduled PUSCH - [2] bits
-UL/supplementary UL indicator - 0 or 1 bit

DCI format 0_1 may be used for non-falback DCI for scheduling a PUSCH and, here, the CRC may be scrambled by a C-RNTI. DCI format 0_1 in which the CRC is scrambled by the C-RNTI may include, for example, information as shown in Table 5 below.

TABLE 5

```
- Carrier indicator - 0 or 3 bits
-UL/SUL indicator - 0 or 1 bit
-Identifier for DCI formats - [1] bits
-Bandwidth part indicator - 0, 1 or 2 bits
-Frequency domain resource assignment
    $•For resource allocation type 0 , ⌈ {N}_{R B}^{UL , BWP} / P ⌉ bits$
    $•For resource allocation type 1 , ⌈ {log}_{2} ( {N}_{R B}^{UL , BWP} ( {N}_{R B}^{UL , BWP} + 1 ) / 2 ⌉ bits$
-Time domain resource assignment -1, 2, 3, or 4 bits
-virtual resource block (VRB)-to-physical resource block (PRB) mapping - 0 or
1 bit, only for resource allocation type 1.
    • 0 bit if only resource allocation type 0 is configured;
    • 1 bit otherwise.
-Frequency hopping flag - 0 or 1 bit, only for resource allocation type 1.
    • 0 bit if only resource allocation type 0 is configured;
    • 1 bit otherwise.
-Modulation and coding scheme - 5 bits
-New data indicator - 1 bit
-Redundancy version - 2 bits
-HARQ process number - 4 bits
-1st downlink assignment index - 1 or 2 bits
    • 1 bit for semi-static HARQ-ACK codebook;
    • 2 bits for dynamic HARQ-ACK codebook with single HARQ-
  ACK codebook.
-2nd downlink assignment index - 0 or 2 bits
    • 2 bits for dynamic HARQ-ACK codebook with two HARQ-
  ACK sub-codebooks;
    • 0 bit otherwise.
-TPC command for scheduled PUSCH - 2 bits
$– SRS resource indicator - ⌈ {log}_{2} ( {Σ}_{k = 1}^{{L}_{{max}_{=}}} ( \begin{matrix}{N}_{SRS} \\ k\end{matrix} ) ) ⌉ or ⌈ {log}_{2} ( {N}_{S R S} ) ⌉ bits$
$\cdot ⌈ {log}_{2} ( {Σ}_{k = 1}^{{L}_{{max}_{=}}} ( \begin{matrix}{N}_{SRS} \\ k\end{matrix} ) ) ⌉ bits for non - codebook based PUSCH transmission ;$
    • ┌log₂ (N_{SRS})] bits for codebook based PUSCH transmission.
-Precoding information and number of layers - up to 6 bits
-Antenna ports - up to 5 bits
-SRS request - 2 bits
-Channel state information (CSI) request - 0, 1, 2, 3, 4, 5, or 6 bits
- Code block group (CBG) transmission information - 0, 2, 4, 6, or 8 bits
-phase tracking reference signal (PTRS)-demodulation reference signal (DMRS)
association - 0 or 2 bits.
-beta_offset indicator - 0 or 2 bits
-DMRS sequence initialization - 0 or 1 bit
```

DCI format 1_0 may be used for fallback DCI for scheduling a PDSCH, and here, the CRC may be scrambled by a C-RNTI. DCI format 1_0 in which the CRC is scrambled by the C-RNTI may include, for example, information as shown in Table 6 below.

TABLE 6

-Identifier for DCI formats - [1] bit
$- Frequency domain resource assignment - ⌈ {log}_{2} ( {N}_{R B}^{DL , BWP} ( {N}_{R B}^{DL , BWP} + 1 ) / 2 ⌉ bits$
-Time domain resource assignment - X bits
-VRB-to-PRB mapping - 1 bit.
-Modulation and coding scheme - 5 bits
-New data indicator - 1 bit
-Redundancy version - 2 bits
-HARQ process number - 4 bits
-Downlink assignment index - 2 bits
-TPC command for scheduled PUCCH - [2] bits
-Physical uplink control channel (PUCCH) resource indicator - 3 bits
-PDSCH-to-HARQ feedback timing indicator - [3] bits

DCI format 1_1 may be used for non-fallback DCI for scheduling a PDSCH and, here, the CRC may be scrambled by a C-RNT. DCI format 1_1 in which the CRC is scrambled by the C-RNTI may include, for example, information as shown in Table 7 below.

```
TABLE 7
- Carrier indicator - 0 or 3 bits
-Identifier for DCI formats - [1] bits
-Bandwidth part indicator - 0, 1 or 2 bits
-Frequency domain resource assignment
    $•For resource allocation type 0 , {N}_{R B}^{DL , BWP} / P bits$
    $•For resource allocation type 1 , ⌈ {log}_{2} ( {N}_{R B}^{DL , BWP} ( {N}_{R B}^{DL , BWP} + 1 ) / 2 ⌉ bits$
-Time domain resource assignment - 1, 2, 3, or 4 bits
-VRB-to-PRB mapping - 0 or 1 bit, only for resource allocation type 1.
    • 0 bit if only resource allocation type 0 is configured;
    • 1 bit otherwise.
-Physical resource block (PRB) bundling size indicator - 0 or 1 bit
-Rate matching indicator - 0, 1, or 2 bits
-Zero power (ZP) channel state information (CSI)-reference signal (RS)
trigger - 0, 1, or 2 bits
For transport block 1:
-Modulation and coding scheme - 5 bits
-New data indicator - 1 bit
-Redundancy version - 2 bits
For transport block 2:
-Modulation and coding scheme - 5 bits
-New data indicator - 1 bit
-Redundancy version - 2 bits
-HARQ process number - 4 bits
-Downlink assignment index - 0 or 2 or 4 bits
-TPC command for scheduled PUCCH - 2 bits
-PUCCH resource indicator - 3 bits
- PDSCH-to-HARQ feedback timing indicator - 3 bits
-Antenna ports - 4, 5 or 6 bits
- Transmission configuration indication - 0 or 3 bits
-SRS request - 2 bits
- CBG transmission information - 0, 2, 4, 6, or 8 bits
- CBG flushing out information - 0 or 1 bit
-DMRS sequence initialization - 1 bit
```

### [PDCCH: CORESET, REG, CCE, Search Space]

Hereinafter, a downlink control channel in a 5G communication system is described in more detail with reference to the drawings.

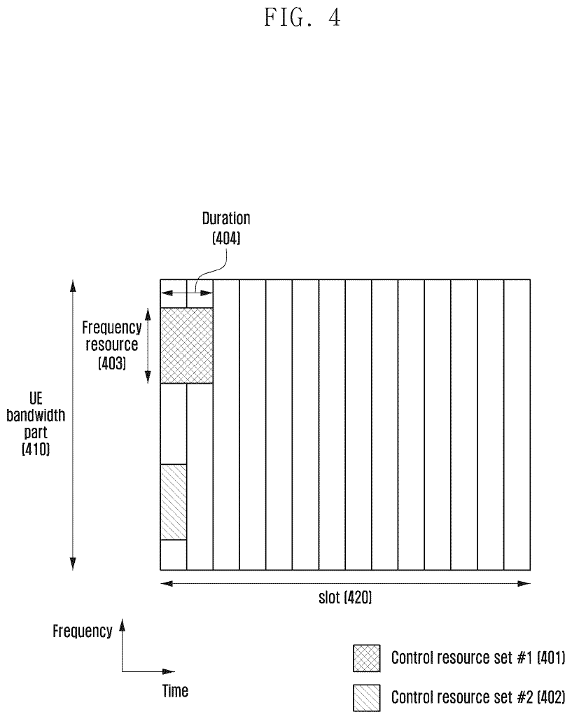

FIG. 4 illustrates an example of a control area (hereinafter, control resource set (CORESET)) in which a downlink control channel is transmitted in a 5G wireless communication system. FIG. 4 illustrates an example in which a UE bandwidth part 410 is configured in the frequency axis and two control areas (control resource set #1 401 and control resource set #2 402) are configured in a single slot 420 in the time axis. The control resource sets 401 and 402 may be configured in specific frequency resources 403 within the entire UE BWP 410 in the frequency axis. A control resource set may be configured as one or a plurality of OFDM symbols in the time axis, which may be defined as a control resource set duration 404. With reference to the example of FIG. 4, the control resource set #1 401 may be configured as a control resource set duration of two symbols, and control resource set #2 402 may be configured as a control resource set duration of one symbol.

The above-described control resource sets in the 5G may be configured through higher layer signaling (e.g., system information, master information block (MB), and radio resource control (RRC) signaling) in the UE by the base station. Configuring the control resource set in the UE implies providing information, such as a control resource set identity, a frequency location of the control resource set, and a symbol length of the control resource set. For example, the following information may be included as shown in Table 8 below.

TABLE 8

| | |
|---|---|
| ControlResourceSet ::= | SEQUENCE { |

-- Corresponds to L1 parameter “CORESET-ID”

| | |
|---|---|
| controlResourceSetId | ControlResourceSetId, |

(control resource set identity)

| | |
|---|---|
| frequencyDomainResources | BIT STRING (SIZE (45)), |

(frequency axis resource allocation information)

| | |
|---|---|
| duration | INTEGER |

(1..maxCoReSetDuration),
(time axis resource allocation information)

| | |
|---|---|
| cce-REG-MappingType | CHOICE { |

```
  (CCE-to-REG mapping scheme)
        interleaved
      SEQUENCE {
            reg-BundleSize
      ENUMERATED {n2, n3, n6},
    (REG bundle size)
            precoderGranularity
      ENUMERATED {sameAsREG-bundle, allContiguousRBs},
            interleaverSize
      ENUMERATED {n2, n3, n6}
            (interleaver size)
            shiftIndex
      INTEGER(0..maxNrofPhysicalResourceBlocks−1)
                OPTIONAL
          (interleaver shift)
    },
```

| | |
|---|---|
| nonInterleaved | NULL |

```
      },
      tci-StatesPDCCH
      SEQUENCE(SIZE (1..maxNrofTCI-StatesPDCCH)) OF
      TCI-StateId
            OPTIONAL,
  (QCL configuration information)
```

| | |
|---|---|
| tci-PresentInDCI | ENUMERATED |

{enabled}
OPTIONAL, -- Need S
}

In Table 8, tci-StatesPDCCH (simply, referred to as transmission configuration indication (TCI) state) configuration information may include information on one or a plurality of SS/PBCH block indexes or channel state information reference signal (CSI-RS) indexes having the quasi co-located (QCL) relationship with a DMRS transmitted in corresponding CORESET.

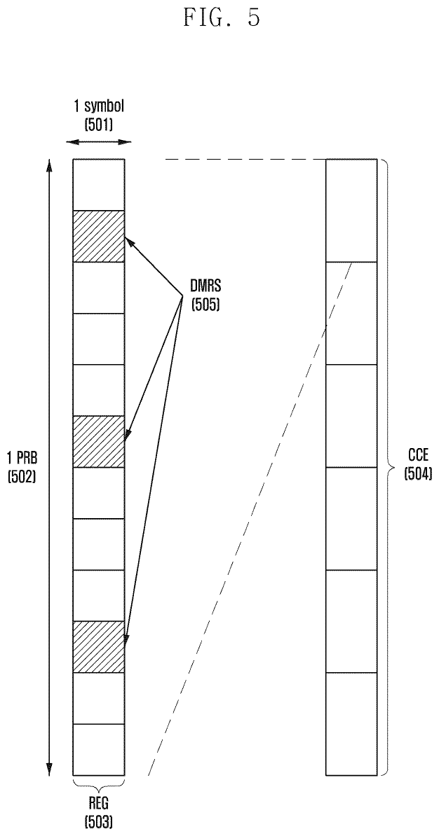

FIG. 5 illustrates an example of the basic unit of time and frequency resources included in a downlink control channel available in 5G. According to FIG. 5, the basic unit of time and frequency resources included in the control channel may be referred to as a resource element group (REG) 503, and the REG 503 may be defined as one OFDM symbol 501 in the time axis and one PRB 502 in the frequency axis, that is, as 12 subcarriers. The base station may configure a downlink control channel allocation unit by concatenating the REGs 503.

As illustrated in FIG. 5, when the basic unit for allocation of the downlink control channel in the 5G system is a control channel eminent (CCE) 504, one CCE 504 may include a plurality of REGs 503. In describing the REG 503 illustrated in FIG. 5 by way of example, the REG 503 may include 12 REs and, when one CCE 504 includes six REGs 503, one CCE 504 may include 72 REs. When a downlink CORESET is configured, the corresponding area may include a plurality of CCEs 504, and a specific downlink control channel may be mapped to one or the plurality of CCEs 504 according to an aggregation level (AL) within the CORESET and then transmitted. The CCEs 504 in the CORESET may be distinguished by numbers and the numbers of the CCEs 504 may be assigned according to a logical mapping scheme.

The basic unit of the downlink control channel illustrated in FIG. 5, that is, the REG 503 may include all of REs to which DCI is mapped and areas each to which a DMRS 505, which is a reference signal for decoding the RE, are mapped. As illustrated in FIG. 5, three DMRSs 505 may be transmitted in one REG 503. The number of CCEs 504 required to transmit the PDCCH may be 1, 2, 4, 8, or 16 according to the aggregation level (AL), and the different number of CCEs may be used to implement link adaptation of the downlink control channel. For example, if AL=L, one downlink control channel may be transmitted through L CCEs. The UE needs to detect a signal in a state in which the UE is unaware of information on the downlink control channel, and a search space indicating a set of CCEs is defined to perform blind decoding. The search space is a set of downlink control channel candidates including CCEs for which the UE needs to attempt decoding at the given aggregation level, and there are several aggregation levels at which one set of CCEs is configured by 1, 2, 4, 8, and 16 CCEs and accordingly, the UE may have a plurality of search spaces. A search space set may be defined as a set of search spaces at all the configured aggregation levels.

The search space may be classified into a common search space and a UE-specific search space. UEs in a predetermined group or all UEs may investigate a common search space of the PDCCH in order to receive cell-common control information, such as dynamic scheduling for system information or paging messages. For example, PDSCH scheduling allocation information for transmission of an SIB including provider information of a cell may be received by investigating the common search space of the PDCCH. In the case of the common search space, UEs in a predetermined group or all UEs need to receive the PDCCH, so the common-search space may be defined as a set of pre-arranged CCEs. Scheduling allocation information for the UE-specific PDSCH or PUSCH may be received by investigating the UE-specific search space of the PDCCH. The UE-specific search space may be UE-specifically defined through a UE identity and a function of various system parameters.

A parameter for the search space of the PDCCH in the 5G system may be configured in the UE by the base station through higher layer signaling (e.g., SIB, MIB, and RRC signaling). For example, the base station may configure, in the UE, the number of PDCCH candidates at each aggregation level L, a monitoring period of the search space, a monitoring position in units of symbols within the slot for the search space, a search space type (common search space or UE-specific search space), a combination of a DCI format and an RNTI to be monitored in the corresponding search space, and a control resource set index for monitoring the search space. For example, the following information shown in Table 9 below may be included.

TABLE 9

| | |
|---|---|
| SearchSpace ::= | SEQUENCE { |

-- Identity of the search space. SearchSpaceId = 0 identifies the
SearchSpace configured via PBCH (MIB) or ServingCellConfigCommon.

| | |
|---|---|
| searchSpaceId | SearchSpaceId, |

(search space identifier)

| | |
|---|---|
| controlResourceSetId | ControlResourceSetId, |

(control resource set identifier)

| | |
|---|---|
| monitoringSlotPeriodicityAndOffset | CHOICE { |

(monitoring slot level period)

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

}

| | |
|---|---|
| | OPTIONAL, |
| Duration (monitoriing length) | INTEGER (2..2559) |
| monitoringSymbolsWithinSlot | BIT STRING (SIZE |
| (14)) | OPTIONAL, |

(monitoring symbol within slot)

| | |
|---|---|
| nrofCandidates | SEQUENCE { |

(number of PDCCH candidates for each aggregation level)

| | |
|---|---|
| aggregationLevel1 | ENUMERATED {n0, n1, |

n2, n3, n4, n5, n6, n8},

| | |
|---|---|
| aggregationLevel2 | ENUMERATED {n0, n1, |

n2, n3, n4, n5, n6, n8},

| | |
|---|---|
| aggregationLevel4 | ENUMERATED {n0, n1, |

n2, n3, n4, n5, n6, n8},

| | |
|---|---|
| aggregationLevel8 | ENUMERATED {n0, n1, |

n2, n3, n4, n5, n6, n8},

| | |
|---|---|
| aggregationLevel16 | ENUMERATED {n0, n1, |

n2, n3, n4, n5, n6, n8}
},

| | |
|---|---|
| searchSpaceType | CHOICE { |

```
    (search space type)
        -- Configures this search space as common search space (CSS) and
DCI formats to monitor.
```

| | |
|---|---|
| common | SEQUENCE { |

```
    (common search space)
      }
```

| | |
|---|---|
| ue-Specific | SEQUENCE { |

```
    (UE-specific search space)
          -- Indicates whether the UE monitors in this USS for DCI formats
0-0 and 1-0 or for formats 0-1 and 1-1.
```

| | |
|---|---|
| formats | ENUMERATED |

```
{formats0-0-And-1-0, formats0-1-And-1-1},
          ...
        }
```

The base station may configure one or a plurality of search space sets in the UEl according to configuration information. According to some embodiments, the base station may configure search space set 1 and search space set 2 in the UE, and the configuration may be performed such that DCI format A scrambled by an X-RNTI in search space set 1 is monitored in the common search space and DCI format B scrambled by a Y-RNTI in search space set 2 is monitored in the UE-specific search space.

According to configuration information, one or a plurality of search space sets may be present in the common search space or the UE-specific search space. For example, search space set #1 and search space set #2 may be configured as common search spaces, and search space set #3 and search space set #4 may be configured as UE-specific search spaces.

In the common search space, the following combinations of DCI formats and RNTIs may be monitored. Of course, the disclosure is not limited to the following examples.

DCI format 0_0/1_0 with CRC scrambled by C-RNTI, CS-RNTI, SP-CSI-RNTI, RA-RNTI, TC-RNTI, P-RNTI, SI-RNTI

DCI format 2_0 with CRC scrambled by SFI-RNTI

DCI format 2_1 with CRC scrambled by INT-RNTI

DCI format 2_2 with CRC scrambled by TPC-PUSCH-RNTI, TPC-PUCCH-RNTI

DCI format 2_3 with CRC scrambled by TPC-SRS-RNTI

In the UE-specific search space, the following combinations of DCI formats and RNTIs may be monitored. Of course, the disclosure is not limited to the following examples.

DCI format 0_0/1_0 with CRC scrambled by C-RNTI, CS-RNTI, TC-RNTI

DCI format 1_0/1_1 with CRC scrambled by C-RNTI, CS-RNTI, TC-RNTI

The specified RNTIs may follow the following definitions and usage.

Cell RNTI (C-RNTI): used for UE-specific PDSCH scheduling

Temporary cell RNTI (TC-RNTI): used for UE-specific PDSCH scheduling

Configured scheduling RNTI (CS-RNTI): used for semi-statically configured UE-specific PDSCH scheduling

Random access RNTI (RA-RNTI): used for PDSCH scheduling in random access stage

Paging RNTI (P-RNTI): used for PDSCH scheduling through which paging is transmitted

System information RNTI (SI-RNTI): used for PDSCH scheduling through which system information is transmitted

Interruption RNTI (INT-RNTI): used for indicating whether puncturing for PDSCH is performed

Transmit power control for PUSCH RNTI (TPC-PUSCH-RNTI): used for indicating power control command for PUSCH

Transmit power control for PUCCH RNTI (TPC-PUCCH-RNTI): used for indicating power control command for PUCCH

Transmit power control for SRS RNTI (TPC-SRS-RNTI): used for indicating power control command for SRS

The specified DCI formats described above may follow the following definitions shown in Table 10 below.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot |
| | format |
| 2_1 | Notifying a group of UEs of the PRB(s) |
| | and OFDM symbol(s) where UE may assume no |
| | transmission is intended for the UE |
| 2_2 | Transmission of TPC commands for |
| | PUCCH and PUSCH |
| 2_3 | Transmission of a group of TPC |
| | commands for SRS transmissions by one or more |
| | UEs |

In the 5G system, control resource set p and a search space of aggregation level L in search space set s may be expressed as shown in Equation 1 below.

$$[ Equation 1 ]$$

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + iLggregation level$$

n_{CI}: carrier index
N_{CCE,p}: total number of CCEs present within control resource set p

$${n}_{s , f}^{μ}$$

slot index

$${M}_{s , max}^{( L )} er$$

PDCCH candidates at aggregation level L

$${m}_{s , {n}_{CI}} = 0 , … , {M}_{s , max}^{( L )} DCCH$$

candidate index at aggregation level L
i=0, . . . , L˜1

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI}≠0, A=39827 for pmod3=0, Aₚ=39829 for p mod 3=1, Aₚ=39839 for p mod 3=2, D=65537
n_{RNTI}: UE identity

$${Y}_{p , {n}_{s , f}^{μ}}$$

may correspond to 0 in the case of the common search space.

$${Y}_{p , {n}_{s , f}^{μ}}$$

may correspond to a value that varies according to the identity of the UE (C-RNTI or ID configured by base station to UE) and a time index, in the case of the UE-specific search space.

In the 5G system, a set of search space sets monitored by the UE at every point in time may vary as a plurality of search space sets may be configured as different parameters (e.g., parameters in Table 10). When search space set #1 is configured on an X-slot period, search space set #2 is configured on a Y-slot period, and X and Y are different from each other, the UE may monitor all of search space set #1 and search space set #2 in a specific slot and monitor one of search space set #1 and search space set #2 in another specific slot.

### [PDCCH: Span]

The UE may perform UE capability report at every subcarrier spacing in a case in which a plurality of PDCCH monitoring positions are present within a slot and, here, the concept “span” may be used. The span represents consecutive symbols in which the UE may monitor a PDCCH in the slot, and each PDCCH monitoring position may be in one span. The span may be expressed by (X,Y) in which X refers to the minimum number of symbols that needs to be spaced apart between first symbols of two consecutive spans and Y refers to the number of consecutive symbols for monitoring the PDCCH within one span. Here, the UE may monitor the PDCCH in a section within Y symbols from the first symbol of the span within the span.

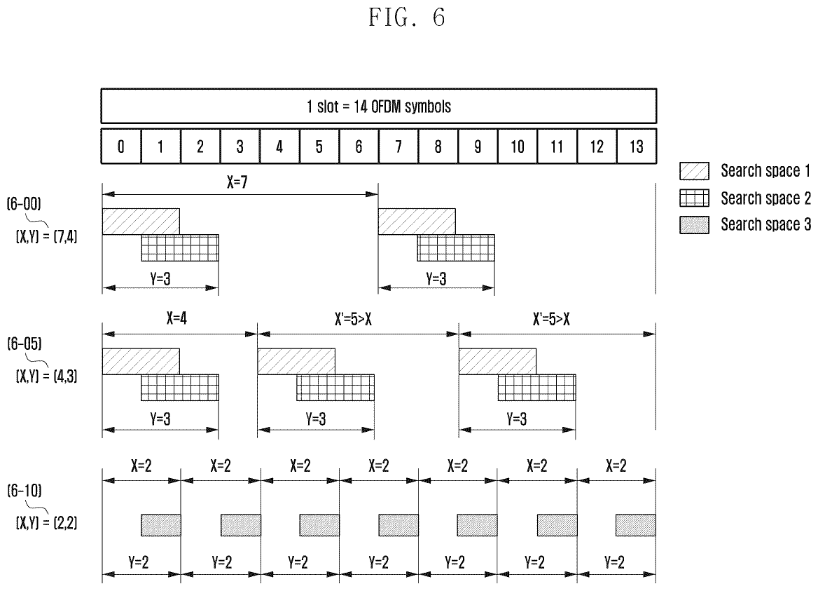

FIG. 6 illustrates a case in which the UE may have a plurality of PDCCH monitoring positions in a slot through a span in a wireless communication system. The span may be expressed by (X,Y)=(7,4), (4,3), and (2,2), and the three cases are expressed as 6-00, 6-05, and 6-10 in FIG. 6. For example, 6-00 represents a case in which the number of spans that may be expressed by (7,4) is 2 in the slot. An interval between first symbols of the two spans is expressed as X=7, a PDCCH monitoring position may be present within a total of Y=3 symbols from the first symbol of each span, and search spaces 1 and 2 are present within Y=3 symbols. As another example, 6-05 represents a case in which a total number of spans that may be expressed by (4,3) is 3 is in the slot, and an interval between a second span and a third span is X′=5 symbols larger than X=4.

### [PDCCH: UE Capability Report]

A slot location of the common search space and the UE-specific search space is indicated by a monitoringSymbolsWithinSlot parameter in Table 11 below, and the symbol location within the slot is indicated by a bitmap through a monitoringSymbolsWithinSlot parameter in Table 9. Meanwhile, the symbol location within the slot in which the UE may perform search space monitoring may be reported to the base station through the following UE capability.
UE capability 1 (hereinafter, referred to as FG 3-1). When the number of monitoring positions (MOs) for type 1 and type 3 common search spaces or the UE-specific search space is one within the slot as shown in Table 11 below, the UE capability refers to capability of monitoring a corresponding MO if the corresponding MO is within the first three symbols in the slot. The UE capability is mandatory capability that all UEs supporting NR need to support and whether to support the capability is not explicitly reported to the base station.

TABLE 11

| | | | Field name |
|---|---|---|---|
| | Feature | | in TS 38.331 |
| Index | group | Components | [2] |
| 3-1 | Basic | 1) One configured CORESET per BWP | n/a |
| | DL | per cell in addition to CORESET0 | |
| | control | CORESET resource allocation of 6RB bit- | |
| | channel | map and duration of 1-3 OFDM symbols | |
| | | for FR1 | |
| | | For type 1 CSS without dedicated RRC | |
| | | configuration and for type 0, 0A, and 2 | |
| | | CSSs, CORESET resource allocation of | |
| | | 6RB bit-map and duration 1-3 OFDM | |
| | | symbols for FR2 | |
| | | For type 1 CSS with dedicated RRC | |
| | | configuration and for type 3 CSS, UE | |
| | | specific SS, CORESET resource allocation | |
| | | of 6RB bit-map and duration 1-2 OFDM | |
| | | symbols for FR2 | |
| | | REG-bundle sizes of 2/3 RBs or 6 RBs | |
| | | Interleaved and non-interleaved CCE-to- | |
| | | REG mapping | |
| | | Precoder-granularity of REG-bundle size | |
| | | PDCCH DMRS scrambling determination | |
| | | TCI state(s) for a CORESET configuration | |
| | | 2) CSS and UE-SS configurations for | |
| | | unicast PDCCH transmission per BWP per | |
| | | cell | |
| | | PDCCH aggregation levels 1, 2, 4, 8, 16 | |
| | | UP to 3 search space sets in a slot for | |
| | | a scheduled SCell per BWP | |
| | | This search space limit is before | |
| | | applying all dropping rules. | |
| | | For type 1 CSS with dedicated RRC | |
| | | configuration, type 3 CSS, and UE-SS, | |
| | | the monitoring position is within the | |
| | | first 3 OFDM symbols of a slot | |
| | | For type 1 CSS without dedicated RRC | |
| | | configuration and for type 0, 0A, and 2 | |
| | | CSS, the monitoring position can be any | |
| | | OFDM symbol(s) of a slot, with the | |
| | | monitoring positions for any of Type 1- | |
| | | CSS without dedicated RRC | |
| | | configuration, or Types 0, 0A, or 2 CSS | |
| | | configurations within a single span of | |
| | | three consecutive OFDM symbols within a | |
| | | slot | |
| | | 3) Monitoring DCI formats 0_0, 1_0, | |
| | | 0_1, 1_1 | |
| | | 4) Number of PDCCH blind decodes per | |
| | | slot with a given SCS follows Case 1-1 | |
| | | table | |
| | | 5) Processing one unicast DCI scheduling | |
| | | DL and one unicast DCI scheduling UL | |
| | | per slot per scheduled CC for FDD | |
| | | 6) Processing one unicast DCI scheduling | |
| | | DL and 2 unicast DCI scheduling UL per | |
| | | slot per scheduled CC for TDD | |

UE capability 2 (hereinafter, referred to as FG 3-2). When the number of MOs for the common search space or the Uc-specific search space is one within the slot as shown in Table 12 below, the UE capability refers to capability of performing monitoring regardless of a start symbol location of the corresponding MO. The UE capability may be optionally supported by the UE, and whether to support the capability is explicitly reported to the base station.

TABLE 12

| | | | Field name |
|---|---|---|---|
| | Feature | | in TS 38.331 |
| Index | group | Components | [2] |
| 3-2 | PDCCH monitoring | For a given UE, all search | pdcchMoni- |
| | on any span of up to | space configurations are | toringSin- |
| | 3 consecutive | within the same span of 3 | glePosition |
| | OFDM symbols of a | consecutive OFDM | |
| | slot | symbols in the slot | |

UE capability 3 (hereinafter, referred to as FG 3-5, 3-5a, 3-5b). When the number of MOs for the common search space or the UE-specific search space is plural within the slot as shown in Table 13 below, the UE capability indicates a pattern of MOs that the UE may monitor. The pattern includes an interval X between start symbols of different MOs and a maximum symbol length Y of one MO. A combination of (X, Y) supported by the UE may be one or more of {(2, 2), (4, 3), (7, 3)}. The UE capability may be optionally supported by the UE, and whether to support the capability and the combination (X, Y) is explicitly reported to the base station.

TABLE 13

| Index | Feature group | Components | Field name in TS 38.331 [2] |
|---|---|---|---|
| 3-5 | For type 1 | For type 1 CSS with dedicated RRC | pdcch- |
| | CSS with | configuration, type 3 CSS, and UE-SS, | MonitoringAnyPositions |
| | dedicated | monitoring position can be any OFDM | { |
| | RRC | symbol(s) of a slot for Case 2 | 3-5. withoutDCI-Gap |
| | configuration, | | 3-5a. withDCI- |
| | type 3 CSS, | | Gap |
| | and UE-SS, | | } |
| | monitoring | | |
| | position can | | |
| | be any | | |
| | OFDM | | |
| | symbol(s) of | | |
| | a slot for | | |
| | Case 2 | | |
| 3-5a | For type 1 | For type 1 CSS with dedicated RRC | |
| | CSS with | configuration, type 3 CSS and UE-SS, | |
| | dedicated | monitoring position can be any OFDM | |
| | RRC | symbol(s) of a slot for Case 2, with | |
| | configuration, | minimum time separation (including the | |
| | type 3 CSS, | cross-slot boundary case) between two DL | |
| | and UE-SS, | unicast DCIs, between two UL unicast | |
| | monitoring | DCIs, or between a DL and an UL unicast | |
| | position can | DCI in different monitoring positions | |
| | be any | where at least one of them is not the | |
| | OFDM | monitoring positions of FG-3-1, for a | |
| | symbol(s) of | same UE as | |
| | a slot for | 2OFDM symbols for 15 kHz | |
| | Case 2 with a | 4OFDM symbols for 30 kHz | |
| | DCI gap | 7OFDM symbols for 60 kHz with NCP | |
| | | 11OFDM symbols for 120 kHz | |
| | | Up to one unicast DL DCI and up | |
| | | to one unicast UL DCI in a monitoring | |
| | | position except for the monitoring | |
| | | positions of FG 3-1. | |
| | | In addition for TDD the minimum | |
| | | separation between the first two UL | |
| | | unicast DCIs within the first 3 OFDM | |
| | | symbols of a slot can be zero OFDM | |
| | | symbols. | |
| 3-5b | All PDCCH | PDCCH monitoring positions of | |
| | monitoring | FG-3-1, plus additional PDCCH | |
| | position can | monitoring position(s) can be any OFDM | |
| | be any | symbol(s) of a slot for Case 2, and for any | |
| | OFDM | two PDCCH monitoring positions | |
| | symbol(s) of | belonging to different spans, where at | |
| | a slot for | least one of them is not the monitoring | |
| | Case 2 with a | positions of FG-3-1, in same or different | |
| | span gap | search spaces, there is a minimum time | |
| | | separation of X OFDM symbols | |
| | | (including the cross-slot boundary case) | |
| | | between the start of two spans, where each | |
| | | span is of length up to Y consecutive | |
| | | OFDM symbols of a slot. Spans do not | |
| | | overlap. Every span is contained in a | |
| | | single slot. The same span pattern repeats | |
| | | in every slot. The separation between | |
| | | consecutive spans within and across slots | |
| | | may be unequal but the same (X, Y) limit | |
| | | must be satisfied by all spans. Every | |
| | | monitoring position is fully contained in | |
| | | one span. In order to determine a suitable | |
| | | span pattern, first a bitmap b(l), 0 <= l <= 13 | |
| | | is generated, where b(l) = 1 if symbol l of | |
| | | any slot is part of a monitoring position, | |
| | | b(l) = 0 otherwise. The first span in the | |
| | | span pattern begins at the smallest l for | |
| | | which b(l) = 1. The next span in the span | |
| | | pattern begins at the smallest l not | |
| | | included in the previous span(s) for which | |
| | | b(l) = 1. The span duration is | |
| | | max{maximum value of all CORESET | |
| | | durations, minimum value of Y in the UE | |
| | | reported candidate value} except possibly | |
| | | the last span in a slot which can be of | |
| | | shorter duration. A particular PDCCH | |
| | | monitoring configuration meets the UE | |
| | | capability limitation if the span | |
| | | arrangement satisfies the gap separation | |
| | | for at least one (X, Y) in the UE reported | |
| | | candidate value set in every slot, including | |
| | | cross slot boundary. | |
| | | For the set of monitoring positions | |
| | | which are within the same span: | |
| | | Processing one unicast | |
| | | DCI scheduling DL and one unicast DCI | |
| | | scheduling UL per scheduled CC across | |
| | | this set of monitoring positions for FDD | |
| | | Processing one unicast | |
| | | DCI scheduling DL and two unicast DCI | |
| | | scheduling UL per scheduled CC across | |
| | | this set of monitoring positions for TDD | |
| | | Processing two unicast | |
| | | DCI scheduling DL and one unicast DCI | |
| | | scheduling UL per scheduled CC across | |
| | | this set of monitoring positions for TDD | |
| | | The number of different start | |
| | | symbol indices of spans for all PDCCH | |
| | | monitoring positions per slot, including | |
| | | PDCCH monitoring positions of FG-3-1, | |
| | | is no more than floor(14/X) (X is | |
| | | minimum among values reported by UE). | |
| | | The number of different start | |
| | | symbol indices of PDCCH monitoring | |
| | | positions per slot including PDCCH | |
| | | monitoring positions of FG-3-1, is no | |
| | | more than 7. | |
| | | The number of different start | |
| | | symbol indices of PDCCH monitoring | |
| | | positions per half-slot including PDCCH | |
| | | monitoring positions of FG-3-1 is no | |
| | | more than 4 in SCell. | |

The UE may report whether to support UE capability 2 and/or UE capability 3 and a relevant parameter to the base station. The base station may perform time axis resource allocation for the common search space and the ULE-specific search space on the basis of the UE capability. In the resource allocation, the BS may not place a MO at a location at which the UE may not perform monitoring.

### [QCL, TCI State]

In a wireless communication system, one or more different antenna ports (or one or more channels, signals, and combinations thereof, but commonly referred to as different antenna ports for convenience of description) may be associated by a QCL configuration shown in Table 14 below. The TCI state is to inform a QCL relation between a PDCCH (or PDCCH DMRS) and another RS or channel, and that a reference antenna port A (e.g., reference RS #A) and another purpose antenna port B (e.g., target RS #B) are QCLed implies that the UE is allowed to apply some or all of large-scale channel parameters estimated in the antenna port A to channel measurement from the antenna port B. The QCL is required to associate different parameters according to situations, such as 1) time tracking influenced by average delay and delay spread, 2) frequency tracking influenced by Doppler shift and Doppler spread, 3) radio resource management (RRM) influenced by an average gain, and 4) beam management (BM) influenced by a spatial parameter. Accordingly, NR supports four types of QCL relations shown in Table 14 below.

TABLE 14

| QCL type | Large-scale characteristics |
|---|---|
| A | Doppler shift, Doppler spread, average delay, delay |
| | spread |
| B | Doppler shift, Doppler spread |
| C | Doppler shift, average delay |
| D | Spatial Rx parameter |

The spatial RX parameter may refer to some or all of various parameters, such as an angle of arrival (AoA), a power angular spectrum (PAS) of AoA, an angle of departure (AoD), a PAS of AoD, a transmission/reception channel correlation, transmission/reception beamforming, and a spatial channel correlation.

The QCL relation may be configured in the UE through RRC parameter TCI-state and QCL-Info as shown in Table 15 below. With reference to Table 15 below, the base station may configure one or more TCI states in the UE and inform the UE of a maximum of two QCL relations (qcl-Type 1 and qcl-Type 2) for an RS with reference to an ID of the TCI state, that is, a target RS. Here, each piece of QCL information (QCL-Info) included in the TCI state includes a serving cell index and a BWP index of a reference RS indicated by the corresponding QCL information, a type and an ID of the reference RS, and the QCL type as shown in Table 14 above.

TABLE 15

| | |
|---|---|
| TCI-State ::= | SEQUENCE { |
| tci-StateId | TCI-StateId, |

(ID of corresponding TCI state)

| | |
|---|---|
| qcl-Type1 | QCL-Info, |

(QCL information of first reference RS of RS (target RS) that refers to corresponding
TCI state ID)

| | |
|---|---|
| qcl-Type2 | QCL-Info |

```
        OPTIONAL, -- Need R
  (QCL information of second reference RS of RS (target RS) that refers to corresponding
TCI state ID))
  ...
}
```

| | |
|---|---|
| QCL-Info ::= | SEQUENCE { |
| cell | ServCellIndex |

```
      OPTIONAL, -- Need R
  (serving cell index of reference RS indicated by corresponding QCL information)
```

| | |
|---|---|
| bwp-Id | BWP-Id |

```
        OPTIONAL, -- Cond CSI-RS-Indicated
  (BWP index of reference RS indicated by corresponding QCL information)
```

| | |
|---|---|
| referenceSignal | CHOICE { |
| csi-rs | NZP-CSI- |

```
RS-ResourceId,
    ssb
  SSB-Index
    (one of CSI-RS ID or SSB ID indicated by corresponding QCL information)
  },
```

| | |
|---|---|
| qcl-Type | ENUMERATED |

{typeA, typeB, typeC, typeD},
...
}

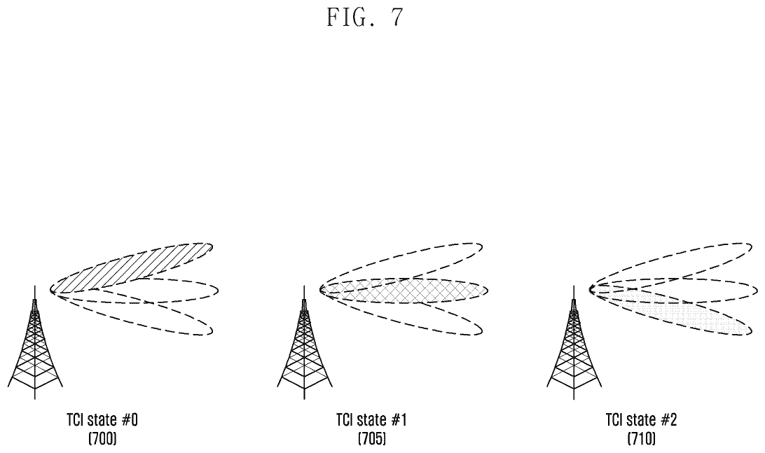

FIG. 7 illustrates an example of base station beam allocation according to a TCI state configuration. With reference to FIG. 7, the base station may transmit information on N different beams to the UE through N different TCI states. For example, when N=3 as illustrated in FIG. 7, the base station may inform that a qcl-Type 2 parameter included in three TCI states 700, 705, and 710 is associated with a CSI-RS or an SSB corresponding to different beams to be configured as QCL type D and antenna ports referring to the different TCI states 700, 705, and 710 are associated with different spatial Rx parameters, that is, different beams.

Table 16 to Table 20 below show valid TCI state configurations according to a target antenna port type.

Table 16 shows valid TCI state configuration when the target antenna port is a CSI-RS for tracking (TRS). The TRS represents an NZP CSI-RS for which a repetition parameter is not configured and trs-Info is configured as true among CSI-RSs. Configuration 3 in Table 16 may be used for an aperiodic TRS.

TABLE 16
Valid TCI state configuration when the target
antenna port is CSI-RS for tracking (TRS)

| Valid TCI | | | DL RS 2 | qcl-Type2 |
|---|---|---|---|---|
| state | | | (if | (if |
| Configuration | DL RS 1 | qcl-Type1 | configured) | configured) |
| 1 | SSB | QCL-TypeC | SSB | QCL-TypeD |
| 2 | SSB | QCL-TypeC | CSI-RS (BM) | QCL-TypeD |
| 3 | TRS | QCL-TypeA | TRS (same as | QCL-TypeD |
| | (periodic) | | DL RS 1) | |

Table 17 shows valid TCI state configuration when the target antenna port is a CSI-RS for CSI. The CSI-RS for CSI represents an NZP CSI-RS for which a parameter (e.g., repetition parameter) indicating that repetition is not configured and trs-Info is not configured as true among the CSI-RSs.

TABLE 17
Valid TCI state configuration when the
target antenna port is CSI-RS for CSI

| Valid TCI | | | DL RS 2 | qcl-Type2 |
|---|---|---|---|---|
| state | | | (if | (if |
| Configuration | DL RS 1 | qcl-Type1 | configured) | configured) |
| 1 | TRS | QCL-TypeA | SSB | QCL-TypeD |
| 2 | TRS | QCL-TypeA | CSI-RS (BM) | QCL-TypeD |
| 3 | TRS | QCL-TypeA | TRS (same as | QCL-TypeD |
| | | | DL RS 1) | |
| 4 | TRS | QCL-TypeB | | |

Table 18 shows valid TCI state configuration when the target antenna port is a CSI-RS for beam management (BM) (the same meaning as CSI-RS for Li RSRP reporting). The CSI-RS for BM represents an NZP CSI-RS for which a repetition parameter is configured to have a value of on or off and trs-Info is not configured as true.

TABLE 18
Valid TCI state configuration when the target antenna
port is CSI-RS for BM (for L1 RSRP reporting)

| Valid TCI | | | DL RS 2 | qcl-Type2 |
|---|---|---|---|---|
| state | | | if | (if |
| Configuration | DL RS 1 | qcl-Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | SS/PBCH | QCL-TypeC | SS/PBCH | QCL-TypeD |
| | Block | | Block | |

Table 19 shows valid TCI state configuration when the target antenna port is a PDCCH DMRS.

TABLE 19
Valid TCI state configuration when the
target antenna port is PDCCH DMRS

| Valid TCI | | | DL RS 2 | qcl-Type2 |
|---|---|---|---|---|
| state | | | (if | (if |
| Configuration | DL RS 1 | qcl-Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | CSI-RS | QCL-TypeA | CSI-RS (same | QCL-TypeD |
| | (CSI) | | as DL RS 1) | |

Table 20 shows valid TCI state configuration when the target antenna port is a PDCCH DMRS.

TABLE 20
valid TCI state configurations when
the target antenna port is PDSCH DMRS

| Valid TCI | | | DL RS 2 | qcl-Type2 |
|---|---|---|---|---|
| state | | | (if | (if |
| Configuration | DL RS 1 | qcl-Type 1 | configured) | configured) |
| 1 | TRS | QCL-TypeA | TRS | QCL-TypeD |
| 2 | TRS | QCL-TypeA | CSI-RS (BM) | QCL-TypeD |
| 3 | CSI-RS | QCL-TypeA | CSI-RS (CSI) | QCL-TypeD |
| | (CSI) | | | |

In a representative QCL configuration method by Table 16 to Table 20 above, the target antenna port and the reference antenna port for each stage are configured and operated as “SSB”->“TRS”->“CSI-RS for CSI, CSI-RS for BM, PDCCH DMRS, or PDSCH DMRS.”.” Through this, it is possible to aid a reception operation of the UE by associating statistical characteristics measurable from the SSB and the TRS to the respective antennas.

### [PDCCH: Related to TCI State]

Specifically, TCI state combinations applicable to the PDCCH DMRS antenna port may be as shown in Table 21 below. In Table 21, a fourth row is a combination assumed by the UE before RRC configuration, and configuration after RRC is impossible.

TABLE 21

| | | | DL RS 2 | qcl-Type2 |
|---|---|---|---|---|
| Valid TCI state | | | (if | (if |
| Configuration | DL RS 1 | qcl-Type1 | configured) | configured) |
| 1 | TRS | QCL- | TRS | QCL-TypeD |
| | | TypeA | | |
| 2 | TRS | QCL- | CSI-RS (BM) | QCL-TypeD |
| | | TypeA | | |
| 3 | CSI-RS | QCL- | | |
| | (CSI) | TypeA | | |
| 4 | SS/PBCH | QCL- | SS/PBCH | QCL-TypeD |
| | Block | TypeA | Block | |

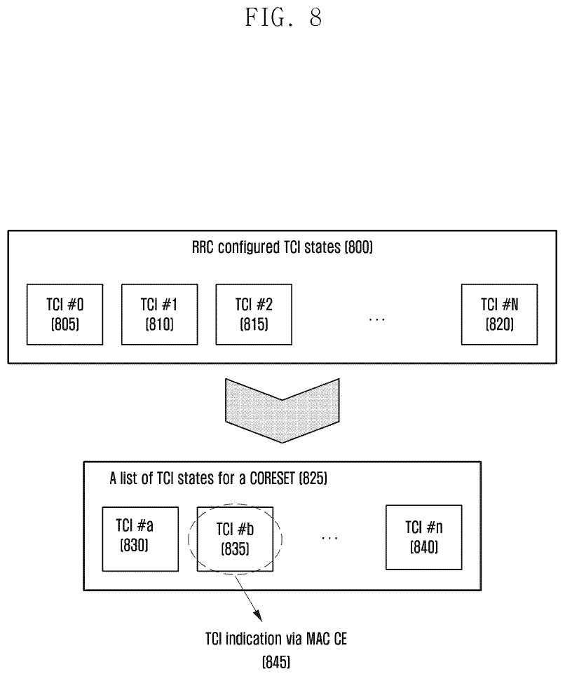

In NR, a hierarchical signaling method as illustrated in FIG. 8 is supported for dynamic allocation for a PDCCH beam. With reference to FIG. 8, the base station may configure N TCI states 805, 810, . . . , 820 in the UE through RRC signaling 800 and configure some of them as TCI states for CORESET as indicated by reference numeral 825. Then, the base station may indicate one of TCI states 830, 835, and 840 for CORESET to the UE through MAC CE signaling as indicated by reference numeral 845. Then, the UE may receive a PDCCH on the basis of beam information included in the TCI state indicated by the MAC CE signaling.

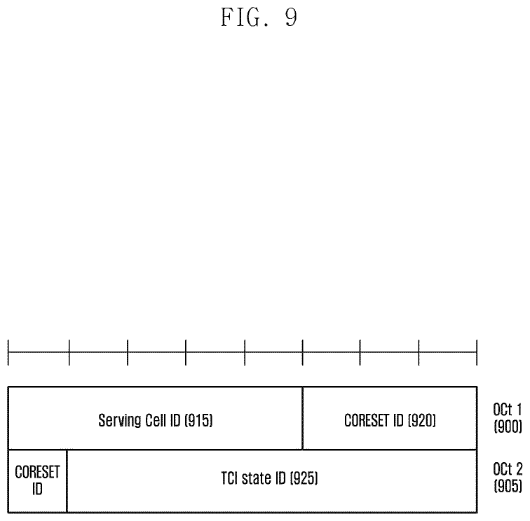

FIG. 9 illustrates a TCI indication MAC CE signaling structure for the PDCCH DMRS. With reference to FIG. 9, TCI indication MAC CE signaling for the PDCCH DMRS may include 2 bytes (16 bits), and may include a serving cell ID 915 of 5 bits, a CORESET ID 920 of 4 bits, and a TCI state ID 925 of 7 bits.

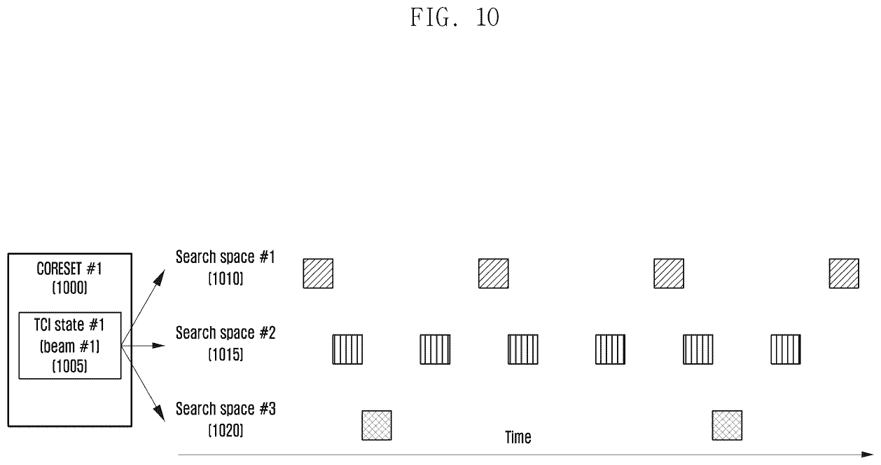

FIG. 10 illustrates an example of beam configuration of a control resource set (CORESET) and a search space according to the description. With reference to FIG. 10, the base station may indicate one of a TCI state list included in configuration of CORESET 1000 through MAC CE signaling as indicated by reference numeral 1005. Then, before another TCI state is indicated to corresponding CORESET through another MAC CE signaling, the UE may consider that the same QCL information (beam #1) 1005 is applied to one or more search spaces 1010, 1015, and 1020 associated with the CORESET. The above-described PDCCH beam allocation method has difficulty in indicating a beam change earlier than a MAC CE signaling delay and has a disadvantage of applying the same beam for each CORESET regardless of a search space characteristic, and thus makes a flexible PDCCH beam operation difficult. Hereinafter, embodiments of the disclosure provide a more flexible PDCCH beam configuration and operation method. In describing the following embodiments of the disclosure, some distinguished examples are provided for convenience of description, but they are not exclusive and may be applied through a proper combination thereof according to circumstances.

The base station may configure one or a plurality of TCI states for specific CORESET in the UE and activate one of the configured TCI states through a MAC CE activation command. For example, {TCI state #0, TCI state #1, TCI state #2} are configured in CORESET #1 as the TCI states, and the base station may transmit a command for activating TCI state #0 assumed as the TCI state for CORESET #1 to the UE through the MAC CE. The UE may correctly receive a DMRS of the corresponding CORESET on the basis of QCL information within the activated TCI state in response to the activation command for the TCI state received through the MAC CE.

For CORESET (CORESET #0) of which index is set to 0, if the UE does not receive the MAC CE activation command for the TCI state of CORESET #0, the UE may assume that a DMRS transmitted in CORESET #0 is QCLed with an SS/PBCH block identified in an initial access process or a non-contention-based random access process that is not triggered by a PDCCH command.

For CORESET (CORESET #X) of which index is set to a value other than 0, if a TCI state for CORESET #X is not configured for the UE or if at least one TCI state is configured for the UE but the UE does not receive a MAC CE activation command for activating one thereof, the UE may assume that a DMRS transmitted in CORESET #X is QCLed with an SS/PBCH block identified in an initial access process.

### [PDCCH: Related to QCL Prioritization Rule]

Hereinafter, an operation of determining QCL priority of a PDCCH is described in detail.

When a plurality of control resource sets operating by carrier aggregation in a single cell or band and present in an activated bandwidth part in a single or a plurality of cells overlap each other in the time domain while having the same or different QCL-TypeD characteristics in a specific PDCCH monitoring interval, the UE may select a specific control resource set according to a QCL priority determination operation, and monitor control resource sets having the same QCL-TypeD characteristic as that of the selected control resource set. That is, when a plurality of control resource sets overlap each other in the time domain, the UE may receive only one QCL-TypeD characteristic. Criteria capable of determining QCL priority may be as follows.
Criterion 1. A control resource set connected to a common search interval having a lowest index in a cell corresponding to a lowest index among cells including common search intervals
Criterion 2. A control resource set connected to a UE-specific search interval having a lowest index in a cell corresponding to a lowest index among cells including UE-specific search intervals

As described above, when each criterion is not satisfied, a next criterion is applied. For example, in a case in which control resource sets overlap each other in the time domain in a specific PDCCH monitoring interval, if all the control resource sets are connected to UE-specific search intervals rather than common search intervals, that is, if criterion 1 is not satisfied, the UE may omit application of criterion 1 and apply criterion 2.
In the case of selecting a control resource set according to the above-described criteria, the UE may additionally consider two items below for QCL information configured in the control resource set. First, if control resource set 1 has CSI-RS 1 as a reference signal having a relation of QCL-TypeD, a reference signal having a relation of QCL-TypeD with CSI-RS 1 is SSB 1, and a reference signal having a relation of QCL-TypeD with another control resource set, control resource set 2, is SSB 1, the UE may consider that two control resource sets 1 and 2 have different QCL-TypeD characteristics. Second, if control resource set 1 has CSI-RS 1 configured in cell 1 as a reference signal having a relation of QCL-TypeD, a reference signal having a relation of QCL-TypeD with CSI-RS 1 is SSB 1, control resource set 2 has CSI-RS 2 configured in cell 2 as a reference signal having a relation of QCL-TypeD, and a reference signal having a relation of QCL-TypeD with CSI-RS 2 is SSB 1, the UE may consider that the two control resource sets have the same QCL-TypeD characteristic.

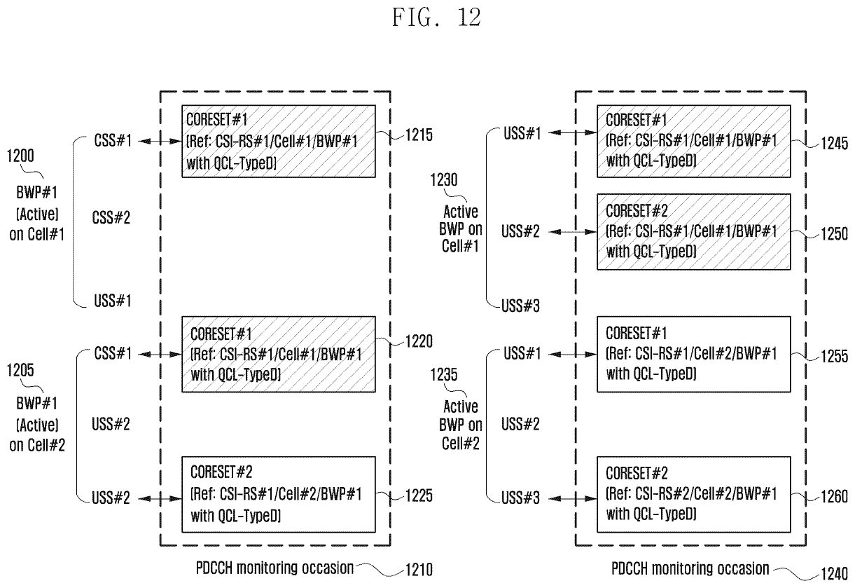

FIG. 12 illustrates a diagram of a method of selecting a receivable control resource set in consideration of priority when a UE receives a downlink control channel in a wireless communication system according to an embodiment of the disclosure. For example, a UE may be configured to receive a plurality of control resource sets overlapping each other in the time domain in a specific PDCCH monitoring occasion 1210, and each of the plurality of control resource sets may be connected to a common search space or a UE-specific search space with respect to a plurality of cells. In the corresponding PDCCH monitoring interval 1210, control resource set (CORESET) #1 1215 connected to common search interval #1 may be present in bandwidth part (BWP) #1 1200 of cell #1, and control resource set (CORESET) #1 1220 connected to common search interval #1 and control resource set (CORESET) #2 1225 connected to UE-specific search interval #2 may be present in bandwidth part (BWP) #1 1205 of cell #2. The control resource sets 1215 and 1220 may have a relation of QCL-TypeD with CSI-RS resource #1 configured in bandwidth part #1 of cell #1, and the control resource set 1225 may have a relation of QCL-TypeD with CSI-RS resource #1 configured in bandwidth part #1 of cell #2. Therefore, if criterion 1 is applied to the PDCCH monitoring occasion 1210, all the other control resource sets having a reference signal in the same QCL-TypeD as control resource set (CORESET) #1 1215 may be received. Therefore, the UE may receive the control resource sets 1215 and 1220 in the PDCCH monitoring occasion 1210. As another example, the UE may be configured to receive a plurality of control resource sets overlapping each other in the time domain in a specific PDCCH monitoring occasion 1240, and each of the plurality of control resource sets may be connected to a common search space or a UE-specific search space with respect to a plurality of cells. In the corresponding PDCCH monitoring interval 1240, control resource set (CORESET) #1 1245 connected to UE-specific search interval #1 and control resource set (CORESET) #2 1250 connected to UE-specific search interval #2 may be present in bandwidth part (BWP) #1 1230 of cell #1, and control resource set #1 (CORESET) 1255 connected to UE-specific search interval #1 and control resource set (CORESET) #2 1260 connected to UE-specific search interval #3 may be present in bandwidth part (BWP) #1 1235 of cell #2. The control resource sets 1245 and 1250 may have a relation of QCL-TypeD with CSI-RS resource #1 configured in bandwidth part #1 of cell #1, the control resource set 1255 may have a relation of QCL-TypeD with CSI-RS resource #1 configured in bandwidth part #1 of cell #2, and the control resource set 1260 may have a relation of QCL-TypeD with CSI-RS resource #2 configured in bandwidth part #1 of cell #2. However, if criterion 1 is applied to the PDCCH monitoring occasion 1240, criterion 2 that is the next criterion may be applied due to absence of the common search interval. If criterion 2 is applied to the PDCCH monitoring occasion 1240, all the other control resource sets having a reference signal in the same QCL-TypeD as the control resource set 1245 may be received. Therefore, the UE may receive the control resource sets 1245 and 1250 in the PDCCH monitoring occasion 1240.

### [Related to Rate Matching/Puncturing]

Hereinafter, a rate matching operation and a puncturing operation are described in detail.

If time and frequency resource A in which random symbol sequence A is to be transmitted overlaps with random time and frequency resource B, a rate matching or puncturing operation may be considered as an operation of transmitting or receiving channel A in consideration of resource C that is an area in which resource A and resource B overlap each other. A detailed operation may follow the contents below.

### Rate Matching Operation

A base station may transmit channel A after mapping channel A to only a remaining resource area excluding resource C corresponding to an area overlapping with resource B from the entire resource A in which the base station is to transmit symbol sequence A to a UE. For example, in a case in which symbol sequence A includes {symbol #1, symbol #2, symbol #3, symbol #4}, resource A is {resource #1, resource #2, resource #3, resource #4}, and resource B is {resource #3, resource #5}, the base station may transmit symbol sequence A after sequentially mapping symbol sequence A to a remaining resource {resource #1, resource #2, resource #4} excluding {resource #3} corresponding to resource C from resource A. Consequently, the base station may transmit the symbol sequence {symbol #1, symbol #2, symbol #3} after mapping the same to {resource #1, resource #2, resource #4}, respectively.

The UE may determine resource A and resource B from scheduling information on symbol sequence A from the base station, and, through this, may determine resource C that is an area in which resource A and resource B overlap each other. The UE may receive symbol sequence A with the assumption that symbol sequence A is transmitted after being mapped to the remaining area excluding resource C from the entire resource A. For example, in a case in which symbol sequence A includes {symbol #1, symbol #2, symbol #3, symbol #4}, resource A is {resource #1, resource #2, resource #3, resource #4}, and resource B is {resource #3, resource #5}, the UE may receive symbol sequence A with the assumption that symbol sequence A is sequentially mapped to the remaining resource {resource #1, resource #2, resource #4} excluding {resource #3} corresponding to resource C from resource A. Consequently, the UE may assume that the symbol sequence {symbol #1, symbol #2, symbol #3} is transmitted after being mapped to {resource #1, resource #2, resource #4}, respectively, and may perform a series of subsequent reception operations.

### Puncturing Operation

When resource C corresponding to an area overlapping with resource B is present in the entire resource A in which the base station is to transmit symbol sequence A to the UE, the base station may map symbol sequence A to the entire resource A and may perform transmission only in a remaining resource area excluding resource C from resource A without performing transmission in a resource area corresponding to resource C. For example, in a case in which symbol sequence A includes {symbol #1, symbol #2, symbol #3, symbol #4}, resource A is {resource #1, resource #2, resource #3, resource #4}, and resource B is {resource #3, resource #5}, the base station may map symbol sequence A {symbol #1, symbol #2, symbol #3, symbol #4} to resource A {resource #1, resource #2, resource #3, resource #4}, respectively, may only transmit a symbol sequence {symbol #1, symbol #2, symbol #4} corresponding to a remaining resource {resource #1, resource #2, resource #4} excluding {resource #3} corresponding to resource C from resource A, and may not transmit {symbol #3} mapped to {resource #3} corresponding to resource C. Consequently, the base station may transmit the symbol sequence {symbol #1, symbol #2, symbol #4} after mapping the same to {resource #1, resource #2, resource #4}, respectively.

The UE may determine resource A and resource B from scheduling information on symbol sequence A from the base station, and, through this, may determine resource C that is an area in which resource A and resource B overlap each other. The UE may receive symbol sequence A with the assumption that symbol sequence A is mapped to entire resource A, but is transmitted only in a remaining area excluding resource C from resource area A. For example, in a case in which symbol sequence A includes {symbol #1, symbol #2, symbol #3, symbol #4}, resource A is {resource #1, resource #2, resource #3, resource #4}, and resource B is {resource #3, resource #5}, the UE may assume that symbol sequence A {symbol #1, symbol #2, symbol #3, symbol #4} is mapped to resource A {resource #1, resource #2, resource #3, resource #4}, respectively, but {symbol #3} mapped to {resource #3} corresponding to resource C is not transmitted, and may perform reception with the assumption that a symbol sequence {symbol #1, symbol #2, symbol #4} corresponding to a remaining resource (resource #1, resource #2, resource #4) excluding {resource #3} corresponding to resource C from resource A is mapped and transmitted. Consequently, the UE may assume that the symbol sequence {symbol #1, symbol #2, symbol #4} is transmitted after being mapped to {resource #1, resource #2, resource #4}, respectively, and may perform a series of subsequent reception operations.

Hereinafter, a method of configuring a rate matching resource for rate matching of the 5G communication system is described. Rate matching implies that the size of a signal is adjusted in consideration of an amount of resources available for signal transmission. For example, rate matching of a data channel may imply that the data channel is not transmitted after being mapped to a specific time and frequency resource area and the size of data is adjusted accordingly.

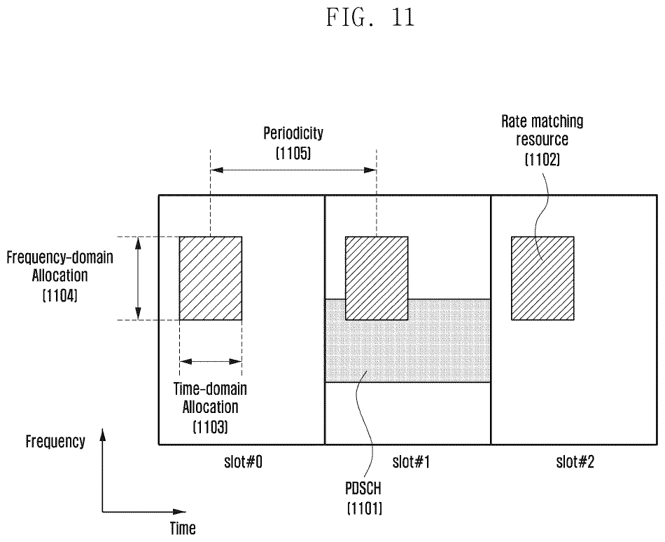

FIG. 11 illustrates a diagram of a method of transmitting or receiving data in consideration of a downlink data channel and a rate matching resource by a base station and a UE.

FIG. 11 illustrates a downlink data channel (PDSCH) 1101 and a rate matching resource 1102. The base station may configure, in the UE, one or a plurality of rate matching resources 1102 through higher layer signaling (e.g., RRC signaling). Configuration information on the rate matching resource 1102 may include time axis resource allocation information (time-domain allocation) 1103, frequency axis resource allocation information (frequency-domain allocation) 1104, and period information (periodicity) 1105. In the following description, a bitmap corresponding to the frequency axis resource allocation information 1104 is named a “first bitmap,”,” a bitmap corresponding to the time axis resource allocation information 1103 is named a “second bitmap,”,” and a bitmap corresponding to the period information 1105 is named a “third bitmap.”.” If all or a portion of time and frequency resources of the scheduled data channel 1101 overlaps the configured rate matching resource 1102, the base station may perform transmission by rate-matching the data channel 1101 in a part of the rate matching resource 1102, and the UE may perform reception and decoding after assuming that the data channel 1101 is rate-matched in the part of the rate matching resource 1102.

The base station may dynamically notify the UE of whether to perform rate matching of the data channel in the configured rate matching resource part, through DCI through additional configuration (which corresponds to “rate matching indicator” in DCI format described above). Specifically, the base station may select some of the configured rate matching resources and group the selected resources into a rate matching resource group, and may indicate whether the data channel is rate-matched for each rate matching resource group, to the UE through DCI using a bitmap scheme. For example, when four rate matching resources, RMR #1, RMR #2, RMR #3, and RMR #4, are configured, the base station may configure RMG #1={RMR #1, RMR #2} and RMG #2={RMR #3, RMR #4} as rate matching groups, and may indicate whether rate matching is performed in RMG #1 and RMG #2, to the UE through a bitmap using 2 bits in a DCI field, respectively. For example, if rate matching is needed, “1” may be indicated, and if rate matching is required not to be performed, “0” may be indicated.

5G supports the granularity of “RB symbol level” and “RE level” as a method of configuring a rate matching resource for a UE described above. More specifically, the following configuration method may be followed.

### RB Symbol Level

A maximum of four RateMatchPatterns for each bandwidth part may be configured for the UE through higher layer signaling, and one RateMatchPattern may include the following contents.

As a reserved resource in a bandwidth part, a resource in which a time and frequency resource area of the reserved resource is configured by a combination of a bitmap having an RB level in the frequency axis and a bitmap having a symbol level may be included. The reserved resource may be spanned over one or two slots. A time domain pattern (periodicityAndPattern) in which time and frequency domain configured by each pair of RB level and symbol level bitmaps is repeated may be additionally configured.

A time and frequency domain resource area configured by a control resource set in a bandwidth part and a resource area corresponding to a time domain pattern configured by configuring a search space in which the corresponding resource area is repeated may be included.

### RE Level

The following contents may be configured for a UE through higher layer signaling.

Configuration information (lte-CRS-ToMatchAround) on a RE corresponding to an LTE cell-specific reference signal or common reference signal (CRS) pattern may include the number (nrofCRS-Ports) of ports of an LTE CRS and a value (v-shift) of LTE-CRS-vshift(s), information (carrierFreqDL) on a location of a center subcarrier of an LTE carrier from a frequency point (e.g., reference point A) serving as a criterion, information (carrierBandwidthDL) on a bandwidth size of an LTE carrier, and subframe configuration information (mbsfn-SubframConfigList) corresponding to a multicast-broadcast single-frequency network (MBSFN). The UE may determine a location of a CRS in an NR slot corresponding to an LTE subframe, based on the information described above.

Configuration information on a resource set corresponding to one or a plurality of zero power (ZP) CSI-RSs in a bandwidth part may be included.

### [Related to LTE CRS Rate Matching]

Hereinafter, a rate matching process for the above-described LTE CRS is described in detail. For coexistence between LTE and new RAT (NR) (LTE-NR coexistence), NR provides a function of configuring a pattern of a cell-specific reference signal (CRS) of LTE to an NR UE. More specifically, the CRS pattern may be provided by RRC signaling including at least one parameter in a ServingCellConfig information element (IE) or a ServingCellConfigCommon IE. For example, the parameter may be lte-CRS-ToMatchAround, lte-CRS-PatternList1-r16, lte-CRS-PatternList2-r16, or crs-RateMatch-PerCORESETPoolIndex-r16.

Rel-15 NR provides a function of configuring one CRS pattern per serving cell through the Ite-CRS-ToMatchAround parameter. In Rel-16 NR, the function is expanded to make it possible to configure a plurality of CRS patterns per serving cell. More specifically, one CRS pattern per LTE carrier may be configured in a single-transmission and reception point (TRP) configuration UE, and two CRS patterns per LTE carrier may be configured in a multi-TRP configuration UE. For example, up to three CRS patterns per serving cell may be configured in a single-TRP configuration UE through the lte-CRS-PatternList1-r16 parameter. As another example, a CRS for each TRP may be configured in a multi-TRP configuration UE. That is, a CRS pattern for TRP1 may be configured for the lte-CRS-PatternList1-r16 parameter, and a CRS pattern for TRP2 may be configured through the lte-CRS-PatternList2-r16 parameter. When two TRPs are configured as described above, whether to apply both the CRS patterns of TRP1 and TRP2 to a specific PDSCH or whether to apply only the CRS pattern of one TRP is determined through the crs-RateMatch-PerCORESETPoolIndex-r16 parameter. When the crs-RateMatch-PerCORESETPoolIndex-r16 is configured to be enabled, only the CRS pattern of one TRP is applied, and otherwise, the CRS patterns of the two TRPs are both applied.

Table 22 shows a ServingCellConfig IE including the CRS pattern, and Table 23 shows a RateMatchPatternLTE-CRS IE including at least one parameter for a CRS pattern.

TABLE 22

| | |
|---|---|
| ServingCellConfig ::= | SEQUENCE { |

| | |
|---|---|
| tdd-UL-DL-ConfigurationDedicated | TDD-UL-DL-ConfigDedicated |

OPTIONAL, -- Cond TDD

| | |
|---|---|
| initialDownlinkBWP | BWP-DownlinkDedicated |

OPTIONAL, -- Need M

| | |
|---|---|
| downlinkBWP-ToReleaseList | SEQUENCE (SIZE (1..maxNrofBWPs)) OF BWP-Id |

OPTIONAL, -- Need N

| downlinkBWP-ToAddModList | | SEQUENCE (SIZE (1..maxNrofBWPs)) OF BWP- |
|---|---|---|
| Downlink | OPTIONAL, -- Need N | |
| firstActiveDownlinkBWP-Id | BWP-Id | OPTIONAL, |

-- Cond SyncAndCellAdd

| | |
|---|---|
| bwp-InactivityTimer | ENUMERATED {ms2, ms3, ms4, ms5, ms6, ms8, ms10, |

ms20, ms30,

```
        ms40,ms50, ms60, ms80,ms100, ms200,ms300, ms500,
        ms750, ms1280, ms1920, ms2560, spare10, spare9, spare8,
        spare7, spare6, spare5, spare4, spare3, spare2, spare1 }
```

OPTIONAL, -- Need R

| | | |
|---|---|---|
| defaultDownlinkBWP-Id | BWP-Id | OPTIONAL, |

-- Need S

| | | |
|---|---|---|
| uplinkConfig | UplinkConfig | OPTIONAL, |

-- Need M

| | | |
|---|---|---|
| supplementaryUplink | UplinkConfig | OPTIONAL, |

-- Need M

| | |
|---|---|
| pdcch-ServingCellConfig | SetupRelease { PDCCH-ServingCellConfig } |

OPTIONAL, -- Need M

| | |
|---|---|
| pdsch-ServingCellConfig | SetupRelease { PDSCH-ServingCellConfig } |

OPTIONAL, -- Need M

| | |
|---|---|
| csi-MeasConfig | SetupRelease { CSI-MeasConfig } |

OPTIONAL, -- Need M

| sCellDeactivationTimer | ENUMERATED {ms20, ms40, ms80, ms160, ms200, ms240, | |
|---|---|---|
| | ms320, ms400, ms480, ms520, ms640, ms720, | |
| | ms840, ms1280, spare2,spare1} | OPTIONAL, -- Cond |

ServingCellWithoutPUCCH

| | |
|---|---|
| crossCarrierSchedulingConfig | CrossCarrierSchedulingConfig |

OPTIONAL, -- Need M

| tag-Id | TAG-Id, | |
|---|---|---|
| dummy | ENUMERATED {enabled} | OPTIONAL, |

-- Need R

| | |
|---|---|
| pathlossReferenceLinking | ENUMERATED {spCell, sCell} |

OPTIONAL, -- Cond ScellOnly

| | | |
|---|---|---|
| servingCellMO | MeasObjectId | OPTIONAL, |

```
-- Cond MeasObject
  ...,
  [[
```

| | |
|---|---|
| lte-CRS-ToMatchAround | SetupRelease { RateMatchPatternLTE-CRS } |

OPTIONAL, -- Need M

| rateMatchPatternToAddModList | | SEQUENCE (SIZE (1..maxNrofRateMatchPatterns)) |
|---|---|---|
| OF RateMatchPattern | OPTIONAL, -- Need N | |
| rateMatchPatternToReleaseList | | SEQUENCE (SIZE (1..maxNrofRateMatchPatterns)) OF |
| RateMatchPatternId | OPTIONAL, -- Need N | |
| downlinkChannelBW-PerSCS-List | | SEQUENCE (SIZE (1..maxSCSs)) OF SCS- |

| | |
|---|---|
| SpecificCarrier | OPTIONAL -- Need S |

```
  ]],
  [[
```

| | |
|---|---|
| supplementaryUplinkRelease | ENUMERATED {true} |

OPTIONAL, -- Need N

| | |
|---|---|
| tdd-UL-DL-ConfigurationDedicated-IAB-MT-r16 | TDD-UL-DL-ConfigDedicated-IAB- |

| | |
|---|---|
| MT-r16 | OPTIONAL, -- Cond TDD_IAB |

| | |
|---|---|
| dormantBWP-Config-r16 | SetupRelease { DormantBWP-Config-r16 } |

OPTIONAL, -- Need M

| | |
|---|---|
| ca-SlotOffset-r16 | CHOICE { |
| refSCS15kHz | INTEGER (−2..2), |
| refSCS30KHz | INTEGER (−5..5), |
| refSCS60KHz | INTEGER (−10..10), |
| refSCS120KHz | INTEGER (−20..20) |

| | |
|---|---|
| } | OPTIONAL, -- Cond |

AsyncCA

| | |
|---|---|
| channelAccessConfig-r16 | SetupRelease { ChannelAccessConfig-r16 } |

OPTIONAL, -- Need M

| | |
|---|---|
| intraCellGuardBandsDL-List-r16 | SEQUENCE (SIZE (1..maxSCSs)) OF |

| | |
|---|---|
| IntraCellGuardBandsPerSCS-r16 | OPTIONAL, -- Need S |

| | |
|---|---|
| intraCellGuardBandsUL-List-r16 | SEQUENCE (SIZE (1..maxSCSs)) OF |

| | |
|---|---|
| IntraCellGuardBandsPerSCS-r16 | OPTIONAL, -- Need S |

| | |
|---|---|
| csi-RS-ValidationWith-DCI-r16 | ENUMERATED {enabled} |

OPTIONAL, -- Need R

| | |
|---|---|
| lte-CRS-PatternList1-r16 | SetupRelease { LTE-CRS-PatternList-r16 } |

OPTIONAL, -- Need M

| | |
|---|---|
| lte-CRS-PatternList2-r16 | SetupRelease { LTE-CRS-PatternList-r16 } |

OPTIONAL, -- Need M

| | |
|---|---|
| crs-RateMatch-PerCORESETPoolIndex-r16 | ENUMERATED {enabled} |

OPTIONAL, -- Need R

| | |
|---|---|
| enableTwoDefaultTCI-States-r16 | ENUMERATED {enabled} |

OPTIONAL, -- Need R

| | |
|---|---|
| enableDefaultTCI-StatePerCoresetPoolIndex-r16 | ENUMERATED {enabled} |

OPTIONAL, -- Need R

| | |
|---|---|
| enableBeamSwitchTiming-r16 | ENUMERATED {true} |

OPTIONAL, -- Need R

| | |
|---|---|
| cbg-TxDiffTBsProcessingType1-r16 | ENUMERATED {enabled} |

OPTIONAL, -- Need R

| | |
|---|---|
| cbg-TxDiffTBsProcessingType2-r16 | ENUMERATED {enabled} |

OPTIONAL -- Need R
]]
}

```
TABLE 23
      - RateMatchPatternLTE-CRS
  The IE RateMatchPatternLTE-CRS is used to configure a pattern to rate match around
LTE CRS. See TS 38.214 [19], clause 5.1.4.2.
        RateMatchPatternLTE-CRS information element
  -- ASN1START
  -- TAG-RATEMATCHPATTERNLTE-CRS-START
```

| | |
|---|---|
| RateMatchPatternLTE-CRS ::= | SEQUENCE { |
| carrierFreqDL | INTEGER (0..16383), |
| carrierBandwidthDL | ENUMERATED {n6, n15, n25, n50, n75, n100, |

spare2, spare1},

| | |
|---|---|
| mbsfn-SubframeConfigList | EUTRA-MBSFN-SubframeConfigList |

OPTIONAL, -- Need M

| | |
|---|---|
| nrofCRS-Ports | ENUMERATED {n1, n2, n4}, |
| v-Shift | ENUMERATED {n0, n1, n2, n3, n4, n5} |

}

| | |
|---|---|
| LTE-CRS-PatternList-r16 ::= | SEQUENCE (SIZE (1..maxLTE-CRS-Patterns-r16)) |

```
OF RateMatchPatternLTE-CRS
  -- TAG-RATEMATCHPATTERNLTE-CRS-STOP
  -- ASN1STOP
```

RateMatch PatternLTE-CRS field descriptions

carrierBandwidthDL
BW of the LTE carrier in number of PRBs (see TS 38.214 [19], clause 5.1.4.2).
carrierFreqDL
Center of the LTE carrier (see TS 38.214 [19], clause 5.1.4.2).
mbsfn-SubframeConfigList
LTE MBSFN subframe configuration (see TS 38.214 [19], clause 5.1.4.2).
nrofCRS-Ports
Number of LTE CRS antenna port to rate-match around (see TS 38.214 [19], clause
5.1.4.2).
v-Shift
Shifting value v-shift in LTE to rate match around LTE CRS (see TS 38.214 [19],
clause 5.1.4.2).

### [PDSCH: Processing Procedure Time]

Hereinafter, a PDSCH processing procedure time is described. When the base station schedules the LTE to transmit a PDSCH using DCI format 1_0, 1_1, or 1_2, the LTE may require a PDSCH processing procedure time for receiving the PDSCH by applying a transmission method indicated through DCI (modulation and coding indication index (MCS), demodulation reference signal-related information, and time and frequency resource allocation information). NR considers this and defines the PDSCH processing procedure time. The PDSCH processing procedure time of the UE may follow [Equation 2] below.

$${T}_{proc , 1} = ( {N}_{1} + {d}_{1 , 1} + {d}_{2} ) ( 2048 + 1 \; 44 ) {κ2}^{- μ} {T}_{c} + {T}_{ext .} \qquad [ Equation 2 ]$$

In Tproc,1 described above in Equation 2, each variable may have the following meaning.
N1: The number of symbols determined by UE processing capability 1 or 2 and numerology μ according to capability of the UE. When reported as UE processing capability 1 according to capability report of the UE, it may have a value of [Table 24], and when reported as UE processing capability 2 and configured through higher layer signaling that UE processing capability 2 is available, it may have a value of [Table 25]. Numerology μ may correspond to a minimum value among μPDCCH, μPDSCH, and μUL to maximize the above Tproc,1, and μPDCCH, μPDSCH, and μUL may represent a numerology of a PDCCH that schedules a PDSCH, a numerology of the scheduled PDSCH, and a numerology of an upper link channel through which HARQ-ACK is to be transmitted, respectively.

TABLE 24
PDSCH processing procedure time
for PDSCH processing capability 1

| | PDSCH decoding time N₁ [symbols] | |
|---|---|---|
| | If dmrs-AdditionalPosition = | Unless dmrs-AdditionalPosition = |
| | pos0 within DMRS- | pos0 within DMRS-DownlinkConfig |
| | DownlinkConfig in | in which PDSCH mapping types |
| | which PDSCH mapping | A and B both are higher layer |
| | types A and B both are | signaling, or if higher layer |
| μ | higher layer signaling | parameter is not configured |
| 0 | 8 | N_{1, 0} |
| 1 | 10 | 13 |
| 2 | 17 | 20 |
| 3 | 20 | 24 |

TABLE 25
PDSCH processing procedure time
for PDSCH processing capability 2

| | PDSCH decoding time N₁ [symbols] |
|---|---|
| | For dmrs-AdditionalPosition = pos0 within |
| | DMRS-DownlinkConfig in which PDSCH mapping types |
| μ | A and B both are higher layer signaling, |
| 0 | 3 |
| 1 | 4.5 |
| 2 | 9 for frequency range 1 |

κ: 64
Text: When the UE uses a shared spectrum channel access method, the UE may calculate Text and may apply the same to the PDSCH processing procedure time. Otherwise, Text is assumed as 0.
If 11 indicating a PDSCH DMRS location value is 12, N1,0 of [Table x2-2] above has a value of 14 and otherwise, has a value of 13.
For PDSCH mapping type A, if a last symbol of the PDSCH is an ith symbol in a sloth in which the PDSCH is transmitted, and i<7, d1,1 is 7-i, and otherwise, d1,1=0.
d2: When a PUCCH with a high priority index and a PUCCH or a PUSCH with a low priority index overlap in time, d2 of the PUCCH with the high priority index may be set to a value reported from the UE. Otherwise, d2=0.
When PDSCH mapping type B is used for UE processing capability 1, a value of d1,1 may be determined based on the number of symbols of the scheduled PDSCH, L, and the number of overlapping symbols between the PDCCH that schedules the PDSCH and the scheduled PDSCH, d, as follows.

$$- If L \geq 7 , d 1 , 1 = 0.$$

$$- If L \geq 4 and L \leq 6 , d 1 , 1 = 7 - L .$$

$$- If L = 3 , d 1 , 1 = min ( d , 1 ) .$$

$$- If L = 2 , d 1 , 1 = 3 + d .$$

When PDSCH mapping type B is used for UE processing capability 2, a value of d1,1 may be determined based on the number of symbols of the scheduled PDSCH, L, and the number of overlapping symbols between the PDCCH that schedules the PDSCH and the scheduled PDSCH, d, as follows.

$$- If L \geq 7 , d 1 , 1 = 0.$$

$$- If L \geq 4 , L \leq 6 , d 1 , 1 = 7 - L .$$

$$- For L = 2 ,$$

If the scheduled PDCCH is present within CORESET including three symbols, and the corresponding CORESET and the scheduled PDSCH have the same start symbol, d1,1=3.
Otherwise, d1,1=d.
For the UE that supports capability 2 within a given serving cell, a PDSCH processing procedure time according to UE processing capability 2 may be applied when higher layer signaling for the corresponding cell of the UE, processingType2Enabled, is set to enable.

If a location of a first uplink transmission symbol of a PUCCH including HARQ-ACK information (the location may consider K1 defined as a transmission point in time of HARQ-ACK, PUCCH resources used for HARQ-ACK transmission, and timing advance effect) does not start before a first uplink transmission symbol that appears after a time of Tproc,1 from a last symbol of the PDSCH, the UE needs to transmit a valid HARQ-ACK message. That is, the UE needs to transmit the PUCCH that includes HARQ-ACK only when the PDSCH processing procedure time is sufficient. Otherwise, the UE may not provide the base station with valid HARQ-ACK information corresponding to the scheduled PDSCH. The Tproc,1 may be used for both normal and extended CP cases. For the PDSCH that includes two PDSCH transmission locations within a single slot, d1,1 is calculated based on a first PDSCH transmission location within the corresponding slot.

### [PDSCH: Reception Preparation Procedure Time During Cross-Carrier Scheduling]

Hereinafter, in the case of cross-carrier scheduling in which numerology μPDCCH through which the PDCCH subsequently scheduled is transmitted and numerology μPDSCH through which the PDSCH scheduled through the corresponding PDCCH is transmitted differ from each other, PDSCH reception preparation procedure time of the UE defined for a time interval between the PDCCH and the PDSCH, Npdsch, is described.

If μPDCCH<μPDSCH, the scheduled PDSCH may not be transmitted earlier than a first symbol of a slot that appears after Npdsch symbols from a last symbol of the PDCCH that schedules the corresponding PDSCH. The transmission symbol of the PDSCH may include a DM-RS.

If μPDCCH>μPDSCH, the scheduled PDSCH may be transmitted after Npdsch symbols from the last symbol of the PDCCH that schedules the corresponding PDSCH. The transmission symbol of the PDSCH may include a DM-RS.

TABLE 25
N_{pdsch} according to scheduled PDCCH subcarrier spacing

| μ_{PDCCH} | N_{pdsch} [symbols] |
|---|---|
| 0 | 4 |
| 1 | 5 |
| 2 | 10 |
| 3 | 14 |

### [Related to SRS]

Hereinafter, an uplink channel estimation method using sounding reference signal (SRS) transmission of the UE is described. The base station may configure at least one SRS configuration for each uplink BWP to transmit configuration information for SRS transmission, and may also configure at least one SRS resource set for each SRS configuration. For example, the base station and the UE may exchange the following higher signaling information to transmit information on the SRS resource set:
srs-ResourceSetId: SRS resource set index;
srs-ResourceIdList: A set of SRS resource indexes referenced in the SRS resource set;
resourceType: Time-axis transmission configuration of the SRS resource referenced in the SRS resource set, which may be configured as one of “periodic,” “semi-persistent,” and “aperiodic.” If configured as “periodic” or “semi-persistent,” associated CSI-RS information may be provided depending on usage of the SRS resource set. If configured “aperiodic,” an aperiodic SRS resource trigger list and slot offset information may be provided, and associated CSI-RS information may be provided depending on the usage of the SRS resource set;
usage: It refers to configuration for the usage of the SRS resource referenced in the SRS resource set, and may be configured as one of “beamManagement,” “codebook,” “nonCodebook,” and “antennaSwitching,” and
alpha, p0, pathlossReferenceRS, srs-PowerControlAdjustmentStates: Parameter configuration for transmission power adjustment of the SRS resource referenced in the SRS resource set is provided.

The UE may understand that the SRS resource included in a set of SRS resource indexes referenced in the SRS resource set follows information configured in the SRS resource set.

Also, the base station and the UE may transmit and receive higher layer signaling information to transmit individual configuration information on the SRS resources. For example, individual configuration information on the SRS resource may include time-frequency axis mapping information within a slot of the SRS resource, and this may include information on frequency hopping within the slot of SRS resource or between slots. Also, individual configuration information on the SRS resource may include time axis transmission configuration of the SRS resource, and may be configured as one of “periodic,” “semi-persistent,” and “aperiodic.” This may be restricted to have the same time axis transmission configuration as the SRS resource set in which the SRS resource is included. If the time axis transmission configuration of the SRS resource is configured to be “periodic” or “semi-persistent,” SRS resource transmission periodicity and slot offset (e.g., periodicityAndOffset) may be additionally included in the time axis transmission configuration.

The base station may activate, deactivate, or trigger SRS transmission to the UE through higher layer signaling including RRC signaling or MAC CE signaling, or L1 signaling (e.g., DCI). For example, the base station may activate or deactivate periodic SRS transmission to the UE through higher layer signaling. The base station may indicate activation of the SRS resource set in which resourceType is configured as periodic through higher layer signaling, and the UE may transmit the SRS resource referenced in the activated SRS resource set. Time-frequency axis resource mapping within the slot of the transmitted SRS resource follows resource mapping information configured in the SRS resource, and slot mapping including transmission periodicity and slot offset follows periodicityAndOffset configured in the SRS resource. Also, a spatial domain transmission filter that applies to the transmitted SRS resource may refer to spatial relation info configured in the SRS resource, or may refer to associated CSI-RS information configured in the SRS resource set in which the SRS resource is included. The UE may transmit the SRS resource within an activated uplink BWP for the activated periodic SRS resource through higher layer signaling.

For example, the base station may activate or deactivate semi-persistent SRS transmission through higher layer signaling. The base station may indicate activation of the SRS resource set through MAC CE signaling, and the UE may transmit the SRS resource referenced in the activated SRS resource set. The SRS resource set activated through MAC CE signaling may be limited to the SRS resource set in which resourceType is configured as semi-persistent. Time-frequency axis resource mapping within the slot of the transmitted SRS resource follows resource mapping information configured in the SRS resource, and slot mapping including transmission periodicity and slot offset follows periodicityAndOffset configured in the SRS resource. Also, a spatial domain transmission filter that applies to the transmitted SRS resource may refer to spatial relation info configured in the SRS resource, or may refer to associated CSI-RS information configured in the SRS resource set in which the SRS resource is included. If spatial relation info is configured in the SRS resource, this is not followed and the spatial domain transmission filter may be determined with reference to configuration information on the spatial relation info that is transmitted through MAC CE signaling activating semi-persistent SRS transmission. The UE may transmit the SRS resource within the activated uplink BWP for the activated semi-persistent SRS resource through higher layer signaling.

For example, the base station may trigger aperiodic SRS transmission to the UE through DCI. The base station may indicate one aperiodic SRS resource trigger (aperiodicSRS-ResourceTrigger) through an SRS request field of DCI. The UE may understand that the SRS resource set including the aperiodic SRS resource trigger indicated through DCI is triggered from an aperiodic SRS resource trigger list, in the configuration information of the SRS resource set. The UE may transmit the SRS resource referenced in the triggered SRS resource set. Time-frequency axis resource mapping within the slot of the transmitted SRS resource follows resource mapping information configured in the SRS resource. Also, slot mapping of the transmitted SRS resource may be determined through slot offset between the PDCCH including DCI and the SRS resource, and this may refer to value(s) included in a slot offset set configured in the SRS resource set. Specifically, the slot offset between the PDCCH including DCI and the SRS resource may apply a value indicated in a time domain resource assignment field of DCI among offset value(s) included in the slot offset set configured in the SRS resource set. Also, a spatial domain transmission filter that applies to the transmitted SRS resource may refer to spatial relation info configured in the SRS resource, or may refer to associated CSI-RS information configured in the SRS resource set in which the SRS resource is included. The UE may transmit the SRS resource within the activated uplink BWP for the aperiodic SRS resource triggered through DCI.

When the base station triggers aperiodic SRS transmission through DCI, the UE may require a minimum time interval between the PDCCH including DCI that triggers aperiodic SRS transmission and the SRS to be transmitted, in order to transmit the SRS by applying configuration information on the SRS resource. The time interval for SRS transmission of the UE may be defined by the number of symbols between the last symbol of the PDCCH including DCI that triggers aperiodic SRS transmission and the first symbol in which the most initially transmitted SRS resource among SRS resource(s) to be transmitted is mapped. The minimum time interval may be defined with reference to the PUSCH preparation procedure time required for the UE to prepare for PUSCH transmission. Also, the minimum time interval may have a different value depending on usage of the SRS resource set that includes the transmitted SRS resource. For example, the minimum time interval may be defined by N2 symbols that are defined by considering UE processing capability according to UE capability with reference to the PUSCH preparation procedure time of the UE. Also, when the usage of the SRS resource set is configured as “codebook” or “antennaSwitching” in consideration of usage of the SRS resource set including the transmitted SRS resource, the minimum time interval may be determined as N2 symbols, and when the usage of the SRS resource set is configured as “nonCodebook” or “beamManagement,” the minimum time interval may be determined as N2+14 symbols. The UE may transmit an aperiodic SRS when the time interval for SRS transmission is greater than or equal to the minimum time interval, or may ignore DCI that triggers the aperiodic SRS when the time interval for aperiodic SRS transmission is less than the minimum time interval.

TABLE 26

| | |
|---|---|
| SRS-Resource ::= | SEQUENCE { |
| srs-ResourceId | SRS-ResourceId, |
| nrofSRS-Ports | ENUMERATED {port1, ports2, ports4}, |
| ptrs-PortIndex | ENUMERATED {n0, n1 } |

OPTIONAL, -- Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
      }
    },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, |

groupHopping, sequenceHopping },

| | |
|---|---|
| resourceType | CHOICE { |
| aperiodic | SEQUENCE { |

```
        ...
      },
```

| | |
|---|---|
| semi-persistent | SEQUENCE { |
| periodicityAndOffset-sp | SRS-PeriodicityAndOffset, |

```
        ...
      },
```

| | |
|---|---|
| periodic | SEQUENCE { |
| periodicityAndOffset-p | SRS-PeriodicityAndOffset, |

```
        ...
      }
    },
```

| | |
|---|---|
| 79oncohereneId | INTEGER (0..1023), |
| spatialRelationInfo | SRS-SpatialRelationInfo |

```
OPTIONAL, -- Need R
    ...
  }
```

spatialRelationInfo configuration information of [Table 26] above refers to a single reference signal to apply beam information of the reference signal to a beam used for corresponding SRS transmission. For example, configuration of spatialRelationInfo may include information as shown in [Table 27] below.

TABLE 27

| SRS-SpatialRelationInfo ::= | SEQUENCE { | |
|---|---|---|
| servingCellId | ServCellIndex | OPTIONAL, -- Need S |

| | |
|---|---|
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |

```
    }
  }
}
```

Referring to the above spatialRelationInfo configuration, an SS/PBCH block index, a CSI-RS index, or an SRS index may be configured as an index of a reference signal to be referenced in order to use beam information of a specific reference signal. Higher signaling referenceSignal is configuration information indicating beam information of which reference signal is to be referenced for corresponding SRS information, ssb-Index indicates an index of an SS/PBCH block, csi-RS-Index indicates an index of a CSI-RS, and srs indicates an index of an SRS. If a value of higher signaling referenceSignal is configured as “ssb-Index,” the UE may apply a reception beam used when receiving the SS/PBCH block corresponding to ssb-Index, as a transmission beam of corresponding SRS transmission. If the value of higher signaling referenceSignal is configured as “csi-RS-Index,” the UE may apply a reception beam used when receiving the CSI-RS corresponding to csi-RS-Index, as the transmission beam of corresponding SRS transmission. If the value of higher signaling referenceSignal is configured “srs,” the UE may apply the transmission beam used when transmitting the SRS corresponding to srs, as the transmission beam of the corresponding SRS transmission.

### [PUSCH: Related to Transmission Scheme]

Next, a scheme of scheduling PUSCH transmission is described. The PUSCH transmission may be dynamically scheduled by a UL grant in DCI, or may be operated by configured grant Type 1 or Type 2. Dynamic scheduling indication for PUSCH transmission may be performed through DCI format 0_0 or 0_1.

Configured grant Type 1 PUSCH transmission may be semi-statically configured through reception of configuredGrantConfig including rrc-ConfiguredUplinkGrant shown in Table 28 through higher signaling without receiving a UL grant in DCI. Configured grant Type 2 PUSCH transmission may be semi-persistently scheduled by the UL grant in the DCI after reception of configuredGrantConfig not including rrc-ConfiguredUplinkGrant shown in Table 28 through higher signaling. When the PUSCH transmission operates by a configured grant, parameters applied to the PUSCH transmission may be applied through configuredGrantConfig, which is higher signaling in Table 28, except for dataScramblingIdentityPUSCH, txConfig, codebookSubset, maxRank, and scaling of UCI-OnPUSCH provided by pusch-Config shown in Table 29, which is higher signaling. When transformPrecoder in configuredGrantConfig, which is higher signaling in Table 28, is provided to the UE, the UE applies tp-pi2BPSK in pusch-Config of Table 29 to the PUSCH transmission that operates by the configured grant.

TABLE 28

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, |
| qam64LowSE} | OPTIONAL, -- Need S |
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, |

sym5x14, sym8x14, sym10x14, sym16x14, sym20x14,

sym32x14, sym40x14, sym64x14, sym80x14,

sym128x14, sym160x14, sym256x14, sym320x14, sym512x14,

sym640x14, sym1024x14, sym1280x14,

sym2560x14, sym5120x14,

sym6, sym1x12, sym2x12, sym4x12, sym5x12,

sym8x12, sym10x12, sym16x12, sym20x12, sym32x12,

sym40x12, sym64x12, sym80x12, sym128x12,

sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. |
| maxNrofPhysicalResourceBlocks-1) | OPTIONAL, -- Need R |
| pathlossReferenceIndex | INTEGER (0..maxNrofPUSCH- |

```
PathlossReferenceRSs-1),
      ...
    }
OPTIONAL, -- Need R
    ...
  }
```

Next, a PUSCH transmission method is described. A DMRS antenna port for PUSCH transmission is the same as an antenna port for SRS transmission. The PUSCH transmission may follow each of a codebook-based transmission method and a non-codebook-based transmission method depending on whether a value of txConfig in pusch-Config of [Table 29], which is higher signaling, is “codebook” or “nonCodebook.”.”

As described above, the PUSCH transmission may be dynamically scheduled through DCI format 0_0 or 0_1, and may be semi-statically configured by a configured grant. If scheduling for PUSCH transmission is indicated to the UE through DCI format 0_0, the UE may perform beam configuration for the PUSCH transmission using pucch-spatialRelationnfoD corresponding to a UE-specific PUCCH resource corresponding to a lowest ID in an activated uplink BWP in a serving cell. Here, the PUSCH transmission is based on a single antenna port. The UE does not expect scheduling for PUCCH transmission through DCI format 0_0, within a BWP in which a PUCCH resource including pucch-spatialRelationDnfo is not configured. If txConfig in pusch-Config of Table 29 is not configured to the UE, the UE does not expect to be scheduled through DCI format 0_1.

TABLE 29

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS- |
| UplinkConfig } | OPTIONAL, -- Need M |
| dmrs-UplinkForPUSCH-MappingTypeB | SetupRelease { DMRS- |
| UplinkConfig } | OPTIONAL, -- Need M |
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF |

INTEGER (1.. maxNrofPhysicalResourceBlocks-1)
OPTIONAL, -- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, |
| qam64LowSE} | OPTIONAL, -- Need S |
| transformPrecoder | ENUMERATED {enabled, disabled} |
| OPTIONAL, -- Need S | |
| codebookSubset | ENUMERATED |

{fullyAndPartialAndNonCoherent, partialAndNonCohere86oncoherentent}

OPTIONAL, --

Cond codebookBased

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

```
OPTIONAL, -- Need S
    ...
  }
```

Next, codebook-based PUSCH transmission is described. The codebook-based PUSCH transmission may be dynamically scheduled through DCI format 0_0 or 0_1, and may semi-statically operate by a configured grant. If a codebook-based PUSCH is dynamically scheduled by DCI format 0_1 or semi-statically configured by the configured grant, the UE determines a precoder for PUSCH transmission based on an SRS resource indicator (SRI), a transmission precoding matrix indicator (TPMI), and a transmission rank (the number of PUSCH transmission layers).

Here, the SRI may be given through an SRS resource indicator that is a field in DCI, or may be configured through srs-ResourceIndicator that is higher signaling. At least one SRS resource may be configured for the UE at the time of the codebook-based PUSCH transmission, and up to two SRS resources may be configured. In a case in which the SRI is provided to the UE through DCI, an SRS resource indicated by the SRI indicates an SRS resource corresponding to the SRI among SRS resources transmitted before a PDCCH including the corresponding SRI. Also, the TPMI and the transmission rank may be given through “precoding information and number of layers” that is a field in DCI, or may be configured through precodingAndNumberOfLayers that is higher signaling. The TPMI is used to indicate a precoder applied to PUSCH transmission. If one SRS resource is configured for the UE, the TPMI is used to indicate a precoder to be applied in the configured one SRS resource. If a plurality of SRS resources are configured for the UE, the TPMI is used to indicate a precoder to be applied in an SRS resource indicated by the SRI.

The precoder to be used for PUSCH transmission is selected from an uplink codebook having the number of antenna ports corresponding to a value of nrofSRS-Ports in SRS-Config that is higher signaling. In the codebook-based PUSCH transmission, the UE determines a codebook subset based on a TPMI and codebookSubset in pusch-Config that is higher signaling. The higher signaling, codebookSubset in pusch-Config, may be configured to be one of “fullyAndPartialAndNonCoherent,”,” “partialAndNonCoherent,”,” an87oncoherentent” based on UE capability reported to the base station by the UE. If the UE reports “partialAndNonCoherent” as UE capability, the UE does not expect that a value of codebookSubset that is higher signaling is configured to be “fullyAndPartialAndNonCoherent.”.” Also, if the UE report87oncoherentent” as UE capability, the UE does not expect that the value of codebookSubset corresponding to higher signaling is configured to be “fullyAndPartialAndNonCoherent” or “partialAndNonCoherent.”.” When nrofSRS-Ports in SRS-ResourceSet corresponding to higher signaling indicates two SRS antenna ports, the UE does not expect that the value of codebookSubset corresponding to higher signaling is configured to be “partialAndNonCoherent.”.”

One SRS resource set in which a value of usage in SRS-ResourceSet, higher signaling, is configured to be “codebook” may be configured for the UE, and one SRS resource in the SRS resource set may be indicated through an SRI. If several SRS resources are configured in an SRS resource set in which the value of usage in SRS-ResourceSet that is higher signaling is configured to be “codebook,”,” the UE expects that a value of nrofSRS-Ports in SRS-Resource, higher signaling, is configured to be identical for all the SRS resources.

The UE may transmit, to the base station, one or a plurality of SRS resources included in the SRS resource set in which the value of usage is configured to be “codebook” according to higher signaling, and the base station may select one from among the SRS resources transmitted from the UE, and indicates the UE to perform PUSCH transmission using transmission beam information on the selected SRS resource. Here, in the codebook-based PUSCH transmission, an SRI is used as information for selecting an index of one SRS resource and is included in DCI. Additionally, the base station includes, in the DCI, information indicating a TPMI and a rank to be used by the UE for PUSCH transmission. The UE uses the SRS resource indicated by the SRI, to apply a precoder indicated by the TPMI and the rank indicated based on a transmission beam of the SRS resource, and performs the PUSCH transmission.

Next, non-codebook-based PUSCH transmission is described. The non-codebook-based PUSCH transmission may be dynamically scheduled through DCI format 0_0 or 0_1, and may semi-statically operate by a configured grant. When at least one SRS resource is configured in an SRS resource set in which a value of usage in SRS-ResourceSet that is higher signaling is configured to be “nonCodebook,”,” the non-codebook-based PUSCH transmission may be scheduled for the UE through DCI format 0_1.

For an SRS resource set in which the value of usage in SRS-ResourceSet that is higher signaling is configured to be “nonCodebook,”,” one connected non-zero power (NZP) CSI-RS resource may be configured for the UE. The UE may perform a calculation for a precoder for SRS transmission through measurement of the NZP CSI-RS resource connected to the SRS resource set. If a difference between a first symbol of aperiodic SRS transmission by the UE and a last reception symbol of an aperiodic NZP CSI_RS resource connected to an SRS resource set is smaller than 42 symbols, the UE does not expect that information on the precoder for SRS transmission is updated.

If a value of resourceType in SRS-ResourceSet that is higher signaling is configured to be “aperiodic,”,” the connected NZP CSI-RS is indicated by SRS request that is a field in DCI format 0_1 or 1_1. Here, if the connected NZP CSI-RS resource is an aperiodic NZP CSI-RS resource, this implies that the connected NZP CSI-RS is present for a case in which a value of the SRS request that is a field in DCI format 0_1 or 1_1 is not “00.”.” Here, corresponding DCI is required not to indicate scheduling of a cross carrier or a cross BWP. Also, if the value of the SRS request indicates presence of the NZP CSI-RS, the NZP CSI-RS may be located in a slot in which a PDCCH including an SRS request field is transmitted. TCI states configured for a scheduled subcarrier is not configured to be QCL-TypeD.

If a periodic or semi-persistent SRS resource set is configured, the connected NZP CSI-RS may be indicated through associatedCSI-RS in SRS-ResourceSet that is higher signaling. For non-codebook-based transmission, the UE does not expect that spatialRelationInfo that is higher signaling for an SRS resource and associatedCSI-RS in SRS-ResourceSet that is higher signaling are configured together.

When a plurality of SRS resources are configured for the UE, the UE may determine a precoder and a transmission rank to be applied to PUSCH transmission, based on an SRI indicated by the base station. Here, the SRI may be indicated through an SRS resource indicator that is a field in DCI, or may be configured through srs-ResourceIndicator that is higher signaling. Similarly to the codebook-based PUSCH transmission described above, when the SRI is provided to the UE through the DCI, an SRS resource indicated by the corresponding SRI indicates an SRS resource corresponding to the SRI among SRS resources transmitted before a PDCCH including the SRI. The UE may use one or a plurality of SRS resources for SRS transmission, and a maximum number of SRS resources and a maximum number of SRS resources simultaneously transmittable in the same symbol in one SRS resource set are determined based on UE capability reported by the UE to the base station. Here, the SRS resources simultaneously transmitted from the UE occupy the same RB. The UE configures one SRS port for each SRS resource. Only one SRS resource set may be configured in the SRS resource set in which a value of usage in SRS-ResourceSet that is higher signaling is configured to be “nonCodebook,”,” and up to four SRS resources may be configured for non-codebook-based PUSCH transmission.

The base station transmits one NZP CSI-RS connected to an SRS resource set to the UE, and the UE calculates a precoder to be used to transmit one or a plurality of SRS resources in the SRS resource set, based on a result of measurement performed at the time of reception of the NZP CSI-RS. The UE applies the calculated precoder when transmitting, to the base station, one or a plurality of SRS resources in an SRS resource set in which usage is configured to be “nonCodebook,”,” and the base station selects one or a plurality of SRS resources from among the received one or plurality of SRS resources. In the non-codebook-based PUSCH transmission, an SRI indicates an index that may represent a combination of one or a plurality of SRS resources, and the SRI is included in the DCI. The number of SRS resources indicated by the SRI transmitted from the base station may be the number of transmission layers of a PUSCH, and the UE applies a precoder applied to SRS resource transmission to each of the layers to transmit the PUSCH.

### [PUSCH: Preparation Procedure Time]

Hereinafter, a PUSCH preparation procedure time is described. When the base station schedules the UE to transmit a PUSCH using DCI format 0_0, 0_1, or 0_2, the UE may require the PUSCH preparation procedure time for transmitting the PUSCH by applying a transmission method (transmission precoding method of SRS resource, number of transmission layers, spatial domain transmission filter) indicated through DCI. In NR, the PUSCH preparation procedure time is defined by considering this. The PUSCH preparation procedure time of the UE may follow [Equation 3] below.

$$[ Equation 3 ]$$

$${T}_{proc , 2} = max ( ( {N}_{2} + {d}_{2 , 1} + {d}_{2} ) ( 2048 + 1 \; 44 ) {κ2}^{- μ} {T}_{c} + {T}_{ext} + {T}_{switch} , {d}_{2 , 2} ) .$$

In Tproc,2 described in Equation 3, each variable may have the following meaning.
N2: The number of symbols determined based on UE processing capability 1 or 2 and numerology μ according to capability of the UE. When reported as UE processing capability 1 according to capability report of the UE, it may have a value in [Table 30], and when reported as UE processing capability 2 and configured through higher layer signaling that UE processing capability 2 is available, it may have a value in [Table 31].

TABLE 30

| | PUSCH preparation time N₂ |
|---|---|
| μ | [symbols] |
| 0 | 10 |
| 1 | 12 |
| 2 | 23 |
| 3 | 36 |

TABLE 31

| | PUSCH preparation time N₂ |
|---|---|
| μ | [symbols] |
| 0 | 5 |
| 1 | 5.5 |
| 2 | 11 for frequency range 1 |

d2,1: The number of symbols that is determined as 0 when resource elements of a first OFDM symbol of PUSCH transmission all are configured to include DM-RS and otherwise, determined as 1.
κ: 64
μ: Between μ_{DL} and μ_{UL}, it follows the value that makes Tproc,2 larger. μ_{DL} indicates numerology of downlink through which a PDCCH including DCI that schedules a PUSCH is transmitted, and μ_{UL} indicates numerology of uplink through which the PUSCH is transmitted.
Tc: It has 1/(Δfₘₐₓ·N_{f}), Δfₘₐₓ=480·10³, N_{f}=4096.
d2,2: It follows BWP switching time when DCI that schedules the PUSCH indicates BWP and otherwise, has a value of 0.
d2: When OFDM symbols of a PUSCH with a high priority index, and a PUCCH with a low priority index overlap in time, a value of d2 of the PUSCH with the high priority index is used. Otherwise, d2=0.
Text: When the UE uses a shared spectrum channel access method, the UE may calculate Text and may apply the same to the PDSCH processing procedure time. Otherwise, Text is assumed as 0.
Tswitch: When the uplink switching interval is triggered, Tswitch is assumed as the switching interval time. Otherwise, it is assumed as 0.

When a first symbol of a PUSCH starts earlier than a first uplink symbol in which a CP starts after Tproc,2 after a last symbol of a PDCCH including DCI that schedules the PUSCH in consideration of time axis resource mapping information of the PUSCH scheduled through DCI and timing advance effect between uplink and downlink, the base station and the UE determine that the PUSCH preparation procedure time is not sufficient. Otherwise, the base station and the UE determine that the PUSCH preparation procedure time is sufficient. The UE may transmit the PUSCH only when the PUSCH preparation procedure time is sufficient and may ignore DCI that schedules the PUSCH when the PUSCH preparation procedure time is insufficient.

### [PUSCH: Related to Repetition Transmission]

Hereinafter, repetition transmission of an uplink data channel in a 5G system is described. In the 5G system, two types, PUSCH repetition transmission type A and PUSCH repetition transmission type B, are supported as a repetition transmission method of the uplink data channel. Either PUSCH repetition transmission type A or B may be configured to the UE through higher layer signaling.

### PUSCH Repetition Transmission Type A

As described above, a symbol length of an uplink data channel and a location of a start symbol are determined using a time domain resource allocation method within a single slot, and the base station may notify the UE of the number of repetition transmissions through higher layer signaling (e.g., RRC signaling) or L1 signaling (e.g., DCI).

The UE may repeatedly transmit an uplink data channel having the same length and start symbol of the uplink data channel configured based on the number of repetition transmissions received from the base station. Here, when at least one symbol among symbols of a slot configured by the base station to the UE as downlink or an uplink data channel configured to the UE is configured as downlink, the UE omits uplink data channel transmission, but counts the number of repetition transmissions of the uplink data channel.

### PUSCH Repetition Transmission Type B

As described above, the start symbol and the length of the uplink data channel are determined using the time domain resource allocation method within a single slot, and the base station may notify the UE of the number of repetition transmissions, numberofrepetitions, through higher signaling (e.g., RRC signaling) or L1 signaling (e.g., DCI).

Initially, nominal repetition of the uplink data channel is determined based on the start symbol and the length of the configured uplink data channel as follows. A slot in which an nth nominal repetition starts is given by

$${K}_{s} + ⌊ \frac{S + n \cdot L}{{N}_{symb}^{slot}} ⌋ ,$$

and a symbol that starts in the slot is given by

$$mod ( S + n \cdot L , {N}_{symb}^{slot} ) .$$

A slot in which the nth nominal repetition ends is given by

$${K}_{s} + ⌊ \frac{S + ( n + 1 ) \cdot L - 1}{{N}_{symb}^{slot}} ⌋ ,$$

and a symbol that ends in the slot is given by

$$mod ( S + ( n + 1 ) \cdot L - 1 , {N}_{symb}^{slot} ) .$$

Here, n=0, . . . , numberofrepetitions-1, S denotes the start symbol of the configured uplink data channel, and L denotes the symbol length of the configured uplink data channel. Kₛ denotes a slot in which PUSCH transmission starts, and

$${N}_{symb}^{slot}$$

denotes the number of slots per slot.

The UE determines an invalid symbol for PUSCH repetition transmission type B. The symbol configured as downlink by tdd-UL-DL-ConfigurationCommon or tdd-UL-DL-ConfigurationDedicated is determined as the invalid symbol for PUSCH repetition transmission type B. Additionally, the invalid symbol may be configured in higher layer parameter (e.g., InvalidSymbolPattern). The higher layer parameter (e.g., InvalidSymbolPattern) provides a symbol-level bitmap across one slot or two slots whereby the invalid symbol may be configured. In the bitmap, 1 denotes the invalid symbol. Additionally, a periodicity and a pattern of the bitmap may be configured through the higher layer parameter (e.g., periodicityAndPattern). If the higher layer parameter (e.g., InvalidSymbolPattern) is configured and InvalidSymbolPatternIndicator-ForDCIFormat0_1 or InvalidSymbolPatternIndicator-ForDCIFormat0_2 parameter represents 1, the UE applies the invalid symbol pattern. If the parameter represents 0, the UE does not apply the invalid symbol pattern. If the higher layer parameter (e.g., InvalidSymbolPattern) is configured and InvalidSymbolPatternIndicator-ForDCIFormat0_1 or InvalidSymbolPatternIndicator-ForDCIFormat0_2 parameter is not configured, the UE applies the invalid symbol pattern.

After the Invalid symbol is determined, the UE may consider symbols other than the invalid symbol as valid symbols for each nominal repetition. If at least one valid symbol is included in each nominal repetition, the nominal repetition may include one or more actual repetitions. Here, each actual repetition may include a continuous set of valid symbols that may be used for PUSCH repetition transmission type B within a single slot.

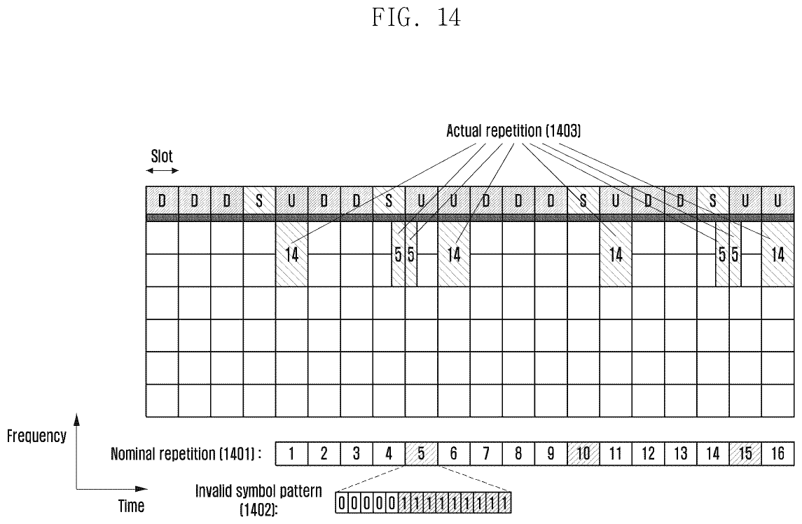

FIG. 14 illustrates an example of PUSCH repetition transmission type B in a wireless communication system according to an embodiment of the disclosure. In the UE, the start symbol S of the uplink data channel may be set to 0, the length L of the uplink data channel may be set to 14, and the number of repetition transmissions may be set to 16. In this case, the nominal repetition is indicated in 16 consecutive slots (1401). Then, the UE may determine a symbol configured as a downlink symbol in each nominal repetition (1401) as the invalid symbol. Also, the UE determines symbols set to 1 in an invalid symbol pattern 1402 as invalid symbols. When valid symbols other than invalid symbols in each nominal repetition include one or more consecutive symbols in a single slot, they are configured as actual repetition and transmitted (1403).

Also, for PUSCH repetition transmission, NR Release 16 may define the following additional methods for UL grant-based PUSCH transmission and configured grant-based PUSCH transmission across the slot boundary.
Method 1 (mini-slot level repetition): Through a single UL grant, two or more PUSCH repetition transmissions within a single slot or across the boundary of consecutive slots are scheduled. Also, for method 1, time domain resource allocation information within DCI indicates resources of first repetition transmission. Also, time domain resource information of first repetition transmission and time domain resource information of remaining repetition transmissions may be determined based on uplink or downlink direction determined for each symbol of each slot. Each repetition transmission occupies consecutive symbols.
Method 2 (multi-segment transmission): Through a single UL grant, two or more PUSCH repetition transmissions are scheduled in consecutive slots. Here, one transmission is specified for each slot and a starting point or a repetition length may be different for each transmission. Also, in method 2, time domain resource allocation information within DCI indicates the starting points and the repetition lengths of all repetition transmissions. Also, in the case of performing repetition transmission within a single slot through method 2, if a plurality of sets of consecutive uplink symbols are present within the corresponding slot, each repetition transmission is performed for each uplink symbol set. If only one set of consecutive uplink symbols is present within the slot, one PUSCH repetition transmission is performed according to the method of NR Release 15.
Method 3: Through two or more UL grants, two or more PUSCH repetition transmissions are scheduled in consecutive slots. Here, one transmission is specified for each slot, an nth UL grant may be received before a PUSCH transmission scheduled for (n−1)-th UL grant ends.
Method 4: Through a single UL grant or a single configured grant, one or more PUSCH repetition transmissions may be supported within a single slot, or two or more PUSCH repetition transmissions may be supported across the boundary of consecutive slots. The repetition count indicated by the base station to the UE is only a nominal value and the actual number of PUSCH repetition transmissions performed by the UE may be greater than the nominal repetition count. Time domain resource allocation information within DCI or the configured grant represents resources of the first repetition transmission indicated by the base station. Time domain resource information of remaining repetition transmissions may be determined with reference to resource information of the first repetition transmission and the uplink or downlink direction of symbols. If time domain resource information of a repetition transmission indicated by the base station is across the slot boundary or includes an uplink/downlink transition point, the corresponding repetition transmission may be divided into a plurality of repetition transmissions. Here, a single slot may include a single repetition transmission for each uplink period.

The above-described repetition transmission may be applied to all of dynamic grant (DG) PUSCH and configured grant (CG) PUSCH. The DG PUSCH refers to a method that provides all PUSCH scheduling information through DCI, and the CG PUSCH refers to a method that provides PUSCH scheduling information using only a higher signal or provides PUSCH scheduling information through some DCI. Also, the DG PUSCH refers to a method for the UE to transmit a PUSCH only in a scheduling area provided by DCI, and the CG PUSCH refers to a method for the UE to periodically transmit the PUSCH without receiving separate DCI, according to a periodicity configured using the higher signal.

### [PUSCH: Frequency Hopping Process]

Hereinafter, frequency hopping of the uplink data channel (PUSCH) in the 5G system is described in detail.

In 5G, two methods are supported for each PUSCH repetition transmission type as a frequency hopping method of the uplink data channel. Initially, PUSCH repetition transmission type A supports intra-slot frequency hopping and inter-slot frequency hopping, and PUSCH repetition transmission type B supports inter-repetition frequency hopping and inter-slot frequency hopping.

The intra-slot frequency hopping method supported in PUSCH repetition transmission type A refers to a method for the UE to transmit allocated resources of the frequency domain in two hops within a single slot by changing the same by the configured frequency offset. In intra-slot frequency hopping, a start RB of each hop may be expressed through Equation 4 below.

$${RB}_{start} = \{ \begin{matrix}{RB}_{start} & i = 0 \\ ( {RB}_{start} + {RB}_{offset} ) mod {N}_{BWP}^{size} & i = 1\end{matrix} . \qquad [ Equation 4 ]$$

In Equation 4, i=0 and i=1 denote the first hop and the second hop, respectively, and RBₛₜₐᵣₜ denotes the start RB in a UL BWP and is calculated using the frequency resource allocation method. RB_{offset} denotes a frequency offset between two hops through a higher layer parameter. The number of symbols of the first hop may be represented as

$$⌊ {N}_{symb}^{PUSCH , s} / 2 ⌋ ,$$

and the number of symbols of the second hop may be represented as

$${N}_{symb}^{PUSCH , s} - ⌊ {N}_{symb}^{PUSCH , s} / 2 ⌋ \cdot {N}_{symb}^{PUSCH , s}$$

denotes the length of PUSCH transmission within a single slot and is represented as the number of OFDM symbols.

Then, the inter-slot frequency hopping method supported in PUSCH repetition transmission types A and B refers to a method for the UE to transmit allocated resources of the frequency domain for each slot by changing the same by the configured frequency offset. In inter-slot frequency hopping, the start RB during

$${n}_{s}^{μ}$$

slot may be represented through Equation 5.

$${RB}_{start} ( {n}_{s}^{μ} ) = \{ \begin{matrix}{RB}_{start} & {n}_{s}^{μ} mod 2 = 0 \\ ( {Rb}_{start} + {RB}_{offset} ) mod {N}_{BWP}^{size} & {n}_{s}^{μ} mod 2 = 1\end{matrix} \qquad [ Equation 5 ]$$

In Equation 5,

$${n}_{s}^{μ}$$

denotes a current slot number in multi-slot PUSCH transmission, and Rₛₜₐₜ denotes a start RB in an UL BWP and is calculated using the frequency resource allocation method. R_{offset} denotes frequency offset between two hops through the higher layer parameter.

Then, the inter-repetition frequency hopping method supported in PUSCH repetition transmission type B transmits resources allocated in the frequency domain for one or a plurality of actual repetitions within each nominal repetition by shifting the same by the configured frequency offset. RBstart(n), index of the start RB in the frequency domain for one or a plurality of actual repetitions within the nth nominal repetition, may follow Equation 6 below.

$${RB}_{set} ( n ) = \{ \begin{matrix}{RB}_{start} & n mod 2 = 0 \\ ( {RB}_{start} + {RB}_{offset} ) mod {N}_{BWP}^{size} & n mod 2 = 1\end{matrix} \qquad [ Equation 6 ]$$

In Equation 6, n denotes an index of nominal repetition, and RB_{offset} denotes an RB offset between two hops through the higher layer parameter.

### [PUSCH: Multiplexing Rule for AP/SP CSI Reporting]

A method of measuring and reporting a channel state in the 5G communication system is described below. Channel state information (CSI) may include channel quality information (CQI), a precoding matric indicator (PMI), a CSI-RS resource indicator (CRI), an SS/PBCH block resource indicator (SSBRI), a layer indicator (LI), a rank indicator (RI), and/or L1—reference signal received power (RSRP). The base station may control time and frequency resources for the above-described CSI measurement and report of the UE.

For the above-described CSI measurement and report, the UE may be configured with setting information for N(≥1) CSI reports (CSI-ReportConfig), setting information for M(≥1) RS transmission resources (CSI-ResourceConfig), and list information on one or two trigger states (CSI-AperiodicTriggerStateList, and CSI-SemiPersistentOnPUSCH-TriggerStateList) through higher layer signaling. Configuration information for the above-described CSI measurement and report may be as shown in [Table 32] to [Table 38] below.

### [Table 32] CSI-ReportConfig

The IE CSI-ReportConfig is used to configure a periodic or semi-persistent report sent on PUCCH on the cell in which the CSI-ReportConfig is included, or to configure a semi-persistent or aperiodic report sent on PUSCH triggered by DCI received on the cell in which the CSI-ReportConfig is included (in this case, the cell on which the report is sent is determined by the received DCI). See TS 38.214 [19], clause 5.2.1.

CSI-ReportConfig information element

```
  -- ASN1START
  -- TAG-CSI-REPORTCONFIG-START
```

| CSI-ReportConfig ::= | SEQUENCE { | |
|---|---|---|
| reportConfigId | CSI-ReportConfigId, | |
| carrier | ServCellIndex | OPTIONAL, -- Need S |
| resourcesForChannelMeasurement | CSI-ResourceConfigId, | |
| csi-IM-ResourcesForInterference | CSI-ResourceConfigId | OPTIONAL, - |

- Need R

| | | |
|---|---|---|
| nzp-CSI-RS-ResourcesForInterference | CSI-ResourceConfigId | OPTIONAL, |

-- Need R

| | |
|---|---|
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs)) OF |

PUCCH-CSI-Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) OF |

PUCCH-CSI-Resource
},

| | |
|---|---|
| semiPersistentOnPUSCH | SEQUENCE { |
| reportSlotConfig | ENUMERATED {sl5, sl10, sl20, sl40, sl80, |

sl160, sl320},

| | |
|---|---|
| reportSlotOffsetList | SEQUENCE (SIZE (1.. maxNrofUL-Allocations)) |

OF INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL-Allocations)) |

```
OF INTEGER(0..32)
      }
    },
```

| reportQuantity | CHOICE { | |
|---|---|---|
| none | NULL, | |
| cri-RI-PMI-CQI | NULL, | |
| cri-RI-i1 | NULL, | |
| cri-RI-i1-CQI | SEQUENCE { | |
| pdsch-BundleSizeForCSI | | ENUMERATED {n2, n4} |

OPTIONAL -- Need S
},

| | |
|---|---|
| cri-RI-CQI | NULL, |
| cri-RSRP | NULL, |
| ssb-Index-RSRP | NULL, |
| cri-RI-LI-PMI-CQI | NULL |

},

| | |
|---|---|
| reportFreqConfiguration | SEQUENCE { |
| cqi-FormatIndicator | ENUMERATED { widebandCQI, subbandCQI } |

OPTIONAL, -- Need R

| | |
|---|---|
| pmi-FormatIndicator | ENUMERATED { widebandPMI, subbandPMI } |

OPTIONAL, -- Need R

| | |
|---|---|
| csi-ReportingBand | CHOICE { |
| subbands3 | BIT STRING(SIZE(3)), |
| subbands4 | BIT STRING(SIZE(4)), |
| subbands5 | BIT STRING(SIZE(5)), |
| subbands6 | BIT STRING(SIZE(6)), |
| subbands7 | BIT STRING(SIZE(7)), |
| subbands8 | BIT STRING(SIZE(8)), |
| subbands9 | BIT STRING(SIZE(9)), |
| subbands10 | BIT STRING(SIZE(10)), |
| subbands11 | BIT STRING(SIZE(11)), |
| subbands12 | BIT STRING(SIZE(12)), |
| subbands13 | BIT STRING(SIZE 13)), |
| subbands14 | BIT STRING(SIZE(14)), |
| subbands15 | BIT STRING(SIZE(15)), |
| subbands16 | BIT STRING(SIZE(16)), |
| subbands17 | BIT STRING(SIZE(17)), |
| subbands18 | BIT STRING(SIZE(18)), |

...,

| | |
|---|---|
| subbands19-v1530 | BIT STRING(SIZE(19)) |

} OPTIONAL -- Need S

| | |
|---|---|
| } | OPTIONAL, -- |

Need R

| | |
|---|---|
| timeRestrictionForChannelMeasurements | ENUMERATED {configured, |

notConfigured},

| | |
|---|---|
| timeRestrictionForInterferenceMeasurements | ENUMERATED {configured, |

notConfigured},

| | | |
|---|---|---|
| codebookConfig | CodebookConfig | OPTIONAL, |

-- Need R

| | |
|---|---|
| dummy | ENUMERATED {n1, n2} |

OPTIONAL, -- Need R

| groupBasedBeamReporting | CHOICE { | |
|---|---|---|
| enabled | NULL, | |
| disabled | SEQUENCE { | |
| nrofReportedRS | | ENUMERATED {n1, n2, n3, n4} |

```
OPTIONAL -- Need S
      }
    },
```

| | |
|---|---|
| cqi-Table | ENUMERATED {table1, table2, table3, spare1} |

OPTIONAL, -- Need R

| | |
|---|---|
| subbandSize | ENUMERATED {value1, value2}, |
| non-PMI-PortIndication | SEQUENCE (SIZE (1..maxNrofNZP-CSI-RS- |
| ResourcesPerConfig)) OF PortIndexFor8Ranks | OPTIONAL, -- Need R |

```
    ...,
    [[
```

| semiPersistentOnPUSCH-v1530 | SEQUENCE { | |
|---|---|---|
| reportSlotConfig-v1530 | ENUMERATED {sl4, sl8, sl16} | |
| } | | OPTIONAL -- |

```
Need R
    ]],
    [[
```

| semiPersistentOnPUSCH-v1610 | SEQUENCE { | |
|---|---|---|
| reportSlotOffsetListDCI-0-2-r16 | SEQUENCE (SIZE (1.. maxNrofUL- | |
| Allocations-r16)) OF INTEGER(0..32) | OPTIONAL, -- Need R | |
| reportSlotOffsetListDCI-0-1-r16 | SEQUENCE (SIZE (1.. maxNrofUL- | |
| Allocations-r16)) OF INTEGER(0..32) | OPTIONAL -- Need R | |
| } | | OPTIONAL, -- |

Need R

| aperiodic-v1610 | SEQUENCE { | |
|---|---|---|
| reportSlotOffsetListDCI-0-2-r16 | SEQUENCE (SIZE (1.. maxNrofUL- | |
| Allocations-r16)) OF INTEGER(0..32) | OPTIONAL, -- Need R | |
| reportSlotOffsetListDCI-0-1-r16 | SEQUENCE (SIZE (1.. maxNrofUL- | |
| Allocations-r16)) OF INTEGER(0..32) | OPTIONAL -- Need R | |
| } | | OPTIONAL, -- |

Need R

| reportQuantity-r16 | CHOICE { | |
|---|---|---|
| cri-SINR-r16 | NULL, | |
| ssb-Index-SINR-r16 | NULL | |
| } | | OPTIONAL, -- |

Need R

| | |
|---|---|
| codebookConfig-r16 | CodebookConfig-r16 |

```
OPTIONAL -- Need R
    ]]
  }
```

| | |
|---|---|
| CSI-ReportPeriodicityAndOffset ::= | CHOICE { |
| slots4 | INTEGER(0..3), |
| slots5 | INTEGER(0..4), |
| slots8 | INTEGER(0..7), |
| slots10 | INTEGER(0..9), |
| slots16 | INTEGER(0..15), |
| slots20 | INTEGER(0..19), |
| slots40 | INTEGER(0..39), |
| slots80 | INTEGER(0..79), |
| slots160 | INTEGER(0..159), |
| slots320 | INTEGER(0..319) |

}

| | |
|---|---|
| PUCCH-CSI-Resource ::= | SEQUENCE { |
| uplinkBandwidthPartId | BWP-Id, |
| pucch-Resource | PUCCH-ResourceId |

}

| PortIndexFor8Ranks ::= | CHOICE { | |
|---|---|---|
| portIndex8 | SEQUENCE{ | |
| rank1-8 | PortIndex8 | OPTIONAL, |

-- Need R

| | |
|---|---|
| rank2-8 | SEQUENCE(SIZE(2)) OF PortIndex8 |

OPTIONAL, -- Need R

| | |
|---|---|
| rank3-8 | SEQUENCE(SIZE(3)) OF PortIndex8 |

OPTIONAL, -- Need R

| | |
|---|---|
| rank4-8 | SEQUENCE(SIZE(4)) OF PortIndex8 |

OPTIONAL, -- Need R

| | |
|---|---|
| rank5-8 | SEQUENCE(SIZE(5)) OF PortIndex8 |

OPTIONAL, -- Need R

| | |
|---|---|
| rank6-8 | SEQUENCE(SIZE(6)) OF PortIndex8 |

OPTIONAL, -- Need R

| | |
|---|---|
| rank7-8 | SEQUENCE(SIZE(7)) OF PortIndex8 |

OPTIONAL, -- Need R

| | |
|---|---|
| rank8-8 | SEQUENCE(SIZE(8)) OF PortIndex8 |

OPTIONAL -- Need R
},

| portIndex4 | SEQUENCE{ | |
|---|---|---|
| rank1-4 | PortIndex4 | OPTIONAL, |

-- Need R

| | |
|---|---|
| rank2-4 | SEQUENCE(SIZE(2)) OF PortIndex4 |

OPTIONAL, -- Need R

| | |
|---|---|
| rank3-4 | SEQUENCE(SIZE(3)) OF PortIndex4 |

OPTIONAL, -- Need R

| | |
|---|---|
| rank4-4 | SEQUENCE(SIZE(4)) OF PortIndex4 |

OPTIONAL -- Need R
},

| portIndex2 | SEQUENCE{ | |
|---|---|---|
| rank1-2 | PortIndex2 | OPTIONAL, |

-- Need R

| | |
|---|---|
| rank2-2 | SEQUENCE(SIZE(2)) OF PortIndex2 |

OPTIONAL -- Need R
},

| | |
|---|---|
| portIndex1 | NULL |

}

| | |
|---|---|
| PortIndex8::= | INTEGER (0..7) |
| PortIndex4::= | INTEGER (0..3) |
| PortIndex2::= | INTEGER (0..1) |

```
  -- TAG-CSI-REPORTCONFIG-STOP
  -- ASN1STOP
CSI-ReportConfig field descriptions
carrier
Indicates in which serving cell the CSI-ResourceConfig indicated below are to be found. If the
field is absent, the resources are on the same serving cell as this report configuration.
codebookConfig
Codebook configuration for Type-1 or Type-2 including codebook subset restriction. Network
does not configure codebookConfig and codebookConfig-r16 simultaneously to a UE
cqi-FormatIndicator
Indicates whether the UE shall report a single (wideband) or multiple (subband) CQI. (see TS
38.214 [19], clause 5.2.1.4).
cqi-Table
Which CQI table to use for CQI calculation (see TS 38.214 [19], clause 5.2.2.1).
csi-IM-ResourcesForInterference
CSI IM resources for interference measurement. csi-ResourceConfigId of a CSI-ResourceConfig
included in the configuration of the serving cell indicated with the field “carrier” above. The CSI-
ResourceConfig indicated here contains only CSI-IM resources. The bwp-Id in that CSI-ResourceConfig is
the same value as the bwp-Id in the CSI-ResourceConfig indicated by resourcesForChannelMeasurement.
csi-ReportingBand
Indicates a contiguous or non-contiguous subset of subbands in the bandwidth part which CSI shall
be reported for. Each bit in the bit-string represents one subband. The right-most bit in the bit string
represents the lowest subband in the BWP. The choice determines the number of subbands (subbands3 for
3 subbands, subbands4 for 4 subbands, and so on) (see TS 38.214 [19], clause 5.2.1.4). This field is absent
if there are less than 24 PRBs (no sub band) and present otherwise, the number of sub bands can be from 3
(24 PRBs, sub band size 8) to 18 (72 PRBs, sub band size 4).
dummy
This field is not used in the specification. If received it shall be ignored by the UE.
groupBasedBeamReporting
Turning on/off group beam based reporting (see TS 38.214 [19], clause 5.2.1.4).
non-PMI-PortIndication
Port indication for RI/CQI calculation. For each CSI-RS resource in the linked ResourceConfig for
channel measurement, a port indication for each rank R, indicating which R ports to use. Applicable only
for non-PMI feedback (see TS 38.214 [19], clause 5.2.1.4.2).
The first entry in non-PMI-PortIndication corresponds to the NZP-CSI-RS-Resource indicated by
the first entry in nzp-CSI-RS-Resources in the NZP-CSI-RS-ResourceSet indicated in the first entry of nzp-
CSI-RS-ResourceSetList of the CSI-ResourceConfig whose CSI-ResourceConfigId is indicated in a CSI-
MeasId together with the above CSI-ReportConfigId; the second entry in non-PMI-PortIndication
corresponds to the NZP-CSI-RS-Resource indicated by the second entry in nzp-CSI-RS-Resources in the
NZP-CSI-RS-ResourceSet indicated in the first entry of nzp-CSI-RS-ResourceSetList of the same CSI-
ResourceConfig, and so on until the NZP-CSI-RS-Resource indicated by the last entry in nzp-CSI-RS-
Resources in the in the NZP-CSI-RS-ResourceSet indicated in the first entry of nzp-CSI-RS-
ResourceSetList of the same CSI-ResourceConfig. Then the next entry corresponds to the NZP-CSI-RS-
Resource indicated by the first entry in nzp-CSI-RS-Resources in the NZP-CSI-RS-ResourceSet indicated
in the second entry of nzp-CSI-RS-ResourceSetList of the same CSI-ResourceConfig and so on.
nrofReportedRS
The number (N) of measured RS resources to be reported per report setting in a non-group-based
report. N <= N_max, where N_max is either 2 or 4 depending on UE capability.
(see TS 38.214 [19], clause 5.2.1.4) When the field is absent the UE applies the value 1.
nzp-CSI-RS-ResourcesForInterference
NZP CSI RS resources for interference measurement. csi-ResourceConfigId of a CSI-
ResourceConfig included in the configuration of the serving cell indicated with the field “carrier” above.
The CSI-ResourceConfig indicated here contains only NZP-CSI-RS resources. The bwp-Id in that CSI-
ResourceConfig is the same value as the bwp-Id in the CSI-ResourceConfig indicated by
resourcesForChannelMeasurement.
p0alpha
Index of the p0-alpha set determining the power control for this CSI report transmission (see TS
38.214 [19], clause 6.2.1.2).
pdsch-BundleSizeForCSI
PRB bundling size to assume for CQI calculation when reportQuantity is CRI/RI/i1/CQI. If the
field is absent, the UE assumes that no PRB bundling is applied (see TS 38.214 [19], clause 5.2.1.4.2).
pmi-FormatIndicator
Indicates whether the UE shall report a single (wideband) or multiple (subband) PMI. (see TS
38.214 [19], clause 5.2.1.4).
pucch-CSI-ResourceList
Indicates which PUCCH resource to use for reporting on PUCCH.
reportConfigType
Time domain behavior of reporting configuration.
reportFreqConfiguration
Reporting configuration in the frequency domain. (see TS 38.214 [19], clause 5.2.1.4).
reportQuantity
The CSI related quantities to report. see TS 38.214 [19], clause 5.2.1. If the field reportQuantity-
r16 is present, UE shall ignore reportQuantity (without suffix).
reportSlotConfig
Periodicity and slot offset (see TS 38.214 [19], clause 5.2.1.4). If the field reportSlotConfig-v1530
is present, the UE shall ignore the value provided in reportSlotConfig (without suffix).
reportSlotOffsetList, reportSlotOffsetListDCI-0-1, reportSlotOffsetListDCI-0-2
Timing offset Y for semi persistent reporting using PUSCH. This field lists the allowed offset
values. This list must have the same number of entries as the pusch-Time DomainAllocationList in
PUSCH-Config. A particular value is indicated in DCI. The network indicates in the DCI field of the UL
grant, which of the configured report slot offsets the UE shall apply. The DCI value 0 corresponds to the
first report slot offset in this list, the DCI value 1 corresponds to the second report slot offset in this list,
and so on. The first report is transmitted in slot n + Y, second report in n + Y + P, where P is the configured
periodicity.
Timing offset Y for aperiodic reporting using PUSCH. This field lists the allowed offset values.
This list must have the same number of entries as the pusch-TimeDomainAllocationList in PUSCH-
Config. A particular value is indicated in DCI. The network indicates in the DCI field of the UL grant,
which of the configured report slot offsets the UE shall apply. The DCI value 0 corresponds to the first
report slot offset in this list, the DCI value 1 corresponds to the second report slot offset in this list, and so
on (see TS 38.214 [19], clause 6.1.2.1). The field reportSlotOffsetList applies to DCI format 0_0, the field
reportSlotOffsetListDCI-0-1 applies to DCI format 0_1 and the field reportSlotOffsetListDCI-0-2 applies
to DCI format 0_2 (see TS 38.214 [19], clause 6.1.2.1).
resourcesForChannelMeasurement
Resources for channel measurement. csi-ResourceConfigId of a CSI-ResourceConfig included in
the configuration of the serving cell indicated with the field “carrier” above. The CSI-ResourceConfig
indicated here contains only NZP-CSI-RS resources and/or SSB resources. This CSI-ReportConfig is
associated with the DL BWP indicated by bwp-Id in that CSI-ResourceConfig.
subbandSize
Indicates one out of two possible BWP-dependent values for the subband size as indicated in TS
38.214 [19], table 5.2.1.4-2 . If csi-ReportingBand is absent, the UE shall ignore this field.
timeRestrictionForChannelMeasurements
Time domain measurement restriction for the channel (signal) measurements (see TS 38.214 [19],
clause 5.2.1.1).
timeRestrictionForInterferenceMeasurements
Time domain measurement restriction for interference measurements (see TS 38.214 [19], clause
5.2.1.1).
```

### [Table 33] CSI-ResourceConfig

The IE CSI-ResourceConfig defines a group of one or more NZP-CSI-RS-ResourceSet, CSI-IM-ResourceSet and/or CSI-SSB-ResourceSet.

CSI-ResourceConfig information element
-- ASN1START
-- TAG-CSI-RESOURCECONFIG-START

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |
| nzp-CSI-RS-ResourceSetList | SEQUENCE (SIZE (1..maxNrofNZP-CSI-RS- |

ResourceSetsPerConfig)) OF NZP-CSI-RS-ResourceSetId

OPTIONAL, --

Need R

| | |
|---|---|
| csi-SSB-ResourceSetList | SEQUENCE (SIZE (1..maxNrofCSI-SSB- |
| ResourceSetsPerConfig)) OF CSI-SSB-ResourceSetId | OPTIONAL -- Need R |

},

| | |
|---|---|
| csi-IM-ResourceSetList | SEQUENCE (SIZE (1..maxNrofCSI-IM- |

ResourceSetsPerConfig)) OF CSI-IM-ResourceSetId
},

| | |
|---|---|
| bwp-Id | BWP-Id, |
| resourceType | ENUMERATED { aperiodic, semiPersistent, periodic }, |

...
}
-- TAG-CSI-RESOURCECONFIG-STOP
-- ASN1STOP

```
CSI-ResourceConfig field descriptions
  bwp-Id
  The DL BWP which the CSI-RS associated with this CSI-ResourceConfig are located in (see TS
38.214 [19], clause 5.2.1.2.
  csi-IM-ResourceSetList
  List of references to CSI-IM resources used for beam measurement and reporting in a CSI-RS
resource set. Contains up to maxNrofCSI-IM-ResourceSetsPerConfig resource sets if resourceType is
“aperiodic” and 1 otherwise (see TS 38.214 [19], clause 5.2.1.2).
  csi-ResourceConfigId
  Used in CSI-ReportConfig to refer to an instance of CSI-ResourceConfig.
  csi-SSB-ResourceSetList
  List of references to SSB resources used for beam measurement and reporting in a CSI-RS
resource set (see TS 38.214 [19], clause 5.2.1.2).
  nzp-CSI-RS-ResourceSetList
  List of references to NZP CSI-RS resources used for beam measurement and reporting in a CSI-RS
resource set. Contains up to maxNrofNZP-CSI-RS-ResourceSetsPerConfig resource sets if resourceType is
“aperiodic” and 1 otherwise (see TS 38.214 [19], clause 5.2.1.2).
  resourceType
  Time domain behavior of resource configuration (see TS 38.214 [19], clause 5.2.1.2). It does not
apply to resources provided in the csi-SSB-ResourceSetList.
```

### [Table 34] NZP-CSI-RS-ResourceSet

The IE NZP-CSI-RS-ResourceSet is a set of Non-Zero-Power (NZP) CSI-RS resources (their IDs) and set-specific parameters.

NZP-CSI-RS-ResourceSet information element
-- ASN1START
-- TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-RS- |

ResourcesPerSet)) OF NZP-CSI-RS-ResourceId,

| | | |
|---|---|---|
| repetition | ENUMERATED { on, off } | OPTIONAL, |

-- Need S

| | | |
|---|---|---|
| aperiodicTriggeringOffset | INTEGER(0..6) | OPTIONAL, |

-- Need S

| | | |
|---|---|---|
| trs-Info | ENUMERATED {true} | OPTIONAL, |

```
-- Need R
  ...,
  [[
```

| | | |
|---|---|---|
| aperiodicTriggeringOffset-r16 | INTEGER(0..31) | OPTIONAL |

-- Need S
]]
}
-- TAG-NZP-CSI-RS-RESOURCESET-STOP
-- ASN1STOP

```
NZP-CSI-RS-ResourceSet field descriptions
  aperiodicTriggeringOffset, aperiodicTriggeringOffset-r16
  Offset X between the slot containing the DCI that triggers a set of aperiodic NZP CSI-RS
resources and the slot in which the CSI-RS resource set is transmitted. For aperiodicTriggeringOffset, the
value 0 corresponds to 0 slots, value 1 corresponds to 1 slot, value 2 corresponds to 2 slots, value 3
corresponds to 3 slots, value 4 corresponds to 4 slots, value 5 corresponds to 16 slots, value 6 corresponds
to 24 slots. For aperiodicTriggeringOffset-r16, the value indicates the number of slots. The network
configures only one of the fields. When neither field is included, the UE applies the value 0.
  nzp-CSI-RS-Resources
  NZP-CSI-RS-Resources associated with this NZP-CSI-RS resource set (see TS 38.214 [19], clause
5.2). For CSI, there are at most 8 NZP CSI RS resources per resource set.
  repetition
  Indicates whether repetition is on/off. If the field is set to off or if the field is absent, the UE may
not assume that the NZP-CSI-RS resources within the resource set are transmitted with the same downlink
spatial domain transmission filter (see TS 38.214 [19], clauses 5.2.2.3.1 and 5.1.6.1.2). It can only be
configured for CSI-RS resource sets which are associated with CSI-ReportConfig with report of L1 RSRP
or ″no report.”.”
  trs-Info
  Indicates that the antenna port for all NZP-CSI-RS resources in the CSI-RS resource set is same. If
the field is absent or released the UE applies the value false (see TS 38.214 [19], clause 5.2.2.3.1).
```

### [Table 35] CSI-SSB-ResourceSet

The IE CSI-SSB-ResourceSet is used to configure one SS/PBCH block resource set which refers to SS/PBCH as indicated in ServingCellConfigCommon.

CSI-SSB-ResourceSet information element

-- ASN1START
-- TAG-CSI-SSB-RESOURCESET-START

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB-ResourcePerSet)) |

OF SSB-Index,
...
}
-- TAG-CSI-SSB-RESOURCESET-STOP
-- ASN1STOP

### [Table 36] CSI-IV-ResourceSet

The IE CSI-IM-ResourceSet is used to configure a set of one or more CSI Interference Management (IM) resources (their IDs) and set-specific parameters.

CSI-IM-ResourceSet information element
-- ASN1START
-- TAG-CSI-IM-RESOURCESET-START

| | |
|---|---|
| CSI-IM-ResourceSet ::= | SEQUENCE { |
| csi-IM-ResourceSetId | CSI-IM-ResourceSetId, |
| csi-IM-Resources | SEQUENCE (SIZE(1..maxNrofCSI-IM-ResourcesPerSet)) OF |

```
CSI-IM-ResourceId,
  ...
}
-- TAG-CSI-IM-RESOURCESET-STOP
-- ASN1STOP
3 CSI-IM-ResourceSet field descriptions
  csi-IM-Resources
  CSI-IM-Resources associated with this CSI-IM-ResourceSet (see TS 38.214
[19], clause 5.2)
```

### [Table 37] CSI-AperiodicTriggerStateList

The CSI-AperiodicTriggerStateList E is used to configure the UE with a list of a periodic trigger states. Each codepoint of the DCI field “CSI request” is associated with one trigger state. Upon reception of the value associated with a trigger state, the UE may perform measurement of CSI-RS (reference signals) and aperiodic reporting on L1 according to all entries in the associatedReportConfigInfoList for that trigger state.

CSI-AperiodicTriggerStateList information element
-- ASN1START
-- TAG-CSI-APERIODICTRIGGERSTATELIST-START

| | |
|---|---|
| CSI-AperiodicTriggerStateList ::= | SEQUENCE (SIZE (1..maxNrOfCSI-AperiodicTriggers)) |

OF CSI-AperiodicTriggerState

| | |
|---|---|
| CSI-AperiodicTriggerState ::= | SEQUENCE { |
| associatedReportConfigInfoList | SEQUENCE |

(SIZE(1..maxNrofReportConfigPerAperiodicTrigger)) OF CSI-AssociatedReportConfigInfo,
...
}

| | |
|---|---|
| CSI-AssociatedReportConfigInfo ::= | SEQUENCE { |
| reportConfigId | CSI-ReportConfigId, |
| resourcesForChannel | CHOICE { |
| nzp-CSI-RS | SEQUENCE { |
| resourceSet | INTEGER (1..maxNrofNZP-CSI-RS-ResourceSetsPerConfig), |
| qcl-info | SEQUENCE (SIZE(1..maxNrofAP-CSI-RS-ResourcesPerSet)) |

OF TCI-StateId OPTIONAL -- Cond Aperiodic
},

| | |
|---|---|
| csi-SSB-ResourceSet | INTEGER (1..maxNrofCSI-SSB-ResourceSetsPerConfig) |

},

| | |
|---|---|
| csi-IM-ResourcesForInterference | INTEGER(1..maxNrofCSI-IM-ResourceSetsPerConfig) |

OPTIONAL, -- Cond CSI-IM-ForInterference

| | |
|---|---|
| nzp-CSI-RS-ResourcesForInterference | INTEGER (1..maxNrofNZP-CSI-RS- |
| ResourceSetsPerConfig) | OPTIONAL, -- Cond NZP-CSI-RS-ForInterference |

...
}
-- TAG-CSI-APERIODICTRIGGERSTATELIST-STOP
-- ASN1STOP

| CSI-AssociatedReportConfigInfo field descriptions | |
|---|---|
| csi-IM-ResourcesForInterference | |
| CSI-IM-ResourceSet for interference measurement. Entry number in csi-IM- | |
| ResourceSetList in the CSI-ResourceConfig indicated by csi-IM- | |
| ResourcesForInterference in the CSI-ReportConfig indicated by reportConfigId above (1 | |
| corresponds to the first entry, 2 to the second entry, and so on). The indicated CSI-IM- | |
| ResourceSet should have exactly the same number of resources like the NZP-CSI-RS- | |
| ResourceSet indicated in nzp-CSI-RS-ResourcesforChannel. | |
| csi-SSB-ResourceSet | |
| CSI-SSB-ResourceSet for channel measurements. Entry number in csi-SSB- | |
| ResourceSetList in the CSI-ResourceConfig indicated by | |
| resourcesForChannelMeasurement in the CSI-ReportConfig indicated by reportConfigId | |
| above (1 corresponds to the first entry, 2 to the second entry, and so on). | |
| nzp-CSI-RS-ResourcesForInterference | |
| NZP-CSI-RS-ResourceSet for interference measurement. Entry number in nzp- | |
| CSI-RS-ResourceSetList in the CSI-ResourceConfig indicated by nzp-CSI-RS- | |
| ResourcesForInterference in the CSI-ReportConfig indicated by reportConfigId above (1 | |
| corresponds to the first entry, 2 to the second entry, and so on). | |
| qcl-info | |
| List of references to TCI-States for providing the QCL source and QCL type for | |
| each NZP-CSI-RS-Resource listed in nzp-CSI-RS-Resources of the NZP-CSI-RS- | |
| ResourceSet indicated by nzp-CSI-RS-ResourcesforChannel. Each TCI-StateId refers to | |
| the TCI-State which has this value for tci-StateId and is defined in tci- | |
| StatesToAddModList in the PDSCH-Config included in the BWP-Downlink | |
| corresponding to the serving cell and to the DL BWP to which the | |
| resourcesForChannelMeasurement (in the CSI-ReportConfig indicated by | |
| reportConfigId above) belong to. First entry in qcl-info-forChannel corresponds to first | |
| entry in nzp-CSI-RS-Resources of that NZP-CSI-RS-ResourceSet, second entry in qcl- | |
| info-forChannel corresponds to second entry in nzp-CSI-RS-Resources, and so on (see | |
| TS 38.214 [19], clause 5.2.1.5.1) | |
| reportConfigId | |
| The reportConfigId of one of the CSI-ReportConfigToAddMod configured in | |
| CSI-MeasConfig | |
| resourceSet | |
| NZP-CSI-RS-ResourceSet for channel measurements. Entry number in nzp-CSI- | |
| RS-ResourceSetList in the CSI-ResourceConfig indicated by | |
| resourcesForChannelMeasurement in the CSI-ReportConfig indicated by reportConfigId | |
| above (1 corresponds to the first entry, 2 to thesecond entry, and so on). | |
| Conditional | |
| Presence | Explanation |
| Aperiodic | The field is mandatory present if the NZP-CSI-RS- |
| | Resources in the associated resourceSet have the |
| | resourceType aperiodic. The field is absent otherwise. |
| CSI-IM- | This field is optional need M if the CSI- |
| ForInterference | ReportConfig identified by reportConfigId is configured |
| | with csi-IM-ResourcesForInterference; otherwise, it is |
| | absent. |
| NZP-CSI-RS- | This field is optional need M if the CSI- |
| ForInterference | ReportConfig identified by reportConfigId is configured |
| | with nzp-CSI-RS-ResourcesForInterference; otherwise, it |
| | is absent. |

### [Table 38] CSI-SemiPersistentOnPUSCH-TriggerStateList

The CSI-SemiPersistentOnPUSCH-TriggerStateList IE is used to configure the UE with list of trigger states for semi-persistent reporting of channel state information on L1. See also TS 38.214 [19], clause 5.2.

CSI-SemiPersistentOnPUSCH-TriggerStateList information element

-- ASN1START
-- TAG-CSI-SEMIPERSISTENTONPUSCHTRIGGERSTATELIST-START

| | |
|---|---|
| CSI-SemiPersistentOnPUSCH-TriggerStateList ::= | SEQUENCE(SIZE |

(1..maxNrOfSemiPersistentPUSCH-Triggers)) OF CSI-SemiPersistentOnPUSCH-TriggerState

| | |
|---|---|
| CSI-SemiPersistentOnPUSCH-TriggerState ::= | SEQUENCE { |
| associatedReportConfigInfo | CSI-ReportConfigId, |

...
}
-- TAG-CSI-SEMIPERSISTENTONPUSCHTRIGGERSTATELIST-STOP
-- ASN1STOP

For the above-described CSI report setting (CSI-ReportConfig), each report setting CSI-ReportConfig may be associated with CSI resource setting associated with the corresponding report setting and a single downlink (DL) bandwidth part identified with a higher layer parameter bandwidth part identifier (bwp-id) given as CSI-ResourceConfig. Through a time domain reporting operation for each report setting CSI-ReportConfig, “apeodic,” “semi-persistent,” and “periodic” methods are supported, which may be configured from the base station to the UE through reportConfigType parameter that is configured from a higher layer. The semi-persistent CSI reporting method supports “PUCCH-based semi-persistent (semi-PersistentOnPUCCH)” or “PUSCH-based semi-persistent (semi-PersistentOnPUSCH).” In the case of the periodic or the semi-persistent CSI reporting method, the UE may be configured with PUCCH or PUSCH resources used to transmit CSI from the base station through higher layer signaling. The periodicity and slot offset of PUCCH or PUSCH resources used to transmit CSI may be given as numerology of an uplink (UL) bandwidth part in which CSI report is configured to be transmitted. In the case of the aperiodic CSI reporting method, the UE may be scheduled with PUSCH resources used to transmit CSI from the base station through L1 signaling (above-described DCI format 0_1).

For the above-described CSI resource setting (CSI-ResourceConfig), each CSI resource setting CSI-ReportConfig may include S (≥1) CSI resource sets (given as higher layer parameter csi-RS-ResourceSetList). A CSI resource set list may include a non-zero power (NZP) CSI-RS resource set and an SS/PBCH block set, or may include a CSI-interference measurement (CSI-IM) resource set. Each CSI resource setting may be located in a downlink (DL) bandwidth part identified by a higher layer parameter bwp-id, and CSI resource setting may be connected to CSI report setting of the same downlink bandwidth part. The time domain operation of CSI-RS resources within CSI resource setting may be configured to be one of “aperiodic,” “periodic,” and “semi-persistent” from the higher layer parameter resourceType. For the periodic or semi-persistent CSI resource setting, the number of CSI-RS resource sets may be limited to 5=1, and the configured periodicity and slot offset may be given as numerology of the downlink bandwidth part identified by bwp-id. The UE may be configured with one or at least one CSI resource setting for channel or interference measurement from the base station through higher layer signaling and may include, for example, the following CSI resources:
CSI-IM resources for interference measurement;
NZP CSI-RS resources for interference measurement; and
NZP CSI-RS resources for channel measurement.

For CSI-RS resource sets associated with resource setting in which the higher layer parameter resourceType is configured to be “aperiodic,” “periodic,” or semi-persistent,” the trigger state for CSI report setting in which reportType is configured to be “aperiodic” and resource setting for channel or interference measurement for one or more component cells (CCs) may be configured using the higher layer parameter CSI-AperiodicTriggerStateList.

Aperiodic CSI reporting of the UE may use the PUSCH, periodic CSI reporting may use the PUCCH, and semi-persistent CSI reporting may be performed using the PUSCH when triggered or activated by DCI or using the PUCCH after being activated by the MAC control element (MAC CE). As described above, CSI resource setting may also be configured to be aperiodic, periodic, or semi-persistent. The combination between CSI report setting and CSI resource setting may be supported based on [Table 39] below.

TABLE 39
Table 5.2.1.4-1: Triggering/Activation of CSI Reporting
for the possible CSI-RS Configurations.

| CSI-RS | Periodic CSI | Semi-Persistent CSI | Aperiodic CSI |
|---|---|---|---|
| Configuration | Reporting | Reporting | Reporting |
| Periodic CSI-RS | No dynamic | For reporting on | Triggered by DCI; |
| | triggering/activation | PUCCH, the UE | additionally, |
| | | receives an | activation command |
| | | activation command | [10, TS 38.321] |
| | | [10, TS 38.321]; for | possible as defined in |
| | | reporting on PUSCH, | Subclause 5.2.1.5.1. |
| | | the UE receives | |
| | | triggering on DCI | |
| Semi-Persistent CSI- | Not Supported | For reporting on | Triggered by DCI; |
| RS | | PUCCH, the UE | additionally, |
| | | receives an | activation command |
| | | activation command | [10, TS 38.321] |
| | | [10, TS 38.321]; for | possible as defined in |
| | | reporting on PUSCH, | Subclause 5.2.1.5.1. |
| | | the UE receives | |
| | | triggering on DCI | |
| Aperiodic CSI-RS | Not Supported | Not Supported | Triggered by DCI; |
| | | | additionally, |
| | | | activation command |
| | | | [10, TS 38.321] |
| | | | possible as defined in |
| | | | Subclause 5.2.1.5.1. |

Aperiodic CSI reporting may be triggered by a “CSI request” field of the above-described DCI format 0_1 corresponding to DCI that schedules the PUSCH. The UE may monitor the PDCCH, may acquire DCI format 0_1, and may acquire scheduling information on the PUSCH and a CSI request indicator. The CSI request indicator may be set to NTS(=0, 1, 2, 3, 4, 5, or 6) bits, and may be determined by higher layer signaling (reportTriggerSize). One trigger state among one or more aperiodic CSI reporting trigger states that may be configured through higher layer signaling (CSI-AperiodicTriggerStateList) may be triggered by the CSI request indicator.

If all bits of the CSI request field are 0, this may indicate that no CSI report is requested.

If the number of CSI trigger states (M) within configured CSI-AperiodicTriggerStateLite is greater than 2NTs-1, M CSI trigger states may be mapped to 2NTs-1 according to the pre-defined mapping relationship, and one of the 2NTs-1 trigger states may be indicated using the CSI request field.

If the number of CSI trigger states (M) within configured CSI-AperiodicTriggerStateLite is less than or equal to 2NTs-1, one of the M CSI trigger states may be indicated using the CSI request field.

[Table 40] below represents an example of relationship between the CSI request indicator and a CSI trigger state that may be indicated by the indicator.

TABLE 40

| CSI | | | |
|---|---|---|---|
| request | CSI | CSI- | CSI- |
| field | trigger state | ReportConfigId | ResourceConfigId |
| 00 | no CSI request | N/A | N/A |
| 01 | CSI trigger | CSI report#1 | CSI resource#1, |
| | state#1 | CSI report#2 | CSI resource#2 |
| 10 | CSI trigger | CSI report#3 | CSI resource#3 |
| | state#2 | | |
| 11 | CSI trigger | CSI report#4 | CSI resource#4 |
| | state#3 | | |

For CSI resources within the CSI trigger state triggered by the CSI request field, the UE may perform measurement and may generate CSI (including at least one of CQI, PMI, CRI, SSBRI, LI, RI, and L1-RSRP described above) from this. The UE may transmit the acquired CSI using the PUSCH that is scheduled by corresponding DCI format 0_1. When 1 bit corresponding to an uplink data indicator (UL-SCH indicator) within DCI format 0_1 indicates “1,”,” the UE may perform transmission by multiplexing PUSCH resources scheduled by DCI format 0_1 with uplink data (UL-SCH) and acquired CSI. When 1 bit corresponding to the uplink data indicator (UL-SCH indicator) within DCI format 0_1 indicates “0,”,” the UE may perform transmission by mapping only the CSI with PUSCH resources scheduled by DCI format 0_1 without uplink data (UL-SCH).

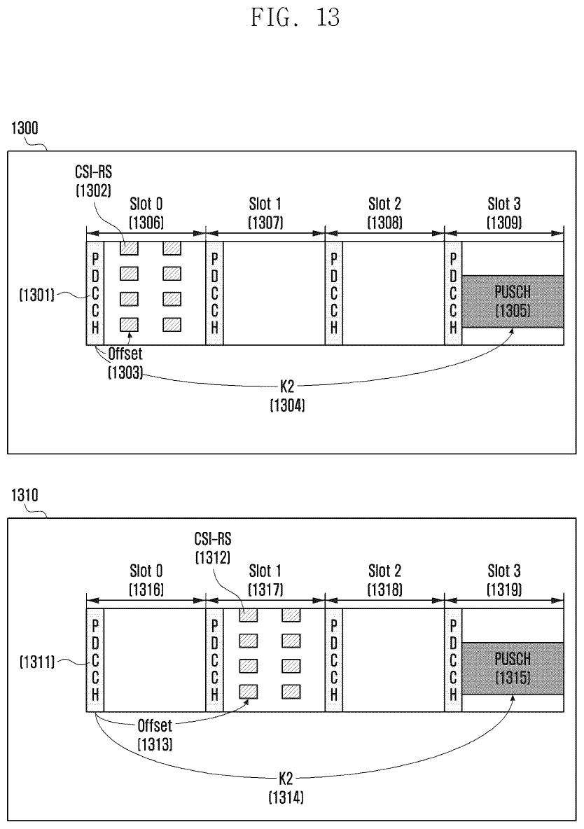

FIG. 13 illustrates an example of an aperiodic CSI reporting method according to an embodiment of the disclosure.

In an example 1300 of FIG. 13, the UE may monitor a PDCCH 1301 and may acquire DCI format 0_1, and, from this, may acquire scheduling information and CSI request information on a PUSCH 1305. The UE may acquire resource information on a CSI-RS 1302 to be measured from a received CSI request indicator. The UE may determine at which point in time measurement for the transmitted CSI-RS 1302 resource is to be performed based on a point in time at which DCI format 0_1 is received and a parameter (above-described aperiodicTriggeringOffset) for the offset within the CSI resource set configuration (e.g., NZP CSI-RS resource set configuration (NZP-CSI-RS-ResourceSet)). More specifically, the UE may be configured with an offset value X of the parameter aperiodicTriggeringOffset within NZP-CSI-RS resource set configuration from the base station through higher layer signaling, and the configured offset value X may indicate an offset between a slot in which DCI triggering aperiodic CSI reporting is received and a slot in which CSI-RS resources are transmitted. For example, the aperiodicTriggeringOffset parameter value and the offset value X may have the mapping relationship described in [Table 41] below.

TABLE 41

| aperiodicTriggeringOffset | Offset X |
|---|---|
| 0 | 0 slot |
| 1 | 1 slot |
| 2 | 2 slots |
| 3 | 3 slots |
| 4 | 4 slots |
| 5 | 16 slots |
| 6 | 24 slots |

The example 1300 of FIG. 13 shows an example in which the above-described offset value is set to X=0. In this case, the UE may receive the CSI-RS 1302 in a slot in which DCI format 0_1 triggering aperiodic CSI reporting is received (corresponding to slot 0 1306 of FIG. 13), and may report CSI 1302 measured from the received CSI-RS to the base station through the PUSCH 1305. The UE may acquire scheduling information (information corresponding to each field of DCI format 0_1 described above) on the PUSCH 1305 for CSI reporting from DCI format 0_1. For example, the UE may acquire information on a slot in which the PUSCH 1305 is to be transmitted from the above-described time domain resource allocation information on the PUSCH 1305 in DCI format 0_1. In the example 1300 of FIG. 13, the UE acquires a K2 value corresponding to a slot offset value for PDCCH-to-PUSCH and accordingly, the PUSCH 1305 may be transmitted in slot 3 1309 away from slot 0 1306 at a point in time at which a PDCCH 1301 is received.

In an example 1310 of FIG. 13, the UE may monitor a PDCCH 1311 and acquire DCI format 0_1, and from this, may acquire scheduling information and CSI request information on a PUSCH 1315. The UE may acquire resource information on a CSI-RS 1312 to be measured from a received CSI request indicator. The example 1310 of FIG. 13 shows an example in which the above-described offset value for CSI-RS is set to X=1. In this case, the UE may receive the CSI-RS 1312 in a slot in which DCI format 0_1 triggering aperiodic CSI reporting is received (corresponding to slot 0 1316 of FIG. 13) and may report CSI measured from the received CSI-RS to the base station through the PUSCH 1315.

Aperiodic CSI report may include at least one or both of CSI part 1 and CSI part 2, and when the aperiodic CSI report is transmitted through a PUSCH, it may be multiplexed with a transport block. For multiplexing, after a CRC is inserted into an input bit of aperiodic CSI, it may be mapped to a resource element within the PUSCH in a specific pattern and transmitted after encoding and rate matching. The above CRC insertion may be omitted depending on a coding method or the length of input bits. The number of modulation symbols calculated for rate matching when multiplexing CSI part 1 or CSI part 2 included in the aperiodic CSI report may be calculated as shown in [Table 42] below.

```
TABLE 42
  For CSI part 1 transmission on PUSCH not using repetition type B with UL-SCH, the
number of coded modulation symbols per layer for CSI part 1 transmission, denoted as
${Q}_{CSI - part 1}^{′} , is determined as follows :$
${Q}_{CSI - 1}^{′} = min \{ ⌈ \frac{( {O}_{CSI - 1} + {L}_{CSI - 1} ) \cdot {β}_{offset}^{PUSCH} \cdot {Σ}_{l = 0}^{{N}_{symb , all}^{PUSCH} - 1} {M}_{sc}^{UCI} ( l )}{{Σ}_{r = 0}^{{C}_{UL - SCH} - 1} {K}_{r}} ⌉ , ⌈ α \cdot {Σ}_{l = 0}^{{N}_{symb , all}^{PUSCH} - 1} {M}_{s c}^{UCI} ( l ) ⌉ - {Q}_{\frac{ACK}{CG} - UCI}^{′} \}$
  . . .
  For CSI part 1 transmission on an actual repetition of a PUSCH with repetition Type
B with UL-SCH, the number of coded modulation symbols per layer for CSI part 1
$transmission , denoted as {Q}_{CSI - part 1}^{′} , is determined as follows :$
${Q}_{CSI - 1}^{′} =$ $\{ \begin{matrix}min \{ ⌈ \frac{( {O}_{CSI - 1} + {L}_{CSI - 1} ) \cdot {β}_{offset}^{PUSCH} \cdot {Σ}_{l = 0}^{{N}_{symb , nominal}^{PUSCH} - 1} {M}_{s c , nominal}^{UCI} ( l )}{{Σ}_{r = 0}^{{C}_{UL - SCH} - 1} {K}_{r}} ⌉ , ⌈ α \cdot {\sum }_{l = 0}^{{N}_{symb , nominal}^{PUSCH} - 1} {M}_{s c , nominal}^{UCI} ( l ) ⌉ - \\ {Q}_{\frac{ACK}{CG} - UCI}^{′} , {\sum }_{l = 0}^{{N}_{symb , actual}^{PUSCH} - 1} {M}_{s c , actual}^{UCI} ( l ) - {Q}_{\frac{ACK}{CG} - UCI}^{′}\end{matrix} \}$
  . . .
  For CSI part 1 transmission on PUSCH without UL-SCH, the number of coded
$modulation symbols per layer for CSI part 1 transmission , denoted as {Q}_{CSI - part 1}^{′} , is determined$
as follows:
  if there is CSI part 2 to be transmitted on the PUSCH,
${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{ACK}^{′} \}$
  else
  ${Q}_{CSI - 1}^{′} = {Σ}_{l = 0}^{{N}_{symb , all}^{PUSCH} - 1} {M}_{sc}^{UCI} ( l ) - {Q}_{ACK}^{′}$ ${Q}_{CSI - 1}^{′} = {Σ}_{l = 0}^{{N}_{symb , all}^{PUSCH} - 1} {M}_{sc}^{UCI} ( l ) - {Q}_{ACK}^{′} end if$ $…$
  For CSI part 2 transmission on PUSCH not using repetition type B with UL-SCH, the
number of coded modulation symbols per layer for CSI part 2 transmission, denoted as
${Q}_{CSI - part 2}^{′} , is determined as follows :$
${Q}_{CSI - 2}^{′} = min \{ ⌈ \frac{( {o}_{CSI - 2} + {L}_{CSI - 2} ) \cdot {β}_{offset}^{PUSCH} \cdot {Σ}_{l = 0}^{{N}_{symb , all}^{PUSCH} - 1} {M}_{sc}^{UCI} ( l )}{{Σ}_{r = 0}^{{C}_{UL - SCH} - 1} {K}_{r}} ⌉ , ⌈ α \cdot {Σ}_{l = 0}^{{N}_{symb , all}^{PUSCH} - 1} {M}_{sc}^{UCI} ( l ) ⌉ - {Q}_{\frac{ACK}{CG} - UCI}^{′} - {Q}_{CSI - 1}^{′} \}$
  For CSI part 2 transmission on an actual repetition of a PUSCH with repetition Type
B with UL-SCH, the number of coded modulation symbols per layer for CSI part 2
$transmission , denoted as {Q}_{CSI - part 2}^{′} , is determined as follows :$
${Q}_{CSI - 2}^{′} =$ $min \{ \begin{matrix}⌈ \frac{( {O}_{CSI - 2} + {L}_{CSI - 2} ) \cdot {β}_{offset}^{PUSCH} \cdot {Σ}_{l = 0}^{{N}_{symb , nominal}^{PUSCH} - 1} {M}_{sc , nominal}^{UCI} ( l )}{{Σ}_{r = 0}^{{C}_{UL - SCH - 1}} {K}_{r}} ⌉ , ⌈ α \cdot {\sum }_{l = 0}^{{N}_{symb , nominal}^{PUSCH} - 1} {M}_{s c , nominal}^{UCI} ( l ) ⌉ - \\ {Q}_{\frac{ACK}{CG} - UCI}^{′} - {Q}_{CSI - 1}^{′} , {\sum }_{l = 0}^{{N}_{symb , actual}^{PUSCH} - 1} {M}_{sc , actual}^{UCI} ( l ) - {Q}_{\frac{ACK}{CG} - UCI}^{′} - {Q}_{CSI - 1}^{′}\end{matrix} \}$ $…$
  For CSI part 2 transmission on PUSCH without UL-SCH, the number of coded
$modulation symbols per layer for CSI part 2 transmission , denoted as {Q}_{CSI - part 2}^{′} , is determined$
as follows:
${Q}_{CSI - 2}^{′} = {\sum }_{l = 0}^{{N}_{symb , all}^{PUSCH} - 1} {M}_{sc}^{UCI} ( l ) - {Q}_{ACK}^{′} - {Q}_{CSI - 1}^{′}$
```

In particular, in the case of PUSCH repetition transmission methods A and B, the UE may transmit the aperiodic CSI report by multiplexing the same only to the first repetition transmission among PUSCH repetition transmissions. This is because aperiodic CSI report information that is multiplexed is encoded in a polar code manner and, here, each PUSCH repetition has the same frequency and time resource allocation in order to be multiplexed to a plurality of PUSCH repetitions. In particular, in the case of PUSCH repetition type B, since each actual repetition may have a different OFDM symbol length, the aperiodic CSI report may be multiplexed only to the first PUSCH repetition and transmitted.

Also, for PUSCH repetition transmission method B, when the UE schedules aperiodic CSI reporting without scheduling for the transport block or receives DCI that activates semi-persistent CSI reporting, a value of nominal repetition may be assumed as 1 although the number of PUSCH repetition transmissions configured through higher layer signaling is greater than 1. Also, when the UE schedules or activates aperiodic or semi-persistent CSI reporting without scheduling for the transport block based on PUSCH repetition transmission method B, the UE may expect the first nominal repetition to be the same as the first actual repetition. For the PUSCH transmitted including semi-persistent CSI based on PUSCH repetition transmission method B without scheduling for DCI after semi-persistent CSI reporting is activated by DCI, if the first nominal repetition differs from the first actual repetition, transmission for the first nominal repetition may be ignored.

### [Related to UE Capability Report]

In LTE and NR systems, the UE may perform a procedure for reporting UE-supported capability to a corresponding base station in a state in which the UE is connected to a serving base station. In the following description, this is referred to as UE capability report.

The base station may transmit a UE capability enquiry message that makes a request for a capability report to the UE in the connected state. The message may include a UE capability request for each radio access technology (RAT) type of the base station. The request for each RAT type may include supported frequency band combination information. In the case of the UE capability enquiry message, a plurality of UE capabilities for respective RAT types may be requested through a single RRC message container transmitted from the base station. Alternatively, the base station may insert the UE capability enquiry message including the UE capability request for each RAT type multiple times and transmit the same to the UE. That is, the UE capability enquiry is repeated multiple times within one message and the UE may configure a UE capability information message corresponding thereto and report the same multiple times. In a next-generation mobile communication system, a UE capability request for NR, LTE, E-UTRA-NR dual connectivity (EN-DC), and multi-RAT dual connectivity (MR-DC) may be made. Also, in general, the UE capability enquiry message is transmitted initially after the UE is connected to the base station, but may be requested under any condition when the base station needs the same.

The UE receiving the request for the UE capability report from the base station in the above stage constructs UE capability according to RAT type and band information requested by the base station. A method by which the UE constructs the UE capability in the NR system is described below.
1. If the UE receives a list of LTE and/or NR bands from the base station through a UE capability request, the UE configures a band combination (BC) for EN-DC and NR standalone (SA). That is, the UE configures a candidate list of BCs for EN-DC and NR SA on the basis of requested bands in FreqBandList. Also, the bands sequentially have priority as stated in FreqBandList.
2. If the base station sets a “eutra-nr-only” flag or an “eutra” flag and makes a request for the UE capability report, the UE completely removes NR SA BCs from the configured candidate list of BCs. This operation may be performed only when the LTE BS (eNB) makes a request for “eutra” capability.
3. Then, the UE removes fallback BCs from the candidate list of BCs configured in the above stage. Here, the fallback BC represents a BC that may be acquired by removing a band corresponding to at least one SCell from an arbitrary BC, and a BC before the removal of the band corresponding to at least one SCell may cover the fallback BC and thus the fallback BC may be omitted. This stage is applied to MR-DC, that is, LTE bands. BCs left after this stage are a final “candidate BC list.”.”
4. The UE selects BCs suitable for the requested RAT type from the final “candidate BC list” and selects BCs to be reported. In this stage, the UE configures supportedBandCombinationList in determined order. That is, the UE configures BCs and UE capability to be reported according to the preset order of rat-Type (nr->eutra-nr->eutra). Also, the UE configures featureSetCombination for configured supportedBandCombinationList and configures a list of “candidate feature set combination” in a candidate BC list from which a list for fallback BCs (including capability of same or lower stage) is removed. The “candidate feature set combination” may include all feature set combinations for NR and EUTRA-NR BCs, and may be acquired from a feature set combination of UE-NR-Capabilities and UE-MRDC-Capabilities containers.
5. Also, if the requested rat Type is eutra-nr and has an influence, featureSetCombinations are all included in two containers of UE-MRDC-Capabilities and UE-NR-Capabilities. However, the NR feature set includes only UE-NR-Capabilities.

After configuring the UE capability, the UE transfers a UE capability information message including the UE capability to the base station. The base station performs scheduling for the corresponding UE and transmission/reception management on the basis of the UE capability received from the UE.

### [Related to CA/DC]

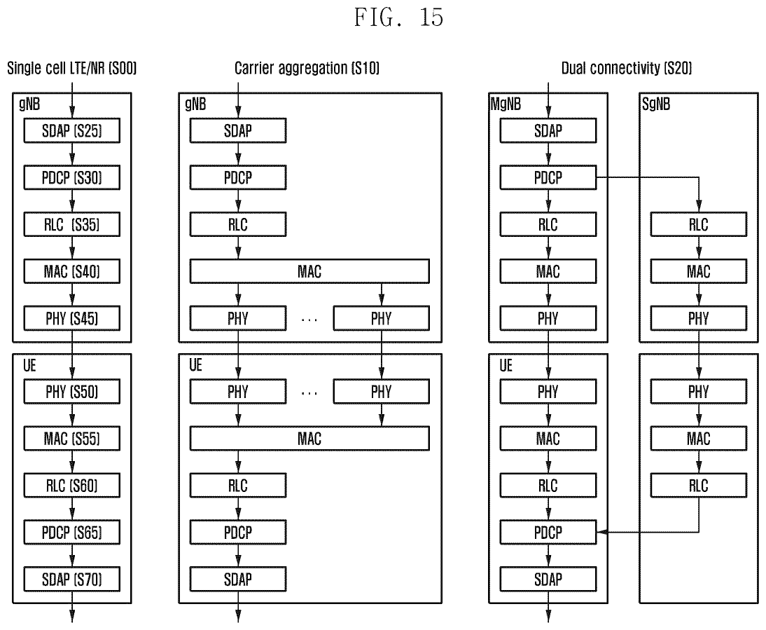

FIG. 15 illustrates a wireless protocol structure of a base station and a UE in single cell, carrier aggregation, and dual connectivity situations, according to an embodiment of the disclosure.

With reference to FIG. 15, a wireless protocol of a next-generation mobile communication system includes NR service data adaptation protocols (SDAPs) S25 and 570, NR packet data convergence protocols (PDCPs) S30 and S65, NR radio link controls (RLCs) S35 and 560, and NR medium access controls (MACs) S40 and S55 in a UE and an NR base station (gNB), respectively.

Main functions of the NR SDAP S25 and S70 may include some of the following functions.

A user data transmission function (transfer of user plane data)

A function of mapping a QoS flow and a data bearer for uplink and downlink (mapping between a QoS flow and a DRB for both DL and UL)

A function of marking a QoS flow ID for uplink and downlink (marking QoS flow ID in both DL and UL packets)

A function of mapping a reflective QoS flow to a data bearer for uplink SDAP PDUs (reflective QoS flow to DRB mapping for the UL SDAP PDUs).

For the SDAP layer device, the UE may be configured regarding whether to use a header of the SDAP layer device or a function of the SDAP layer device for each PDCP layer device, each bearer, or each logical channel through an RRC message. If the SDAP header is configured, a 1-bit indicator of non-access stratum (NAS) reflective QoS of the SDAP header and a 1 bit-indicator of AS reflective QoS may instruct the UE to update or reconfigure information on mapping of QoS flow and a data bearer in uplink and downlink. The SDAP header may include QoS flow ID information indicating QoS. The QoS information may be used as data-processing-priority or scheduling information to support a seamless service.

Main functions of the NR PDCP S30, S65 may include some of the following functions.

A header compression and decompression function (header compression and decompression: ROHC only)

A user data transmission function (transfer of user data)

A sequential delivery function (in-sequence delivery ofupper layer PDUs)

A non-sequential delivery function (out-of-sequence delivery of upper layer PDUs)

A reordering function (PDCP PDU reordering for reception)

A duplicate detection function (duplicate detection of lower layer SDUs)

A retransmission function (retransmission of PDCP SDUs)

A ciphering and deciphering function (ciphering and deciphering)

A timer-based SDU removal function (timer-based SDU discard in uplink)

The reordering function of the NR PDCP layer device refers to a function of sequentially reordering PDCP PDUs received from a lower layer on the basis of a PDCP sequence number (SN), and may include a function of sequentially transferring the reordered data to a higher layer. Alternatively, the reordering function of the NR PDCP layer device may include a function of directly transmitting data regardless of the sequence, a function of recording PDCP PDUs lost due to the reordering, a function of reporting statuses of the lost PDCP PDUs to a transmitting side, and a function of making a request for retransmitting the lost PDCP PDUs.

Main functions of the NR RLC S35, S60 may include some of the following functions.

A data transmission function (transfer of upper layer PDUs)

A sequential delivery function (in-sequence delivery of upper-layer PDUs)

A non-sequential delivery function (out-of-sequence delivery of upper-layer PDUs)

An automatic repeat request (ARQ) function (error correction through ARQ)

A concatenation, segmentation, and reassembly function (concatenation, segmentation and reassembly of RLC SDUs)

A re-segmentation function (re-segmentation of RLC data PDUs)

A reordering function (reordering of RLC data PDUs)

A duplicate detection function (duplicate detection)

An error detection function (protocol error detection)

An RLC SDU deletion function (RLC SDU discard)

An RLC reestablishment function (RLC reestablishment)

The sequential delivery function (in-sequence delivery) of the NR RLC device refers to a function of sequentially transmitting RLC SDUs received from the lower layer to the higher layer. When one original RLC SDU is divided into a plurality of RLC SDUs and then received, the sequential delivery function (in-sequence delivery) of the NR RLC device may include a function of reassembling and transmitting the RLC SDUs, a function of reordering the received RLC PDUs on the basis of an RLC SN or a PDCP SN, a function of recording RLC PDUs lost due to the reordering, a function of reporting statuses of the lost RLC PDUs to a transmitting side, and a function of making a request for retransmitting the lost RLC PDUs. When there are lost RLC SDUs, the sequential delivery function (in-sequence delivery) of the NR RLC device may include a function of sequentially transferring only RLC SDUs preceding the lost RLC SDUs to the higher layer or a function of, if there are lost RLC SDUs, but a predetermined timer expires, sequentially transferring all RLC SDUs received before the timer starts to the higher layer. Alternatively, the sequential delivery function (in-sequence delivery) of the NR RLC device may include a function of, if there are lost RLC SDUs, but a predetermined timer expires, sequentially transferring all RLC SDUs received up to now to the higher layer. Also, the NR RLC device may process the RLC PDUs sequentially in order in which they are received (according to the arrival order regardless of a serial number or a sequence number) and may transfer the RLC PDUs to the PDCP device regardless of the sequence thereof (out-of-sequence delivery). In the case of segments, the NR RLC device may receive segments that are stored in a buffer or are to be received in the future, reconfigure the segments to be one RLC PDU, process the RLC PDU, and then transmit the same to the PDCP device. The NR RLC layer may not include a concatenation function, and the function may be performed by an NR MAC layer, or may be replaced with a multiplexing function of the NR MAC layer.

The non-sequential function (out-of-sequence delivery) of the NR RLC device refers to a function of transferring RLC SDUs received from the lower layer directly to the higher layer regardless of the sequence of the RLC SDUs, and when one original RLC SDU is divided into a plurality of RLC SDUs and then received, may include a function of reassembling and transmitting the RLC PDUs and a function of storing RLC SNs or PDCP SNs of the received RLC PDUs, reordering the RLC PDUs, and recording lost RLC PDUs.

The NR MAC S40, S55 may be connected to a plurality of NR RLC layer devices configured in one UE, and main functions of the NR MAC may include some of the following functions:
A mapping function (mapping between logical channels and transport channels);
A multiplexing and demultiplexing function (multiplexing/demultiplexing of MAC SDUs);
A scheduling information report function (scheduling information reporting);
A HARQ function (error correction through HARQ);
A logical channel priority control function (priority handling between logical channels of one UE);
A UE priority control function (priority handling between UEs by means of dynamic scheduling);
An MBMS service identification function (MBMS service identification);
A transport format selection function (transport format selection); and/or
A padding function (padding).

The NR PHY layer S45, S50 performs an operation for channel-coding and modulating higher layer data to generate an OFDM symbol and transmitting the OFDM symbol through a wireless channel or demodulating and channel-decoding the OFDM symbol received through the wireless channel and transmitting the demodulated and channel-decoded OFDM symbol to the higher layer.

A detailed structure of the wireless protocol may be variously modified according to a carrier (or cell) operation scheme. For example, when the base station transmits data to the UE on the basis of a single carrier (or cell), the base station and the UE use a protocol structure having a single structure for each layer as indicated by reference numeral S00. On the other hand, when the base station transmits data to the UE on the basis of CA using multiple carriers in a single TRP, the base station and the UE use a protocol structure in which layers up to RLC have a single structure but the PHY layer is multiplexed through the MAC layer as indicated by reference numeral S10. As another example, when the base station transmits data to the UE on the basis of dual connectivity (DC) using multiple carriers in multiple TRPs, the base station and the UE use a protocol structure in which layers up to RLC have a single structure but the PHY layer is multiplexed through the MAC layer as indicated by reference numeral S20.

With reference to the above-described PDCCH and beam configuration-related descriptions, since PDCCH repetition transmission is not currently supported in Rel-15 and Rel-16 NRs, it is difficult to achieve the required reliability in a scenario requiring high reliability, such as URLLC. The present disclosure improves the PDCCH reception reliability of the UE by providing a PDCCH repetition transmission method via multiple transmission points (TRPs).

Hereinafter, an embodiment of the disclosure is described with reference to the accompanying drawings. The contents of the disclosure may be applicable in frequency division duplexing (FDD) and time division duplexing (TDD) systems. In the following, higher signaling (or higher layer signaling) herein may be a signal transmission method of transmitting a signal from the base station to the UE using a downlink data channel of a physical layer or from the UE to the base station using an uplink data channel of the physical layer, and may be referred to as RRC signaling, PDCP signaling, or an MAC control element (CE).

Hereinafter, in the disclosure, when determining whether to apply cooperative communication, the UE may use various methods by which PDCCH(s) allocating PDSCHs to which cooperative communication is applied have a specific format, PDCCH(s) allocating PDSCHs to which cooperative communication is applied include a specific indicator informing of whether cooperative communication is applied, PDCCH(s) allocating PDSCHs to which cooperative communication is applied are scrambled by a specific RNTI, or the application of cooperative communication to a specific section indicated by a higher layer is assumed. Hereinafter, for convenience of description, a case in which the UE receives a PDSCH to which cooperative communication is applied on the basis of conditions similar to the above conditions is referred to as a non-coherent joint transmission (NC-JT) case.

Hereinafter, in the disclosure, determining the priority between A and B may be described in various ways, such as selecting one having higher priority according to a predetermined priority rule to perform an operation corresponding thereto, or omitting or dropping an operation of one having lower priority.

Hereinafter, in the disclosure, the examples are explained through a plurality of embodiments. However, the embodiments are not independent, and one or more embodiments may be applied simultaneously or in combination.

### [Related to NC-JT]

According to an embodiment of the disclosure, non-coherent joint transmission (NC-JT) may be used for the UE to receive a PDSCH from a plurality of TRPs.

Unlike the system, a 5G wireless communication system may support all of a service having very short transmission latency and a service requiring a high connectivity density as well as a service requiring a high transmission rate. In a wireless communication network including a plurality of cells, TRPs, or beams, cooperative communication (coordinated transmission) between respective cells, TRPs, or beams may satisfy various service requirements by increasing the strength of a signal received by the UE or efficiently controlling interference between the respective cells, TRPs, and/or beams.

Joint transmission (JT) refers to representative transmission technology for the cooperative communication described above and may increase the strength of a signal received by the UE or throughput by transmitting signals to one UE through different cells, TRPs, and/or beams. Here, a channel between each cell, TRP, and/or beam and the UE may have greatly different characteristics, and particularly, NC-JT supporting non-coherent precoding between respective cells, TRPs, and/or beams may need individual precoding, MCS, resource allocation, and TCI indication according to the channel characteristics for each link between each cell, TRP, and/or beam and the UE.

The NC-JT described above may be applied to at least one of a downlink data channel (e.g., PDSCH), a downlink control channel (e.g., PDCCH), an uplink data channel (e.g., PUSCH), and an uplink control channel (e.g., PUCCH)). In PDSCH transmission, transmission information, such as precoding, MCS, resource allocation, and TCI, may be indicated through DL DCI, and needs to be independently indicated for each cell, TRP, and/or beam for the NC-JT. This is a significant factor that increases payload required for DL DCI transmission, which may have a bad influence on the reception performance of the PDCCH for transmitting DCI. Accordingly, in order to support JT of the PDSCH, there is a need to carefully design a tradeoff between an information amount of DCI and reception performance of control information.

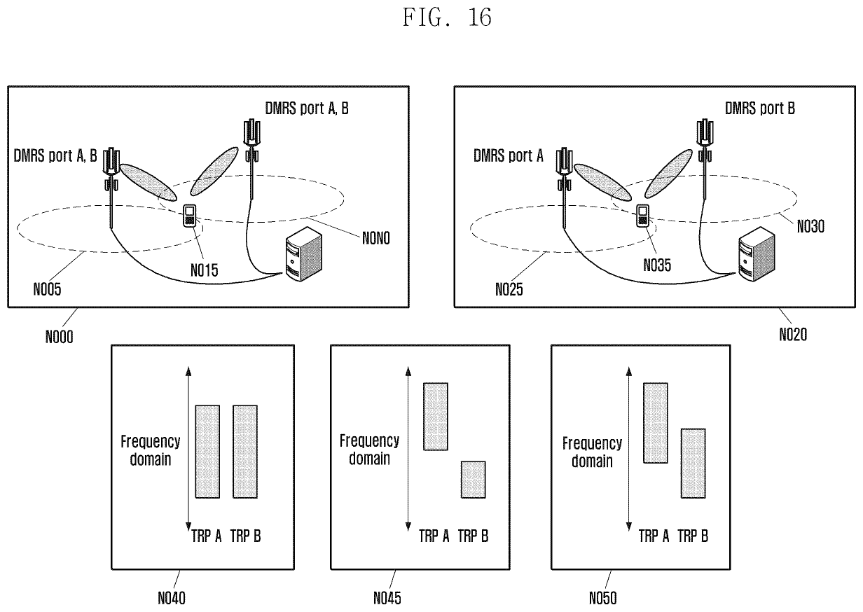

FIG. 16 illustrates an example of configuring antenna ports and allocating resources for transmitting a PDSCH using cooperative communication in a wireless communication system, according to an embodiment of the disclosure.

With reference to FIG. 16, an example for PDSCH transmission is described for each scheme of JT, and examples for allocating radio resources for each TRP are illustrated.

With reference to FIG. 16, an example N000 of coherent JT (C-JT) supporting coherent precoding between respective cells, TRPs, and/or beams is illustrated.

In the case of C-JT, a TRP A N005 and a TRP B N010 transmit a single piece of data (e.g., PDSCH) to a UE N015, and a plurality of TRPs may perform joint precoding. This may imply that the TRP A N005 and the TPR B N010 transmit DMRSs through the same DMRS ports in order to transmit the same PDSCH. For example, the TRP A N005 and the TPR B N010 may transmit DMRSs to the UE through a DMRS port A and a DMRS port B, respectively. In this case, the UE may receive one piece of DCI for receiving one PDSCH demodulated on the basis of the DMRSs transmitted through the DMRS port A and the DMRS port B.

FIG. 16 illustrates an example N020 of NC-JT supporting non-coherent precoding between respective cells, TRPs, and/or beams for PDSCH transmission.

In the case of NC-JT, a PDSCH is transmitted to a UE N035 for each cell, TPR, and/or beam, and individual precoding may be applied to each PDSCH. Respective cells, TRPs, and/or beams may transmit different PDSCHs or different PDSCH layers to the UE, thereby improving throughput compared to single cell, TRP, and/or beam transmission. Also, respective cells, TRPs, and/or beams may repeatedly transmit the same PDSCH to the UE, thereby improving reliability compared to single cell, TRP, and/or beam transmission. For convenience of description, the cell, the TRP, and/or the beam are commonly called a TRP.

Here, various wireless resource allocations, such as a case N040 in which frequency and time resources used by a plurality of TRPs for PDSCH transmission are all the same, a case N045 in which frequency and time resources used by a plurality of TRPs do not overlap at all, and a case N050 in which frequency and time resources used by a plurality of TRPs partially overlap each other may be considered.

In order to support NC-JT, DCI in various forms, structures, and relations may be considered to simultaneously allocate a plurality of PDSCHs to one UE.

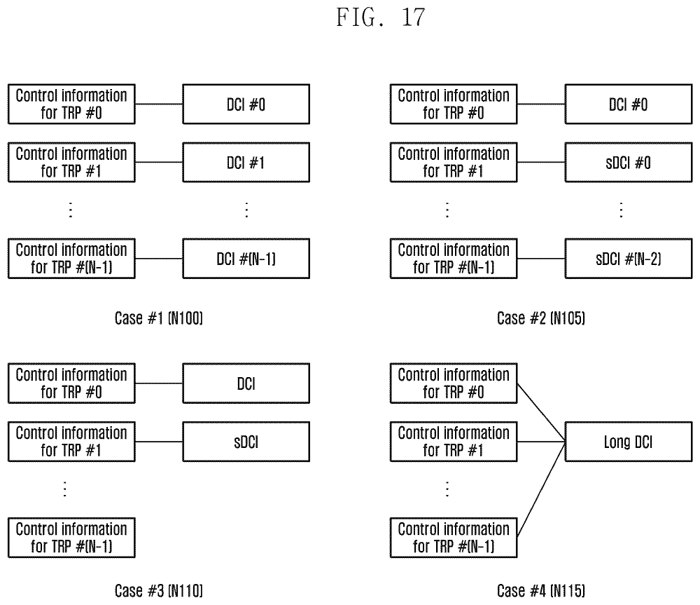

FIG. 17 illustrates an example for a constitution of DCI for NC-JT in which respective TRPs transmit different PDSCHs or different PDSCH layers to a UE in a wireless communication system, according to an embodiment of the disclosure.

With reference to FIG. 17, Case #1 N100 is an example in which control information for PDSCHs transmitted from (N−1) additional TRPs is transmitted independently from control information for a PDSCH transmitted from a serving TRP in a situation in which (N−1) different PDSCHs are transmitted from the (N−1) additional TRPs (TRP #1 to TRP #(N−1)) other than the serving TRP (TRP #0) used for single PDSCH transmission. That is, the UE may acquire control information for PDSCHs transmitted from different TRPs (TRP #0 to TRP #(N−1)) through independent DCI (DCI #0 to DCI #(N−1)). Formats between the independent DCI may be the same as or different from each other, and payload between the DCI may also be the same as or different from each other. In Case #1 described above, a degree of freedom of each PDSCH control or allocation may be completely guaranteed, but when respective pieces of DCI are transmitted from different TRPs, a difference in DCI-specific coverage may occur, which may lead to degrading reception performance.

Case #2 N105 is an example in which pieces of control information (DCI) for PDSCHs of (N−1) additional TRPs are transmitted and each piece of DCI is dependent on control information for the PDSCH transmitted from the serving TRP in a situation in which (N−1) different PDSCHs are transmitted from (N−1) additional TRPs (TRP #1 to TRP #(N−1)) other than the serving TRP (TRP #0) used for single PDSCH transmission.

For example, DCI #0 that is control information for the PDSCH transmitted from the serving TRP (TRP #0) may include all information elements of DCI format 10, DCI format 1_1, and DCI format 1_2, but shortened DCI (hereinafter, referred to as sDCI) (sDCI #0 to sDCI #(N−2)) that is control information for PDSCHs transmitted from the cooperative TRPs (TRP #1 to TRP #(N−1)) may include only some of the information elements of DCI format 10, DCI format 1_1, and DCI format 1_2. Accordingly, the sDCI for transmitting control information for PDSCHs transmitted from cooperative TPRs has smaller payload compared to normal DCI (nDCI) for transmitting control information related to the PDSCH transmitted from the serving TRP, and thus may include reserved bits compared to the nDCI.

In Case #2 described above, a degree of freedom of each PDSCH control or allocation may be limited according to content of information elements included in the sDCI, but reception performance of the sDCI is better than the nDCI, making it possible to lower the probability that difference in DCI-specific coverage occurs.

Case #3 N110 is an example in which one piece of control information for PDSCHs of (N−1) additional TRPs is transmitted and the DCI is dependent on control information for the PDSCH transmitted from the serving TRP in a situation in which (N−1) different PDSCHs are transmitted from (N−1) additional TRPs (TRP #1 to TRP #(N−1)) other than the serving TRP (TRP #0) used for single PDSCH transmission.

For example, DCI #0 that is control information for the PDSCH transmitted from the serving TRP (TRP #0) may include all information elements of DCI format 10, DCI format 1_1, and DCI format 1_2, and in the case of control information for PDSCHs transmitted from cooperative TRPs (TRP #1 to TRP #(N−1)), only some of the information elements of DCI format 1_0, DCI format 1_1, and DCI format 1_2 may be gathered in one “secondary” DCI (sDCI) and transmitted. For example, the sDCI may include at least one piece of HARQ-related information, such as frequency domain resource assignment and time domain resource assignment of the cooperative TRPs, and the MCS. In addition thereto, information that is not included in the sDCI, such as a BWP indicator and a carrier indicator, may follow the DCI (DCI #0, normal DCI, or nDCI) of the serving TRP.

In Case #3 N110, a degree of freedom of PDSCH control or allocation may be limited according to content of the information elements included in the sDCI, but reception performance of the sDCI may be controlled, and Case #3 N110 may have smaller complexity of DCI blind decoding of the UE compared to Case #1 N100 or Case #2 N105.

Case #4 N115 is an example in which control information for PDSCHs transmitted from (N−1) additional TRPs is transmitted in the DCI (long DCI) that is the same as that of control information for the PDSCH transmitted from the serving TRP in a situation in which different (N−1) PDSCHs are transmitted from the (N−1) additional TRPs (TRP #1 to TRP #(N−1)) other than the serving TRP (TRP #0) used for single PDSCH transmission. That is, the UE may acquire control information for PDSCHs transmitted from different TRPs (TRP #0 to TRP #(N−1)) through single DCI. In Case #4 N115, complexity of DCI blind decoding of the UE may not be increased, but a degree of freedom of PDSCH control or allocation may be low since the number of cooperative TRPs is limited according to long DCI payload restriction.

In the following description and embodiments, sDCI may refer to various pieces of supplementary DCI, such as shortened DCI, secondary DCI, or normal DCI (DCI formats 1_0 and 1_1) including PDSCH control information transmitted from the cooperative TRP, and unless specific restriction is mentioned, the corresponding description may be similarly applied to various pieces of supplementary DCI.

Case #1 N100, Case #2 N105, and Case #3 N110 in which one or more pieces of DCI (PDCCHs) are used to support NC-JT may be classified as multiple PDCCH-based NC-JT, and Case #4 N115 in which single DCI (PDCCH) is used to support NC-JT may be classified as single PDCCH-based NC-JT. In multiple PDCCH-based PDSCH transmission, a CORESET for scheduling DCI of the serving TRP (TRP #0) may be distinguished from CORESETs for scheduling DCI of cooperative TRPs (TRP #1 to TRP #(N−1)). A method of distinguishing CORESETs may include a distinguishing method through a higher layer indicator for each CORESET and a distinguishing method through beam configuration for each CORESET. Also, in single PDCCH-based NC-JT, single DCI schedules a single PDSCH having a plurality of layers instead of scheduling a plurality of PDSCHs, and the plurality of layers may be transmitted from a plurality of TRPs. Here, association between a layer and a TRP transmitting the corresponding layer may be indicated through a TCI indication for the layer.

In embodiments of the disclosure, the term “cooperative TRP” may be replaced with various terms, such as a “cooperative panel” and a “cooperative beam,”,” when actually applied.

In embodiments of the disclosure, a “case in which NC-JT is applied” may be variously interpreted depending on situations, such as a “case in which the UE simultaneously receives one or more PDSCHs in one BWP,”,” a “case in which the UE simultaneously receives PDSCHs on the basis of two or more TCI indications in one BWP,”,” and a “case in which PDSCHs received by the UE are associated with one or more DMRS port groups,”,” but is used by one expression for convenience of description.

In the present disclosure, a wireless protocol structure for NC-JT may be variously used according to a TRP development scenario. For example, when a backhaul delay between cooperative TRPs is absent or small, a method (CA-like method) using a structure based on MAC layer multiplexing may be used similarly to reference numeral S10 of FIG. 15. On the other hand, when the backhaul delay between cooperative TRPs is too large to be ignored (e.g., when a time of 2 ms or longer is required to exchange information, such as CSI, scheduling, and HARQ-ACK between cooperative TRPs), a method (DC-like method) of securing a characteristic robust against a delay may be used through an independent structure for each TRP from an RLC layer similarly to reference numeral S20 of FIG. 15.

The UE supporting C-JT/NC-JT may receive a C-JT/NC-JT-related parameter or setting value from a higher layer configuration and may set an RRC parameter of the UE on the basis thereof. For the higher layer configuration, the UE may use a UE capability parameter, for example, tci-StatePDSCH. Here, the UE capability parameter, for example, tci-StatePDSCH may define TCI states for PDSCH transmission, the number of TCI states may be configured as 4, 8, 16, 32, 64, and 128 in FR1 and may be configured as 64 and 128 in FR2, and a maximum of 8 states that may be indicated by 3 bits of a TCI field of the DCI may be configured through a MAC CE message among the configured numbers. A maximum value, 128, refers to a value indicated by maxNumberConfiguredTClstatesPerCC within the parameter tci-StatePDSCH that is included in capability signaling of the UE. As described above, a series of configuration processes from the higher layer configuration to the MAC CE configuration may be applied to a beamforming indication or a beamforming change command for at least one PDSCH in one TRP.

### [Multi-DCI-Based Multi-TRP]

According to an embodiment of the disclosure, it is possible to configure a downlink control downlink control channel for NC-JT based on a multi-PDCCH.

In NC-JT based on multiple PDCCHs, there may be a CORESET or a search space distinguished for each TRP when transmitting DCI for scheduling a PDSCH of each TRP. The CORESET or the search space for each TRP may be configured according to at least one of the following configuration cases.
A higher layer index configuration for each CORESET: CORESET configuration information configured through a higher layer may include an index value, and a TRP for transmitting a PDCCH in the corresponding CORESET may be identified by the configured index value for each CORESET. That is, in a set of CORESETs having the same higher layer index value, the same TRP may be considered to transmit the PDCCH, or the PDCCH that schedules the PDSCH of the same TRP may be considered to be transmitted. The index for each CORESET may be named CORESETPoolIndex, and the PDCCH may be considered to be transmitted from the same TRP in CORESETs in which the same CORESETPoolIndex value is configured. In the case of CORESET in which the CORESETPoolIndex value is not configured, a default value of CORESETPoolIndex may be considered to have been configured, and the default value may be 0.
A configuration of multiple PDCCH-Config: A plurality of PDCCH-Config are configured in one BWP, and each PDCCH-Config may include a PDCCH configuration for each TRP. That is, a list of CORESETs for each TRP and/or a list of search spaces for each TRP may be included in one PDCCH-Config, and one or more CORESETs and one or more search spaces included in one PDCCH-Config may correspond to a specific TRP.
A constitution of a CORESET beam/beam group: A TRP that corresponds to a corresponding CORESET may be identified through a beam or a beam group configured for each CORESET. For example, when the same TCI state is configured in a plurality of CORESETs, the corresponding CORESETs may be considered to be transmitted through the same TRP, or a PDCCH that schedules a PDSCH of the same TRP may be considered to be transmitted in the corresponding CORESET.
A configuration of a search space beam/beam group: A beam or a beam group is configured for each search space, and a TRP for each search space may be identified therethrough. For example, when the same beam/beam group or TCI state is configured in a plurality of search spaces, the same TRP may be considered to transmit the PDCCH in a corresponding search space or a PDCCH that schedules a PDSCH of the same TRP may be considered to be transmitted in the corresponding search space.
As described above, by distinguishing CORESETs or search spaces for each TRP, PDSCH and HARQ-ACK information may be classified for each TRP and, through this, it is possible to generate an independent HARQ-ACK codebook for each TRP and use an independent PUCCH resource.

The above configuration may be independent for each cell or for each BWP. For example, while two different CORESETPoolIndex values are configured in a PCell, no CORESETPoolIndex value may be configured in a specific SCell. In this case, it may be considered that NC-JT is configured in the PCell, but NC-JT is not configured in the SCell in which no CORESETPoolIndex value is configured.

### [Single-DCI-Based Multi-TRP]

According to another embodiment of the disclosure, it is possible to configure a downlink beam for NC-JT based on a single PDCCH.

Single-PDCCH-based NC-JT may schedule PDSCHs transmitted from a plurality of TRPs with one piece of DCI. Here, as a method of indicating the number of TRPs transmitting the corresponding PDSCHs, the number of TCI states may be used. That is, single-PDCCH-based NC-JT may be considered if the number of TCI states indicated by the DCI for scheduling the PDSCHs is 2, and single-TRP transmission may be considered if the number of TCI states is 1. The TCI states indicated by the DCI may correspond to one or two TCI states among TCI states activated by the MAC CE. When the TCI states of DCI correspond to two TCI states activated by the MAC CE, a TCI codepoint indicated by the DCI is associated with the TCI states activated by the MAC CE and in which case the number of TCI states activated by the MAC CE, corresponding to the TCI codepoint, may be 2.

This configuration may be independent for each cell or each BWP. For example, while the number of activated TCI states corresponding to one TCI codepoint is up to 2 in a PCell, the number of activated TCI states corresponding to one TCI codepoint may be up to 1 in a specific SCell. In this case, it may be considered that NC-JT is configured in the PCell, but NC-JT is not configured in the SCell.

### [PHR]

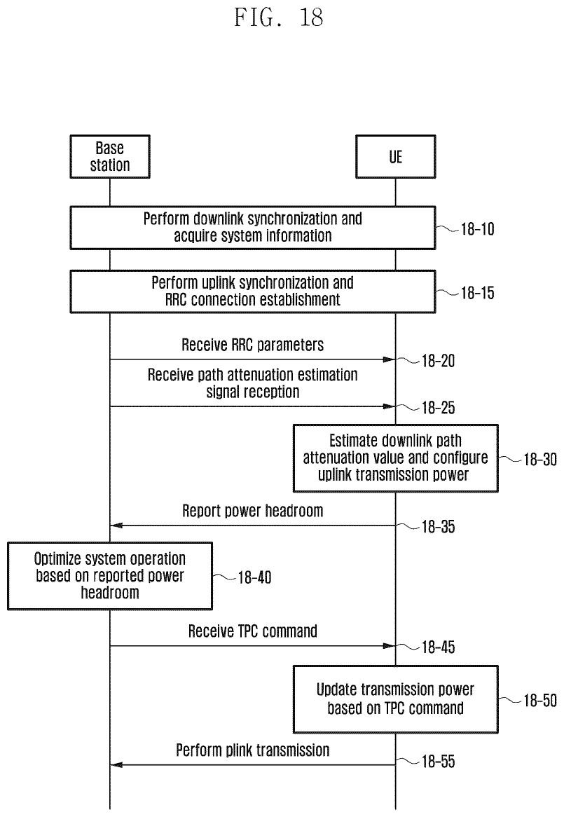

FIG. 18 illustrates a procedure for a base station to control transmission power of a UE in a cellular system. In operation 18-10 of FIG. 18, a UE present within coverage of a base station may perform downlink synchronization with the base station and may acquire system information. According to some embodiments, downlink synchronization may be performed through a synchronization signal, primary synchronization signal/secondary synchronization signal (PSS/SSS) received from the base station. UEs that perform downlink synchronization may receive a master information block (MIB) and a system information block (SIB) from the base station and may acquire system information. In operation 18-15, the UE may perform uplink synchronization with the base station through a random access procedure and may perform radio resource control (RRC) connection establishment. In the random access procedure, the UE may transmit a random access preamble (Preamble) and message 3 (msg3) to the base station through uplink. Here, uplink transmission power control may be performed during transmission of random access preamble and message 3. Specifically, the UE may receive parameters for uplink transmission power control from the base station through the acquired system information, for example, SIB, or may perform uplink transmission power control using a promised parameter. In another embodiment of the disclosure, the UE may measure reference signal received power (RSRP) from a path attenuation estimation signal transmitted from the base station and may estimate a downlink path attenuation value as shown in [Equation 7] below. Based on the estimated path attenuation value, an uplink transmission power value for the random access preamble and message 3 may be set.

$$Downlink path attenuation = transmission power of base station signal - RSRP measured by UE . \qquad [ Equation 7 ]$$

In [Equation 7], the transmission power of the base station signal refers to the transmission power of the downlink path attenuation estimation signal transmitted from the base station. The downlink path attenuation estimation signal transmitted from the base station may be a cell-specific reference signal (CRS) or a synchronization signal block (SSB). When the path attenuation estimation signal is the CRS, the transmission power of the base station signal indicates the transmission power of the CRS and may be transmitted to the user through a referenceSignalPower parameter of system information. When the path attenuation estimation signal is the SSB, the transmission power of the base station signal indicates the transmission power of a secondary synchronization signal (SSS) and a demodulation reference signal (DMRS) transmitted to a PBCH, and may be transmitted to the UE through an ss-PBCH-BlockPower parameter of system information. In operation 18-20, the UE may receive RRC parameters for uplink transmission power control from the base station through UE-specific RRC or common RRC. Here, the received transmission power control parameters may differ from each other depending on a type of an uplink channel and a signal type that are transmitted through uplink. That is, transmission power control parameters applied to transmission of an uplink control channel (physical uplink control channel (PUCCH)), an uplink data channel (physical uplink shared channel (PUSCH)), and a sounding reference signal (SRS) may differ from each other. Also, as described above, transmission power control parameters received by the UE from the base station through the SIB before RRC connection establishment, or transmission power control parameters used by the UE as promised values before RRC connection establishment may be included in RRC parameters transmitted from the base station after RRC connection establishment. The UE may use an RRC parameter value received from the base station after RRC connection establishment for uplink transmission power control. In operation 18-25, the UE may receive a path attenuation estimation signal from the base station. More specifically, the base station may configure a channel state information-reference signal (CSI-RS) as the path attenuation estimation signal of the UE after RRC connection establishment of the UE. In this case, the base station may transmit information on the transmission power of the CSI-RS to the UE through a powerControlOffsetSS parameter of UE dedicated RRC information. Here, powerControlOffsetSS may indicate the difference (offset) in transmission power between the SSB and the CSI-RS. In operation 18-30, the UE may estimate a downlink path attenuation value and may configure an uplink transmission power value. More specifically, the UE may measure downlink RSRP using the CSI-RS and may estimate the downlink path attenuation value through [Equation 1] using information on the transmission power of the CSI-RS received from the base station. Based on the estimated path attenuation value, an uplink transmission power value for transmission of the PUCCH, PUSCH, and SRS may be configured. In operation 18-35, the UE may report a power headroom (power headroom reporting (PHR)) to the base station. The power headroom may refer to the difference between the UE's current transmission power and the UE's maximum output power. In operation 18-40, the base station may optimize system operation based on the reported power headroom. For example, when a specific UE reports a positive power headroom value to the base station, the base station may allocate more resources (resource blocks (RBs)) to the corresponding UE and may increase system throughput. In operation 18-45, the UE may receive a transmission power control (TPC) command from the base station. For example, when the specific UE reports a negative power headroom value to the base station, the base station may allocate fewer resources to the corresponding UE or may reduce the transmission power of the UE through the TPC command. Through this, it is possible to increase the system throughput or to reduce unnecessary power consumption of the UE. In operation 18-50, the UE may update the transmission power based on the TPC command. Here, the TPC command may be transmitted to the UE through UE-specific DCI or group common DCI. Therefore, the base station may dynamically control the transmission power of the UE through the TPC command. In operation 18-55, the UE may perform uplink transmission based on the updated transmission power.

### [PUSCH Power Control]

PUSCH transmission power may be determined through [Equation 8] below.

$${P}_{PUSCH} ( i , j , {q}_{d} , l ) = min \{ \begin{matrix}{P}_{CMAX , f , c} ( i ) , \\ \begin{matrix}{P}_{{0}_{PUSCH} , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} \} [ dBm ] \qquad [ Equation 8 ]$$

In [Equation 8], P_{CMAX,f,c}(i) denotes the maximum transmission power configured to the UE for carrier f of serving cell c at PUSCH transmission time point i. P₀_{_{PUSCH}}_{,b,f,c}(j) refers to a reference configuration transmission power configuration value according to activated uplink bandwidth part (BWP) b of carrier f of serving cell c and has different values according to various transmission types j. It may have various values when PUSCH transmission is a message 3 PUSCH for random access, when the PUSCH is a configured grant PUSCH, or when the PUSCH is a scheduled PUSCH.

$${M}_{RB , b , f , c}^{P U S C H} ( i )$$

denotes the frequency size to which the PUSCH is allocated. α_{b,f,c}(j) denotes a compensation ratio value for path loss of UL BWP b of carrier f of serving cell c, and may be configured by a higher signal and may have a different value depending on j. PL_{b,f,c}(q_{d}) refers to a downlink path loss estimation value of UL BWP b of carrier f of serving cell c and uses a value measured through a reference signal in an activated downlink bandwidth part. The reference signal may be an SS/PBCH block or a CSI-RS. In [Equation 7], the above-described downlink path loss may be calculated. In another embodiment of the disclosure, PL_{b,f,c}(q_{d}) denotes a downlink path attenuation value and is a path attenuation calculated by the UE as shown in [Equation 7]. The UE calculates the path attenuation based on reference signal resources associated with the SS/PBCH block or the CSI-RS depending on whether the higher signal is configured. The reference signal resource may select one from among a plurality of reference signal resource sets by the higher signal or L1 signal, and the UE calculates the path attenuation based on the reference signal resource. Δ_{TF,b,f,c}(i) denotes a value that is determined by a modulation and coding scheme (MCS) value of the PUSCH at the PUSCH transmission time point i of UL BWP b of carrier f of serving cell c. f_{b,f,c}(i, l) refers to a power control adaptation value and may dynamically adjust a power value by a TPC command.

The TPC command is divided into an accumulated mode and an absolute mode, and one between two modes is determined by the higher signal. In the accumulated mode, a currently determined power control adaptation value is accumulated in a value indicated by the TPC command and may increase or decrease according to the TPC command, and has the relationship of f_{b,f,c}(i, 1)=f_{b,f,c}(i˜i₀, l)+Σδ_{PUSCH,b,f,c}. δ_{PUSCH,b,f,c} denotes the value indicated by the TPC command. In the absolute mode, the value is determined by the TPC command regardless of the currently determined power control adaptation value and has the relationship of f_{b,f,c}(i, l)=δ_{PUSCH,b,f,c}. [Table 43] below shows values that may be indicated by the TPC command.

TABLE 43
TPC command

| | | |
|---|---|---|
| TPC Command | Accumulated | Absolute |
| Field | δ_{PUSCH, b, f, c} or | δ_{PUSCH, b, f, c} or |
| | δ_{SRS, b, f .c} [dB] | δ_{SRS, b, f, c} [dB] |

### [PUCCH Power Control]

[Equation 9] is used to determine PUCCH transmission power.

$${P}_{PUCCH , b , f , c} ( i , {q}_{u} , {q}_{d} , l ) = min \{ \begin{matrix}{P}_{CMAX , f , c} ( i ) , \\ \begin{matrix}{P}_{{0}_{PUCCH} , b , f , c} ( {q}_{u} ) + 10 {log}_{10} ( {2}^{μ} \cdot {M}_{RB , b , f , c}^{PUCCH} ( i ) ) + \\ \begin{matrix}{PL}_{b , f , c} ( {q}_{d} ) + {Δ}_{{F}_{PUCCH}} ( i ) + {Δ}_{TF , b , f , c} ( i ) + \\ {f}_{b , f , c} ( i , l )\end{matrix}\end{matrix}\end{matrix} \} [ dBm ] \qquad [ Equation 9 ]$$

In [Equation 9], P₀_{_{PUCCH}}_{,b,f,c}(qᵤ) denotes a reference configuration transmission power configuration value and has different values according to various transmission types qᵤ, and the value may be changed due to a higher signal, such as RRC or MAC CE. When the value is changed due to the MAC CE, and when a slot that transmits HARQ-ACK for a PDSCH in which the UE receives the MAC CE is k, the UE determines that the corresponding value is applied from k+koffset slot. koffset has a different value based on a subcarrier spacing and, for example, may have 3 ms.

$${M}_{RB , b , f , c}^{PUCCH} ( i )$$

denotes the size of a frequency resource area to which the PUCCH is allocated. PL_{b,f,c}(q_{d}) denotes a path attenuation estimation value of the UE. As described above in [Equation 7], the UE calculates it based on a specific reference signal among various CSI-RSs or SS/PBCHs depending on a higher signal configuration status and type. The same q_{d} is applied to repetition transmission PUCCHs. The same qᵤ is applied to repetition transmission PUCCHs.

### [HARQ-ACK: Related to Type 1 (Semi-Static) Codebook]

In a situation in which the number of HARQ-ACK PUCCHs that the UE may transmit within a single slot is limited to one, if the UE receives semi-static HARQ-ACK codebook higher configuration, the UE reports HARQ-ACK information on PDSCH reception or SPS PDSCH release within HARQ-ACK codebook indicated by a value of a PDSCH-to-HARQ_feedback timing indicator within DCI format 1_0 or DCI format 1_1. The UE reports a HARQ-ACK information bit value within the HARQ-ACK codebook as NACK in a slot not indicated by a PDSCH-to-HARQ_feedback timing indicator field within DCI format 1_0 or DCI format 1_1. If the UE reports only HARQ-ACK information on one SPS PDSCH release or one PDSCH in MA,c cases for receiving candidate PDSCHs, and the report is scheduled by DCI format 1_0 including information in which a counter DACI field indicates 1 in Pcell, the UE determines a single HARQ-ACK codebook for the corresponding SPS PDSCH release or the corresponding PDSCH reception.

Other cases follow a HARQ-ACK codebook determination method according to the following method.

If a set of PDSCH reception candidate cases in serving cell c is MA,c, MA,c may be acquired through [pseudo-code 1] stages as follows.

```
  [pseudo-code 1 start]
  - Stage 1: Initialize j to 0, and MA,c to an empty set. Initialize a HARQ-ACK
transmission timing index, k, to 0.
  - Stage 2: Configure R as a set of the respective rows in a table that includes
slot information in which a PDSCH is mapped, start symbol information, and information
including the symbol count or length. If a PDSCH-capable mapping symbol indicated by each
value of R is configured as a UL symbol according to DL and UL configuration configured in a
higher layer, delete a corresponding row from R.
  - Stage 3-1: If the UE may receive a single unicast PDSCH in a single slot
and R is not an empty set, add one to the set MA,c.
  - Stage 3-2: If the UE may receive more than one unicast PDSCH in a single
slot, count the number of PDSCHs that may be allocated to different symbols in the calculated R
and add the counted number to MA,c.
  - Stage 4: Increase k by 1 and start again from stage 2.
  [pseudo-code 1 End]
```

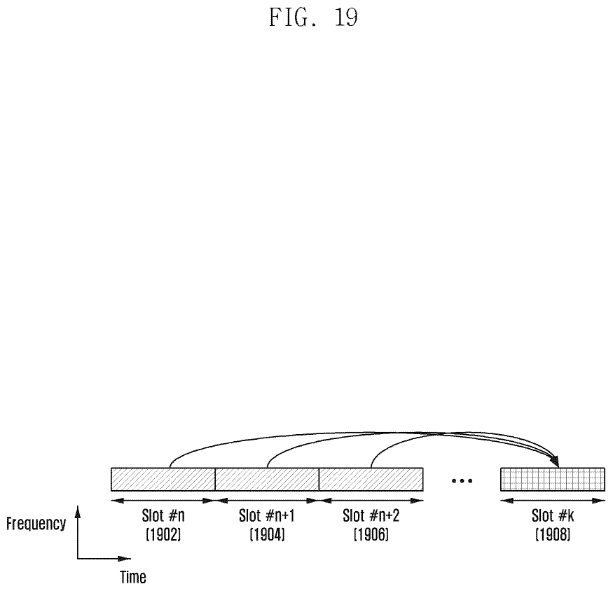

The above-described pseudo-code 1 is described with reference to FIG. 19 as an example.

FIG. 19 illustrates a process for a UE to generate a Type-1 (semi-static) HARQ-ACK codebook according to an embodiment of the disclosure.

With reference to FIG. 19, to perform HARQ-ACK PUCCH transmission in slot #k 1908, all slot candidates enabling PDSCH-to-HARQ-ACK timing that may indicate slot #k 1908 are considered. With reference to FIG. 19, it is assumed that HARQ-ACK transmission is possible in slot #k 1908 only for PDSCHs scheduled in slot #n 1902, slot #n+1 1904, and slot #n+2 1906 by possible PDSCH-to-HARQ-ACK timing combinations. The UE derives the maximum number of schedulable PDSCHs for each slot in consideration of time domain resource configuration information of PDSCHs schedulable in each of the slots 1902, 1904, and 1906 and information indicating whether a symbol within a slot is uplink or downlink. For example, when the maximum two PDSCHs are schedulable in the slot 1902, the maximum three PDSCHs are schedulable in the slot 1904, and the maximum two PDSCHs are schedulable in the slot 1906, the maximum number of PDSCHs included in the HARQ-ACK codebook transmitted in the slot 1908 is seven. This is called cardinality of the HARQ-ACK codebook.

Within a specific slot, the above stage 3-2 is described through [Table 44](Default PDSCH time domain resource allocation A for normal CP) below.

TABLE 44

| Row | dmrs-TypeA- | PDSCH | | | | | |
|---|---|---|---|---|---|---|---|
| index | Position | mapping type | K₀ | S | | Ending | Order |
| | 2 | Type A | 0 | 2 | 2 | 13 | 1x |
| | 3 | Type A | 0 | 3 | 1 | 13 | 1x |
| | 2 | Type A | 0 | 2 | 0 | 11 | 1x |
| | 3 | Type A | 0 | 3 | | 11 | 1x |
| | 2 | Type A | 0 | 2 | | 10 | 1x |
| | 3 | Type A | 0 | 3 | | 10 | 1x |
| | 2 | Type A | 0 | 2 | | 8 | 1x |
| | 3 | Type A | 0 | 3 | | 8 | 1x |
| | 2 | Type A | 0 | 2 | | 6 | 1x |
| | 3 | Type A | 0 | 3 | | 6 | 1x |
| | 2 | Type B | 0 | 9 | | 12 | 2x |
| | 3 | Type B | 0 | 10 | | 13 | 3 |
| | 2 | Type B | 0 | 4 | | 7 | 1x |
| | 3 | Type B | 0 | 6 | | 9 | 2 |
| | 2, 3 | Type B | 0 | 5 | | 11 | 1x |
| | 2, 3 | Type B | 0 | 5 | | 6 | 1x |
| 0 | 2, 3 | Type B | 0 | 9 | | 10 | 2x |
| 1 | 2, 3 | Type B | 0 | 12 | | 13 | 3x |
| 2 | 2, 3 | Type A | 0 | 1 | 3 | 13 | 1x |
| 3 | 2, 3 | Type A | 0 | 1 | | 6 | 1x |
| 4 | 2, 3 | Type A | 0 | 2 | | 5 | 1 |
| 5 | 2, 3 | Type B | 0 | 4 | | 10 | 1x |
| 6 | 2, 3 | Type B | 0 | 8 | | 11 | 2x |

Table 44 refers to a time resource allocation table in which the UE operates by default before the UE receives time resource allocation through a separate RRC signal. For reference, in addition to separately indicating a row index value through RRC, a PDSCH time resource allocation value is determined by the UE's common RRC signal, dmrs-TypeA-Position. In Table 44 above, the columns, ending and order, are values added separately for convenience of description and may not be actually present. The ending column refers to an ending symbol of the scheduled PDSCH, and the order column refers to a code location value located within a specific codebook in the semi-static HARQ-ACK codebook. The corresponding table is applied to time resource allocation applied in DCI format 1_0 of a common search area of the PDCCH.

To determine the HARQ-ACK codebook by calculating the maximum number of non-overlapping PDSCHs within the specific slot, the UE performs the following stages.
Stage 1: Search for a PDSCH allocation value that ends earliest within a slot among rows in the PDSCH time resource allocation table. Table 44 shows that row index 14 ends earliest, which is marked as 1 in the order column. Other row indexes that overlap at least one symbol with the corresponding row index 14 are marked as 1× in the order column.
Stage 2: Search for a PDSCH allocation value that ends earliest among remaining row indexes not indicated in the order column. In Table 44, this corresponds to a row with the row index of 7 and the dmrs-TypeA-Position value of 3. Other row indexes that overlap at least one symbol with this row index are marked as 2× in the order column.
Stage 3: Repeat stage 2 and display the order value by increasing the same. For example, in Table 44, search for the PDSCH allocation value that ends earliest among row indexes not displayed in the order column. In Table 44, this corresponds to a row with the row index of 6 and the dmrs-TypeA-Position value of 3. Other row indexes that overlap at least one symbol with the corresponding row index are marked as 3× in the order column.
Stage 4: When the order is indicated in all row indexes, the process is terminated. The size of order is the maximum number of PDSCHs that may be scheduled without time overlap within the corresponding slot. Scheduling without time overlap indicates that different PDSCHs are scheduled using TDM.

In the order column of Table 44, the maximum value of order indicates the HARQ-ACK codebook size of the corresponding slot, and the order value indicates a HARQ-ACK codebook point at which a HARQ-ACK feedback bit for the corresponding scheduled PDSCH is located. For example, row index 16 in Table 44 indicates that it is present in a second code location in the semi-static HARQ-ACK codebook with the size of 3. If a set of positions for candidate PDSCH receptions in serving cell c is MA,c, the UE that transmits HARQ-ACK feedback may acquire MA,c through stages [pseudo-code 1] or [pseudo-code 2]. MA,c may be used to determine the number of HARQ-ACK bits that the UE needs to transmit. Specifically, the HARQ-ACK codebook may be constructed using the size (cardinality) of the MA,c set.

As another example, considerations for determining the semi-static HARQ-ACK codebook (or type 1 HARQ-ACK codebook) may be as follows:
a) on a set of slot timing values K₁ associated with the active UL BWP
   a) If the UE is configured to monitor PDCCH for DCI format 1_0 and is not configured to monitor PDCCH for DCI format 1_1 on serving cell c, K₁ is provided by the slot timing values {1, 2, 3, 4, 5, 6, 7, 8} for DCI format 1_0
   b) If the UE is configured to monitor PDCCH for DCI format 1_1 for serving cell c, K₁ is provided by dl-DataToUL-ACK for DCI format 1_1
b) on a set of row indexes R of a table that is provided either by a first set of row indexes of a table that is provided by PDSCH-TimeDomainResourceAllocationList in PDSCH-ConfigCommon or by Default PDSCH time domain resource allocation A [6, TS 38.214], or by the union of the first set of row indexes and a second set of row indexes, if provided by PDSCH-TimeDomainResourceAllocationList in PDSCH-Config, associated with the active DL BWP and defining respective sets of slot offsets K₀, start and length indicators SLIV, and PDSCH mapping types for PDSCH reception as described in [6, TS 38.214]
c) on the ratio 2^{μ}^{_{DL}}^{-μ}^{_{UL}} between the downlink SCS configuration μ_{DL} and the uplink SCS configuration μ_{UL} provided by subcarrierSpacing in BWP-Downlink and BWP-Uplink for the active DL BWP and the active UL BWP, respectively
d) if provided, on TDD-UL-DL-ConfigurationCommon and TDD-UL-DL-ConfigDedicated as described in Subclause 11.1.

As another example, the pseudo-code for determining the HARQ-ACK codebook may be as follows.

```
[pseudo-code 2 start]
For the set of slot timing values K₁, the UE determines a set of M_{A,c} positions for candidate
PDSCH receptions or SPS PDSCH releases according to the following pseudo-code. A location
in the Type-1 HARQ-ACK codebook for HARQ-ACK information corresponding to a SPS
PDSCH release is same as for a corresponding SPS PDSCH reception.
Set j = O - index of position for candidate PDSCH reception or SPS PDSCH release
Set B = Ø
Set M_{A,c} = Ø
Set c(K₁) to the cardinality of set K₁
Set k = 0 - index of slot timing values K_{1,k} in descending order of the slot timing values,
in set K₁ for serving cell c
while k < c(K₁)
      if mod(n_{U}-K₁ₖ + 1, max(2^{μ}^{_{UL}}^{-μ}^{_{DL}},1)) = 0
  Set n_{D} = 0 - index of a DL slot within an UL slot
  while n_{D} <max(2^{μ}^{_{DL}}^{-μ}^{_{UL}},1)
    Set R to the set of rows
    Set c(R) to the cardinality of R
    Set r = 0 - index of row in set R
    if slot n_{U} starts at a same time as or after a slot for an active DL BWP change
on serving cell c or an active UL BWP change on the PCell and slot
└(n_{U}-K₁ₖ)*2^{μ}^{_{DL}}^{-μ}^{_{UL}}┘ + n_{D} is before the slot for the active DL BWP change on serving cell c
or the active UL BWP change on the PCell
      continue;
    else
      while r < c(R)
        if the UE is provided TDD-UL-DL-ConfigurationCommon or
$TDD ‐ UL ‐ DL ‐ ConfigDedicated and ,$ $for each slot from slot ⌊ {( {n}_{U} ‐ {K}_{1 , k} )}^{*} {2}^{{µ}_{DL} - {µ}_{UL}} ⌋ + {n}_{D} - {N}_{PDSCH}^{repeat} + 1 to slot ⌊ {( {n}_{U} - {K}_{1 , k} )}^{*} {2}^{{µ}_{DL} - {µ}_{UL}} ⌋ +$ ${n}_{D} , at least one symbol of the PDSCH time resource derived by row$
r is configured as UL where K_{1,k} is the k-th slot timing value in set K₁
          R = R/r;
        end if
        r = r + 1;
      end while
      if the UE does not indicate a capability to receive more than one unicast
PDSCH per slot and R ≠ Ø,
        M_{A,c} = M_{A,c} ∪j;
        j = j + 1;
        The UE does not expect to receive SPS PDSCH release and
unicast PDSCH in a same slot;
    else
        Set c(R) to the cardinality of R
        Set m to the smallest last OFDM symbol index, as determined
by the SLIV, among all rows of R
        while R ≠ Ø
          Set r = 0
        while r < c(R)
          if S ≤ m for start OFDM symbol index S for row r
            b_{r,k,n}_{_{D}} = j; - index of position for candidate
PDSCH reception or SPS PDSCH release associated with row r
            R = R/r;
            B = B∪b_{r,k,n}_{_{D}};
            end if
          r = r + 1;
          end while
          M_{A,c} = M_{A,c} ∪j
          j = j + 1;
          Set m to the smallest last OFDM symbol index among
all rows of R;
          end while
        end if
      end if
      n_{D} = n_{D} + 1;
    end while
  end if
  k = k + 1;
end while
[pseudo-code 2 end]
```

A location of the HARQ-ACK codebook containing HARQ-ACK information on DCI indicating DL SPS release in pseudo-code 2 is based on a location at which a DL SPS PDSCH is received. For example, when a start symbol for transmitting the DL SPS PDSCH starts from a fourth OFDM symbol based on a slot and has the length of 5, HARQ-ACK information including DL SPS release that indicates release of the corresponding SPS assumes as if the PDSCH, which is a symbol starting from a fourth OFDM symbol of a slot in which the DL SPS release is transmitted and having the length of 5, is mapped, and HARQ-ACK information corresponding thereto is determined through a PDSCH-to-HARQ-ACK timing indicator and a PUSCH resource indicator included in control information that indicates the DL SPS release. As another example, when the start symbol for transmitting the DL SPS PDSCH starts from the fourth OFDM symbol based on the slot and has the length of 5, HARQ-ACK information including DL SPS release that indicates release of the corresponding SPS assumes as if the PDSCH, which is a symbol starting from a fourth OFDM symbol of a slot indicated by time domain resource allocation (TDRA) of DCI, DL SPS release, and having the length of 5, is mapped, and HARQ-ACK information corresponding thereto is determined through a PDSCH-to-HARQ-ACK timing indicator and a PUSCH resource indicator included in control information that indicates DL SPS release.

### [HARQ-ACK: Related to Type 2 (Dynamic) Codebook]

The UE transmits HARQ-ACK information transmitted within a single PUCCH in slot n based on a PDSCH-to-HARQ_feedback timing value for PUCCH transmission of HARQ-ACK information in slot n for PDSCH reception or SPS PDSCH release and K0, which is transmission slot location information of the PDSCH scheduled in DCI format 1_0 or 1_1. Specifically, for the above-described HARQ-ACK information transmission, the UE determines the HARQ-ACK codebook of the PUCCH transmitted in the slot determined by PDSCH-to-HARQ_feedback timing and K0, based on DAI included in DCI that indicates the PDSCH or SPS PDSCH release.

The DAI includes counter DAI and total DAI. The counter DAI is information that indicates a location of HARQ-ACK information corresponding to the PDSCH scheduled in DCI format 1_0 or DCI format 1_1 within the HARQ-ACK codebook. Specifically, a value of the counter DAI within DCI format 1_0 or 1_1 indicates an accumulated value of PDSCH reception or SPS PDSCH release scheduled by DCI format 1_0 or DCI format 1_1 in specific cell c. The above-described accumulated value is configured based on a PDCCH monitoring position and a serving cell in which the scheduled DCI is present.

The total DAI is a value that indicates the HARQ-ACK codebook size. Specifically, a value of the total DAI indicates the total number of previously scheduled PDSCHs or SPS PDSCH releases, including a point in time at which DCI is scheduled. The total DAI is a parameter used when HARQ-ACK information in serving cell c also includes HARQ-ACK information on PDSCHs scheduled in other cells including serving cell c in a carrier aggregation (CA) situation. That is, there is no total DAI parameter in a system that operates with a single cell.

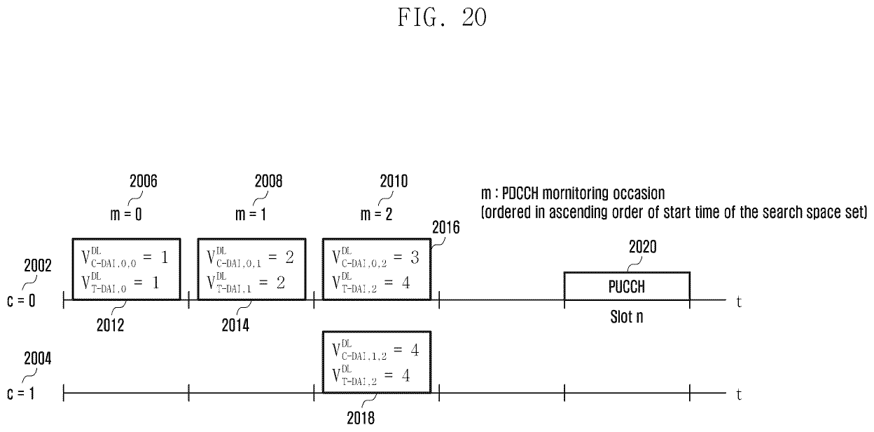

An example of operation of the above DAI is described with reference to FIG. 20.

FIG. 20 illustrates a process for a UE to generate a Type-2 (dynamic) HARQ-ACK codebook according to an embodiment of the disclosure.

With reference to FIG. 20, when the UE transmits a HARQ-ACK codebook selected based on DAI in an nth slot of carrier 0 2002 through a PUCCH 2020 in a situation in which two carriers are configured, it shows the change in values of counter DAI (C-DAI) and total DAI (T-DAI) indicated by DCI searched for each PDCCH monitoring position configured for each carrier. Initially, DCI searched at m=0 (2006) indicates that C-DAI and T-DAI each has a value of 1 (2012). DCI searched at m=1 (2008) indicates that C-DAI and T-DAI each has a value of 2 (2014). DCI searched at carrier 0 (c=0, 2002) of m=2 (2010) indicates that C-DAI has a value of 3 (2016). DCI searched at carrier 1 (c=1, 2004) of m=2 (2010) indicates that C-DAI has a value of 4 (2018). Here, when carriers 0 and 1 are scheduled in the same monitoring position, both indicate that T-DAI has a value of 4.

In FIG. 19 and FIG. 20, HARQ-ACK codebook determination operates in a situation in which only one PUCCH containing HARQ-ACK information is transmitted within a single slot. This is called mode 1. As an example of a method in which a single PUCCH transmission resource is determined within a single slot, when PDSCHs scheduled in different DCI are multiplexed to a single HARQ-ACK codebook and transmitted, the PUCCH resource selected for HARQ-ACK transmission is determined as the PUCCH resource indicated by the PUCCH resource field indicated by DCI that scheduled the PDSCH last. That is, PUCCH resources indicated by the PUCCH resource field indicated by DCI scheduled prior to the above DCI are ignored.

The following description defines HARQ-ACK codebook determination method and devices in a situation in which two or more PUCCHs containing HARQ-ACK information may be transmitted within a single slot. This is called mode 2. The UE may operate only in mode 1 (in which only one HARQ-ACK PUCCH is transmitted within one single slot) or may operate only in mode 2 (in which one or more HARQ-ACK PUCCHs are transmitted within one slot). Alternatively, the UE that supports both mode 1 and mode 2 may be configured by the base station to operate only in one mode through higher signaling, or mode 1 and mode 2 may be implicitly determined by a DCI format, RNTI, a DCI specific field value, and scrambling. For example, PDSCHs scheduled by DCI format A and HARQ-ACK information associated therewith are based on mode 1, and PDSCHs scheduled by DCI format B and HARQ-ACK information associated therewith are based on mode 2. Whether the above-described HARQ-ACK codebook is semi-static or dynamic is determined by an RRC signal.

### [Related to Satellite Communication Structure]

Characteristics of satellite communication are described below. Satellites for communication may be categorized into low Earth orbit (LEO), middle Earth orbit (MEO), and geostationary Earth orbit (GEO) depending on their orbit. In general, GEO may refer to a satellite with the altitude of about 36000 km, MEO may refer to a satellite with the altitude of 5000 to 15000 km, and LEO may refer to a satellite with the altitude of 500 to 1000 km. Of course, it is not limited to the above examples. According to an embodiment of the disclosure, the Earth's orbital period varies depending on each altitude. For GEO, the Earth's orbital period is about 24 hours. For MEO, the Earth's orbital period is about 6 hours. For LEO, the Earth's orbital period is about 90 to 120 minutes. Low Earth orbit (˜2,000 km) satellites have relatively low altitude and accordingly, may have an advantage in propagation delay (which may be understood as an amount of time used for a signal transmitted from a transmitter to reach a receiver) and loss compared to geostationary Earth orbit (36,000 km) satellites.

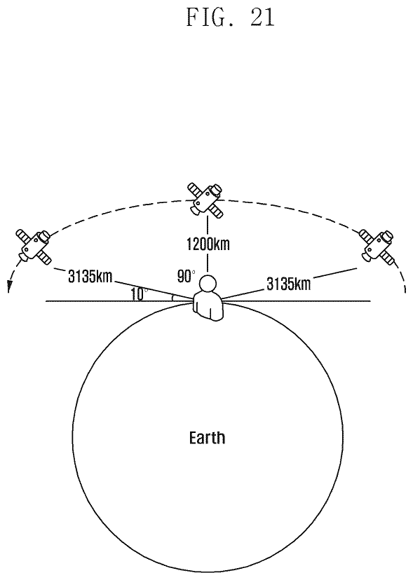

FIG. 21 illustrates the Earth orbital period of a communication satellite according to the altitude or height of a satellite according to an embodiment of the disclosure.

When it is assumed that the UE communicates with a satellite preset at the altitude of 1200 km, a distance between the UE and the satellite may vary depending on the elevation angle between the satellite and the UE. For example, if the elevation angle between the satellite and the UE is 90 degrees, the distance between the UE and the satellite is 1200 km. However, if the elevation angle between the satellite and the UE is 10 degrees, the distance between the UE and the satellite is about 3135 km. Therefore, in satellite communication, although the UE is fixed, the distance between the UE and the satellite may vary due to the periodic orbit of the satellite, such as a low-orbit satellite. Also, since the distance between the UE and the satellite is much longer than the distance between the UE and the base station in a terrestrial network, satellite communication may need to transmit control information and data information by performing data transmission with a low code rate or performing repetition transmission.

### [Related to PDCCH Repetition]

Hereinafter, PDCCH repetition transmission is described. The PDCCH repetition transmission may improve transmission reliability or may increase downlink coverage by repeating the same DCI through a plurality of PDCCH resources.

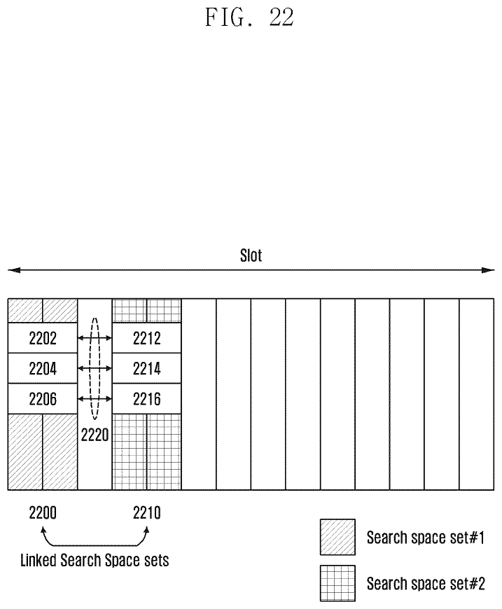

FIG. 22 illustrates PDCCH repetition transmission according to an embodiment of the disclosure.

2200 and 2210 denote a first search duration of a first search space set (search space set #1) and a first search duration of a second search space set (Search space set #2), respectively. Reference numerals 2202, 2204, and 2206 each represents a PDCCH candidate search resource within the first search duration 2200 of the first search space set. Reference numerals 2212, 2214, and 2216 each represents a PDCCH candidate search resource within the first search duration 2210 of the second search space set. The UE may receive the same search space link value for 2200 and 2210 from the base station in advance for PDCCH repetition transmission. Through this, the UE may determine that a specific PDCCH candidate transmitted in the first search duration 2200 of the first search space set and a specific PDCCH candidate transmitted in the first search duration 2210 of the second search space set are transmitted including the same DCI. For example, the UE may determine that 2202 and 2212 are repeatedly transmitted, each including the same DCI. Similarly, the UE may determine that 2204 and 2214 are repeatedly transmitted, each including the same DCI. Similarly, the UE may determine that 2206 and 2216 are repeatedly transmitted, each including the same DCI. They may be referred to as interconnected PDCCH candidate pairs 2220. When constructing the PDCCH candidate pair 2220, at least one of the following needs to be satisfied such that the UE may receive the same DCI from a plurality of PDCCH candidates.
One of conditions may be that each of search spaces is restricted to the same searchspacinglinkID. For example, it may be applied when 2200 and 2210 are configured using the same searchspacinglinkID value.
One of conditions may be that each of the search spaces is restricted to the same search space type (e.g., USS or CSS). For example, both 2200 and 2210 need to be either a USS or a CSS.
One of conditions may be that each of the search spaces is restricted to including the same DCI formats. For example, both 2200 and 2210 need to be configured such that DCI format 1_1 is searched.
One of conditions may be to restrict each of the search spaces to a case of having the same transmission periodicity, offset, and transmission selection length within a slot. For example, 2200 and 2210 need to have the transmission periodicity of 1 ms, the offset of 0, and the transmission section length within the slot that starts from a first symbol of each slot, and also needs to have the CORESET length of 3 symbols.
One of conditions may be to restrict each of the search spaces to a case of having the same number of candidates for each aggregation level (AL). For example, 2200 and 2210 need to have two candidates for AL 8.
Each of the search spaces needs to have the same number of monitoring positions. For example, both 2200 and 2210 need to have the same monitoring position value (or index).

When the above conditions are satisfied, the UE may search for each of PDCCH candidates within two search spaces connected to search for a single DCI format having the same information. Here, the PDCCH candidates may have characteristics of the same AL, the same PDCCH candidate, and the same DCI formats. In summary, the PDCCH repetition uses two search spaces explicitly connected by higher signal configuration provided from an RRC layer and is associated with a corresponding CORESET. Two linked search spaces having the same number of candidates are constructed for the PDCCH repetition, and two PDCCH candidates of the two search spaces may be connected to the same candidate index. When the PDCCH repetition is scheduled to the UE, repetition within the same slot is allowed and each repetition has the same number of CCEs and coded bits and may correspond to the same DCI payload.

### [Related to Type 0 PDCCH CSS]

Hereinafter, a Type 0 PDCCH CSS is described. The Type 0 PDCCH CSS is a PDCCH resource area that the UE first searches after receiving an SS/PBCH block. The corresponding resource area may allow SIB information to be scheduled through PDSCHs. If the UE determines that a CORESET for a Type0-PDCCH CSS set is present from a MIB during cell search, the UE determines the number of consecutive resource blocks and the number of consecutive symbols of a control resource set zero (controlResourceSetZero) and, through this, determines a PDCCH monitoring time point. The information is described as an example in [Table 45] and [Table 46]. Each of a system frame number (SFN) and a slot index is based on an SCS of CORESET, which represents time overlap of the SS/PBCH block. This symbol has a normal cyclic prefix for CORESET associated with pdcch-ConfigSIB1 within the MIB or searchSpaceSIB1 within ConfigCommon. Offsets of [Table 45] are defined based on the SCS of the CORESET for the Type0-PDCCH CSS set, starting from the smallest RB index to the smallest RB index of a common RB that overlaps the first RB of the SS/PBCH block.

In a situation in which the SS/PBCH block and the CORESET are time division multiplexed, the UE monitors the Type0-PDCCH CSS set in two consecutive slots, starting from slot n0. When the index of the SS/PBCH block is i, the UE determines the index of slot n0 in which the Type0-PDCCH CSS is transmitted through

$$n 0 = ( O \cdot {2}^{μ} + ⌊ i \cdot M ⌋ ) mod {N}_{slot}^{f r a m e , μ} . \qquad ( Equation 10 )$$

Here, the Type0-PDCCH CSS transmitted in an odd or even SFN is determined depending on whether a value of

$$⌊ \frac{O \cdot {2}^{μ} + ⌊ i \cdot M ⌋}{{N}_{s l o t}^{f r ame , μ}} ⌋ mod 2 \qquad ( Equation 11 )$$

is 1 or 0. Values of O and M are provide in [Table 46].

TABLE 45
Set of resource blocks and slot symbols of CORESET for
Type0-PDCCH search space set when {SS/PBCH block,
PDCCH} SCS is {15, 15} kHz for frequency
bands with minimum channel bandwidth 5 MHz or 10 MHz

| | SS/PBCH block and | Number | Number of | |
|---|---|---|---|---|
| Index | CORESET multi- plexing pattern | of RBs ${N}_{RB}^{CORESET}$ | Symbols ${N}_{symb}^{CORESET}$ | Offset (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 48 | 1 | 12 |
| 7 | 1 | 48 | 1 | 16 |
| 8 | 1 | 48 | 2 | 12 |
| 9 | 1 | 48 | 2 | 16 |
| 10 | 1 | 48 | 3 | 12 |
| 11 | 1 | 48 | 3 | 16 |
| 12 | 1 | 96 | 1 | 38 |
| 13 | 1 | 96 | 2 | 38 |
| 14 | 1 | 96 | 3 | 38 |

| | |
|---|---|
| 15 | Reserved |

TABLE 46
Parameters for PDCCH monitoring positions for Type0-PDCCH CSS
set - SS/PBCH block and CORESET multiplexing pattern 1 and FR1

| | | Number of search | | |
|---|---|---|---|---|
| Index | O | space sets per slot | M | First symbol index |
| 0 | 0 | 1 | 1 | 0 |
| 1 | 0 | 2 | 1/2 | $\{ 0 , if i is even \} , \{ {N}_{symb}^{CORESET} , if i is odd \}$ |
| 2 | 2 | 1 | 1 | 0 |
| 3 | 2 | 2 | 1/2 | $\{ 0 , if i is even \} , \{ {N}_{symb}^{CORESET} , if i is odd \}$ |
| 4 | 5 | 1 | 1 | 0 |
| 5 | 5 | 2 | 1/2 | $\{ 0 , if i is even \} , \{ {N}_{symb}^{CORESET} , if i is odd \}$ |
| 6 | 7 | 1 | 1 | 0 |
| 7 | 7 | 2 | 1/2 | $\{ 0 , if i is even \} , \{ {N}_{symb}^{CORESET} , if i is odd \}$ |
| 8 | 0 | 1 | 2 | 0 |
| 9 | 5 | 1 | 2 | 0 |
| 10 | 0 | 1 | 1 | 1 |
| 11 | 0 | 1 | 1 | 2 |
| 12 | 2 | 1 | 1 | 1 |
| 13 | 2 | 1 | 1 | 2 |
| 14 | 5 | 1 | 1 | 1 |
| 15 | 5 | 1 | 1 | 2 |

For example, when pdcch-ConfigSIB1 in the MIB indicates each of indexes of [Table 45] and [Table 46] as 0, slot indexes of the Type 0 PDCCH CSS searched by the UE may vary depending on the SS/PBCH block index searched by the UE according to Equations 10 and 11 above. When SS/PBCH block index 1 is searched by the UE, the Type 0 PDCCH CSS may be configured in first two symbols of slot indexes 1 and 2, when SS/PBCH block index 2 is searched by the UE, the Type 0 PDCCH CSS may be configured in first two symbols of slot indexes 2 and 3, when SS/PBCH block index 3 is searched by the UE, the Type 0 PDCCH CSS may be configured in first two symbols of slot indexes 3 and 4, and when SS/PBCH block index 4 is searched by the UE, the Type 0 PDCCH CSS may be configured in first two symbols of slot indexes 4 and 5.

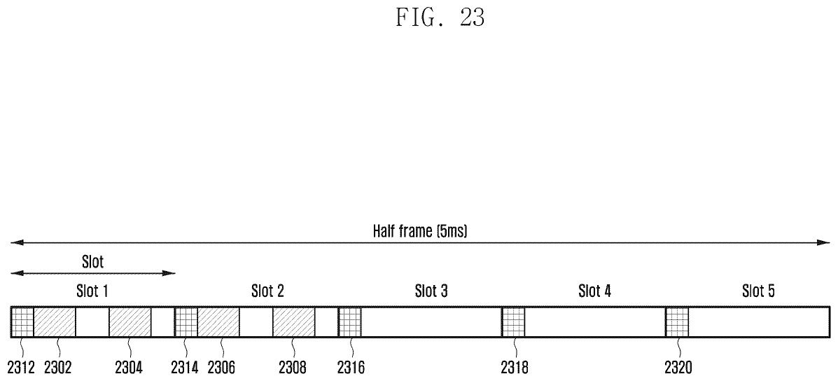

FIG. 23 illustrates Type 0 PDCCH CSS resources in a situation in which a total of four SS/PBCH blocks that may be transmitted and received according to an embodiment of the disclosure.

Reference numerals 2302, 2304, 2306, and 2308 represent SS/PBCH block indexes 1, 2, 3, and 4, respectively. Reference numerals 2312, 2314, 2316, 2318, and 2320 represent the Type 0 PDCCH CSSs transmitted and received in slots 1, 2, 3, 4, and 5, respectively. If the UE searches the SS/PBCH block 2302 and pdcch-ConfigSIB1 of the corresponding MIB indicates indexes of [Table 45] and [Table 46] as 0, the UE may search for the PDCCHs 2312 and 2314 of slots 1 and 2. If the UE searches the SS/PBCH block 2304 and pdcch-ConfigSIB1 of the corresponding MIB indicates indexes of [Table 45] and [Table 46] as 0, the UE may search for the PDCCHs 2314 and 2316 of slots 2 and 3. If the UE searches the SS/PBCH block 2306 and pdcch-ConfigSIB1 of the corresponding MIB indicates indexes of [Table 45] and [Table 46] as 0, the UE may search for the PDCCHs 2316 and 2318 of slots 3 and 4. If the UE searches the SS/PBCH block 2308 and pdcch-ConfigSIB1 of the corresponding MIB indicates indexes of [Table 45] and [Table 46] as 0, the UE may search for the PDCCHs 2318 and 2320 of slots 4 and 5.

### Introduction to Embodiment

In satellite communication, a single satellite basically covers a wide area and is responsible for uplink and downlink transmission and reception. Therefore, the satellite basically operates hundreds to thousands of spot beams and serves UEs belonging to each spot beam. However, from the downlink perspective view, when performing simultaneous downlink transmission using hundreds to thousands of spot beams, downlink transmission power allocated to a specific spot beam is bound to be reduced compared to the transmission power when performing downlink transmission using a single spot beam. Therefore, in such a situation, the reduced downlink transmission power leads to reducing downlink coverage, so technologies for increasing the downlink coverage are required. The following embodiments describe the technologies for enhancing the downlink coverage. Specifically, repetition transmission technology for PDCCH resources searched during initial access of the UE is described.

### First Embodiment

Hereinafter, the embodiment describes a method of determining whether repetition transmission is supported for PDCCHs monitored after an SS/PBCH. The PDCCH may indicate a Type0 PDCCH CSS, may indicate a Type0A PDCCH CSS, may indicate a Type1 PDCCH CSS, may indicate a Type2 PDCCH CSS, may indicate a Type3 PDCCH CSS, or may indicate a PDCCH USS. In this situation, the UE may determine that DCI including the same information is repeatedly transmitted through a plurality of PDCCH resources using one of the following methods.
Method 1-1: An indication method through a specific bit of an MIB. MIB fields may be constructed as shown in [Table 47] below. Among the MIB fields constructed as shown in [Table 47], 1 bit allocated as a spare may indicate whether the PDCCH repetition transmission is supported. For example, if the corresponding bit field is 0, the PDCCH repetition transmission may not be supported, and if the corresponding bit field is 1, the PDCCH repetition transmission may be supported. Alternatively, the opposite case may also be possible. The corresponding feature may be applied only to frequencies that use the satellite communication (or NTN). That is, the corresponding bit may be fixed as spare for frequencies used in a terrestrial network.

TABLE 47

| | |
|---|---|
| MIB ::= | SEQUENCE { |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| spare | BIT STRING (SIZE (1)) |

}

```
MIB field descriptions
  cellBarred
  Value barred means that the cell is barred, as defined in TS 38.304 [20]. This field is
ignored by IAB-MT.
  dmrs-TypeA-Position
  Position of (first) DM-RS for downlink (see TS 38.211 [16], clause 7.4.1.1.2) and
uplink (see TS 38.211 [16], clause 6.4.1.1.3).
  intraFreqReselection
  Controls cell selection/reselection to intra-frequency cells when the highest ranked
cell is barred, or treated as barred by the UE, as specified in TS 38.304 [20]. This field is
ignored by IAB-MT.
  pdcch-ConfigSIB1
  Determines a common ControlResourceSet (CORESET), a common search space and
necessary PDCCH parameters. If the field ssb-SubcarrierOffset indicates that SIB1 is absent,
the field pdcch-ConfigSIB1 indicates the frequency positions where the UE may find
SS/PBCH block with SIB1 or the frequency range where the network does not provide
SS/PBCH block with SIB1 (see TS 38.213 [13], clause 13).
  ssb-SubcarrierOffset
  Corresponds to k_{SSB} (see TS 38.213 [13]), which is the frequency domain offset
between SSB and the overall resource block grid in number of subcarriers. (See TS 38.211
[16], clause 7.4.3.1). For operation with shared spectrum channel access (see 37.213 [48]),
this field corresponds to k̅_{SSB}, and k_{SSB} is obtained from k̅_{SSB} (see TS 38.211 [16], clause
7.4.3.1); the LSB of this field is used also for deriving the QCL relation between SS/PBCH
blocks as specified in TS 38.213 [13], clause 4.1.
  The value range of this field may be extended by an additional most significant bit
encoded within PBCH as specified in TS 38.213 [13].
  This field may indicate that this cell does not provide SIB1 and that there is hence no
CORESET#0 configured in MIB (see TS 38.213 [13], clause 13). In this case, the field
pdcch-ConfigSIB1 may indicate the frequency positions where the UE may (not) find a
SS/PBCH with a control resource set and search space for SIB1 (see TS 38.213 [13], clause
13).
  subCarrierSpacingCommon
  Subcarrier spacing for SIB1, Msg.2/4 for initial access, paging and broadcast SI-
messages. If the UE acquires this MIB on an FR1 carrier frequency, the value scs15or60
corresponds to 15 kHz and the value scs30or120 corresponds to 30 kHz. If the UE acquires
this MIB on an FR2 carrier frequency, the value scs15or60 corresponds to 60 kHz and the
value scs30or120 corresponds to 120 kHz. For operation with shared spectrum channel
access (see 37.213 [48]), the subcarrier spacing for SIB1 is same as that for the corresponding
SSB and this field instead is used for deriving the QCL relation between SS/PBCH blocks as
specified in TS 38.213 [13], clause 4.1.
  systemFrameNumber
  The 6 most significant bits (MSB) of the 10-bit System Frame Number (SFN). The 4
LSB of the SFN are conveyed in the PBCH transport block as part of channel coding (i.e.,
outside the MIB encoding), as defined in clause 7.1 in TS 38.212 [17].
```

Method 1-2: A method of utilizing some bits in PBCH payload. The MIB is a payload transmitted through a higher signal and may be expressed as a₀, a₁, a₂, . . . , a_{A-1} if the size is A bits. Then, L1 layer generates and combines the payload with the size of 8. This may be expressed as a_{A}, a_{A+1}, a_{A+2}, . . . , a_{A+7}. In this situation, a_{A}, a_{A+1}, a_{A+2}, and a_{A+3} may indicate constructing fourth, third, second, and first LSBs of SFN, respectively. Here, a_{A}+4 may be utilized to indicate a half frame bit, and a_{A+5} may be utilized as a bit that additionally provides an offset value of Kssb. a_{A+6} or a_{A+7} may be a value that includes 1 bit and may indicate whether the PDCCH may be repeatedly transmitted. For example, if a value of a_{A+6} is 1, the UE may determine that the PDCCH repetition transmission is supported, and if the value of a_{A+6} is 0, the UE may determine that the PDCCH repetition transmission is not supported. It is only an example and the opposite case may be possible. If both a_{A+6} and a_{A+7} may be utilized for the PDCCH repetition transmission indication, it may be used to additionally indicate the number of PDCCH repetition transmissions or may be utilized to indicate a PDCCH repetition transmission type. The PDCCH repetition transmission type may be utilized to indicate that PDCCHs subject to repetition transmission are included in a single slot or to indicate that PDCCHs subject to repetition transmission are included in different slots.
Method 1-3: Through the existing MIB, an additional bit indicating whether the PDCCH repetition transmission is supported may be included. [Table 48] below shows the transmission structure of the MIB. Here, the MIB is in a structure in which it is transmitted to the UE including information described in [Table 47], and it may be transmitted by increasing the MIB size compared to the conventional one by adding 1 to a messageClassExtension value. Through the added 1 bit, whether the PDCCH repetition transmission is supported may be indicated. Alternatively, if the value includes 2 bits, it may be utilized to additionally indicate the number of PDCCH repetition transmissions or may be utilized to indicate the PDCCH repetition transmission type. The PDCCH repetition transmission type may be utilized to indicate that PDCCHs subject to repetition transmission are included in a single slot or to indicate that PDCCHs subject to repetition transmission are included in different slots.

TABLE 48

| BCCH-BCH-Message ::= SEQUENCE { | |
|---|---|
| message | BCCH-BCH-MessageType |
| } | |
| BCCH-BCH-MessageType ::= CHOICE { | |
| mib | MIB, |
| messageClassExtension | SEQUENCE { } |

}

Method 1-4: The field constructed as the MIB is utilized for the PDCCH repetition purpose. This method may allow some of MIB fields in [Table 47] to be utilized for the PDCCH repetition purpose. For example, a field indicating subCarrierSpacingCommon may be replaced with a field indicating whether the PDCCH repetition is supported and thereby utilized. As another example, a field indicating dmrs-TypeA-Position may be replaced with the field indicating whether the PDCCH repetition is supported and thereby utilized. As another example, a field indicating cellBarred may be replaced with the field indicating whether the PDCCH repetition is supported and thereby utilized. As another example, a field indicating intraFreqReselection may be replaced with the field indicating whether the PDCCH repetition is supported and thereby utilized.
Method 1-5: The foregoing methods describe methods of providing the UE with information regarding whether the PDCCH repetition is supported using a specific value in a PBCH payload or an MIB bit. Unlike this, the UE may indirectly determine whether the PDCCH repetition is supported through default SSB periodicity. For example, if the default SSB periodicity is 20 ms, the UE may determine that the PDCCH repetition is not supported, and if the default SSB periodicity is 160 ms, the UE may determine that the PDCCH repetition is supported. The above values are examples only and may be replaced with other values. The UE may determine the periodicity at which the base station transmits an SSB and may determine whether the PDCCH repetition is supported based on the corresponding periodicity value.
Method 1-6: With limitation to a specific frequency band, the PDCCH repetition transmission may be supported. For example, for UEs that operate in satellite communication frequency band, such as n256 and n255, in the case of performing initial access in the corresponding frequency band, it may be regarded that PDCCH resources provided in the band may be repeatedly transmitted. The above n256 and n255 are examples only and may be changed to other NTN frequency bands.
Method 1-7: When performing a PSS/SSS search, the UE may determine whether the PDCCH repetition is supported through some fields of cell ID. For example, when the cell ID is constructed as

$${N}_{ID}^{c e l l} = 3 {N}_{ID}^{( 1 )} + {N}_{ID}^{( 2 )} where {N}_{ID}^{( 1 )} ∈ \{ 0 , 1 , … , 335 \} and {N}_{ID}^{( 2 )} ∈ \{ 0 , 1 , 2 \} \qquad ( Equation 12 )$$

and when a value of

$${N}_{ID}^{( 2 )}$$

found by the UE through the PSS/SSS is 2, the UE may determine that the initially connected base station provides PDCCH repetition. Alternatively, it may be indicated through another value of

$${N}_{ID}^{( 2 )} .$$

Alternatively, whether the PDCCH repetition is supported may be indicated through a specific value of

$${N}_{ID}^{( 1 )} .$$

### Second Embodiment

Hereinafter, a method of supporting a PDCCH repetition transmission is described. Specifically, methods for repetition transmission for a Type 0 PDCCH CSS are described. The UE may determine that the PDCCH repetition is supported through each area of DCI including the same information in a plurality of resource areas of the Type 0 PDCCH CSS through at least one of the methods described below or some combinations thereof. At least one of the following methos or some combinations thereof may be applied in a situation in which the UE determines that the PDCCH repetition is applied through at least one of the methods described in first embodiment.
Method 2-1: In addition to a first Type 0 PDCCH CSS, an additional second Type 0 PDCCH CSS is configured to be located immediately after the first Type 0 PDCCH CSS. For example, when a first Type 0 PDCCH CSS resource area associated with a CORESET including two symbols is allocated to first two symbols (symbol index 0 and symbol index 1) within a slot that includes 14 symbols, a second Type 0 PDCCH CSS resource area may be located in two symbols (symbol index 2 and symbol index 3) immediately thereafter.

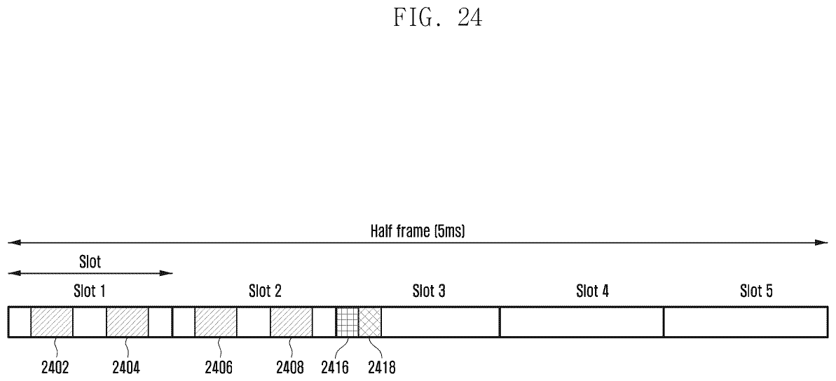

FIG. 24 illustrates PDCCH repetition transmission according to an embodiment of the disclosure.

When searching an SS/PBCH block 2406, the UE may determine that DCI including the same information is transmitted and received through each of a first Type 0 PDCCH CSS 2416 including two symbols and a second Type 0 PDCCH CSS 2418 including two symbols. The DCI may be transmitted and received through the same AL, the same PDCCH candidate index, and the same DCI formats in each of the PDCCHs 2416 and 2418.
Method 2-2: When the second Type 0 PDCCH CSS is configured to be located after the first Type 0 PDCCH CSS in addition to the first Type 0 PDCCH CSS, but an SS/PBCH is allocated, the second Type 0 PDCCH CSS is configured after the SS/PBCH. This method is similar to method 2-1. However, if the SS/PBCH is transmitted immediately after a first Type 0 PDCCH CSS resource, the additional second Type 0 PDCCH CSS may not be configured as in method 2-1, so method 2-2 is a method of configuring and transmitting the additional second type 0 PDCCH CSS after the SS/PBCH. For example, when a first Type 0 PDCCH CSS resource area associated with a CORESET including two symbols is allocated to first two symbols (symbol index 0 and symbol index 2) in a slot that includes 14 symbols, and resources of the SS/PBCH including four symbols are allocated immediately thereafter, a second Type 0 PDCCH CSS resource area is located in two symbols (symbol index 6 and symbol index 7) immediately after the SS/PBCH.

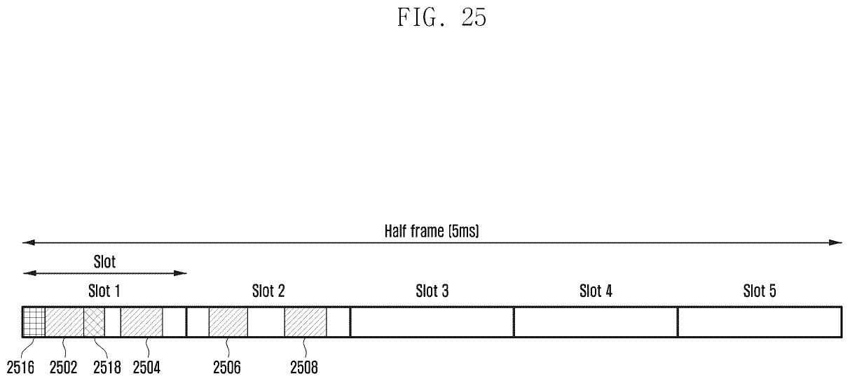

FIG. 25 illustrates PDCCH repetition transmission according to an embodiment of the disclosure.

When the UE searches an SS/PBCH block 2502, the UE may determine that DCI including the same information is transmitted and received through each of a first Type 0 PDCCH CSS 2516 including two symbols and a second Type 0 PDCCH CSS 2518 including two symbols. The DCI may be transmitted and received through the same AL, the same PDCCH candidate index, and the same DCI formats in each of the PDCCHs 2516 and 2518.
Method 2-3: In addition to the first Type 0 PDCCH CSS, the additional second Type 0 PDCCH CSS is configured to be located immediately before the first Type 0 PDCCH CSS. For example, when a first Type 0 PDCCH CSS resource area associated with a CORESET including two symbols is allocated to first two symbols (symbol index 0, symbol index 1) within slot n that includes 14 symbols, a second Type 0 PDCCH CSS resource area is located in last two symbols (symbol index 12 and symbol index 13) of slot n−1.

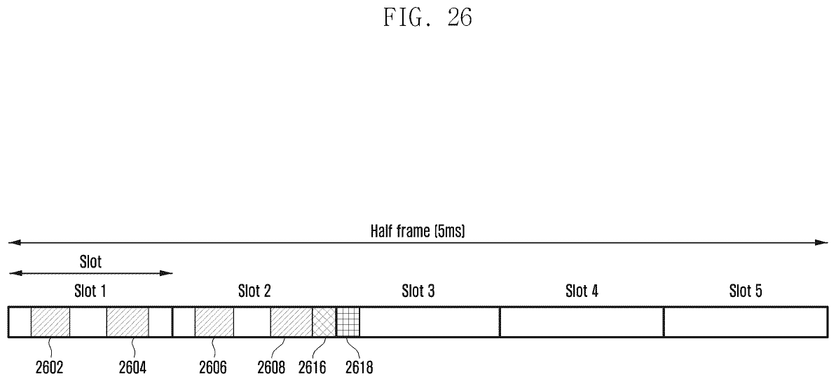

FIG. 26 illustrates PDCCH repetition transmission according to an embodiment of the disclosure.

When the UE searches an SS/PBCH block 2606, the UE may determine that DCI including the same information is transmitted and received through each of a first Type 0 PDCCH CSS 2618 including two symbols and a second Type 0 PDCCH CSS 2616 including two symbols. The DCI may be transmitted and received through the same AL, the same PDCCH candidate index, and the same DCI formats in each of the PDCCHs 2616 and 2618.
Method 2-4: In addition to the first Type 0 PDCCH CSS, the additional second Type 0 PDCCH CSS is configured in a slot immediately following a slot to which the first Type 0 PDCCH CSS is allocated. For example, when the first Type 0 PDCCH CSS resource area associated with a CORESET including two symbols is allocated to first two symbols (symbol index 0 and symbol index 1) within slot n that includes 14 symbols, the second Type 0 PDCCH CSS resource area is located in first two symbols (symbol index 0 and symbol index 1) of next slot n+1.

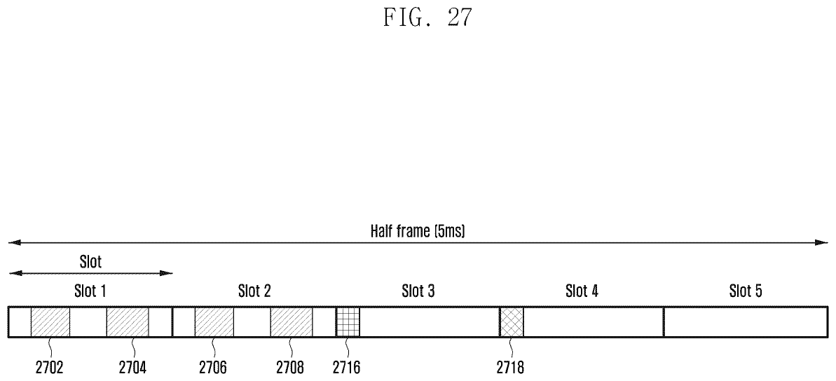

FIG. 27 illustrates PDCCH repetition transmission according to an embodiment of the disclosure.

When the UE searches an SS/PBCH block 2706, the UE may determine that DCI including the same information is transmitted and received through each of a first Type 0 PDCCH CSS 2716 including two symbols and a second Type 0 PDCCH CSS 2718 including two symbols. The DCI may be transmitted and received through the same AL, the same PDCCH candidate index, and the same DCI formats in each of the PDCCHs 2716 and 2718.
Method 2-5: Without the additional second Type 0 PDCCH CSS, the UE may receive PDCCHs including the same DCI through two first Type 0 PDCCH CSS searched through two consecutive slots. For example, when the UE searches for the first Type 0 PDCCH CSS in each of slot n and slot n+1 through specific SS/PBCH block index search, the same DCI may be included in each first Type 0 PDCCH CSS and thereby transmitted.

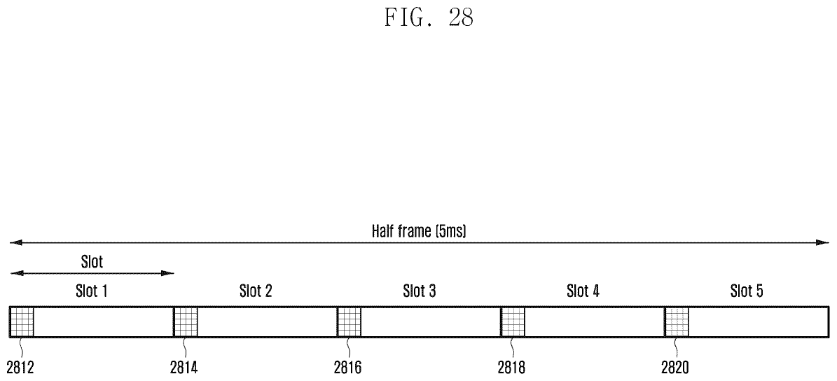

FIG. 28 illustrates PDCCH repetition transmission according to an embodiment of the disclosure.

For example, the UE may identify first Type 0 PDCCH CSS resources allocated to consecutive two slots through the specific SS/PBCH index search and may determine that DCI including the same information is transmitted and received through each of a first Type 0 PDCCH CSS 2812 including two symbols and a first Type 0 PDCCH CSS 2814 including two symbols. The DCI may be transmitted and received through the same AL, the same PDCCH candidate index, and the same DCI formats in each of the PDCCHs 2812 and 2814. As another example, the UE may identify first Type 0 PDCCH CSS resources allocated to consecutive two slots through the specific SS/PBCH index search and may determine that DCI including the same information is transmitted through and received through each of the first Type 0 PDCCH CSS 2814 including two symbols and a first Type 0 PDCCH CSS 2816 including two symbols. The DCI may be transmitted and received through the same AL, the same PDCCH candidate index, and the same DCI formats in each of the PDCCHs 2814 and 2816. As another example, the UE may identify first Type 0 PDCCH CSS resources allocated to consecutive two slots through the specific SS/PBCH index search and may determine that DCI including the same information is transmitted and received through each of the first Type 0 PDCCH CSS 2816 including two symbols and a first Type 0 PDCCH CSS 2818 including two symbols. The DCI may be transmitted and received through the same AL, the same PDCCH candidate index, and the same DCI formats in each of the PDCCHs 2816 and 2818. As another example, the UE may identify first Type 0 PDCCH CSS resources allocated to consecutive two slots through the specific SS/PBCH index search and may determine that DCI including the same information is transmitted and received through each of the first Type 0 PDCCH CSS 2818 including two symbols and a first Type 0 PDCCH CSS 2820 including two symbols. The DCI may be transmitted and received through the same AL, the same PDCCH candidate index, and the same DCI formats in each of the PDCCHs 2818 and 2820.
Method 2-6: It is similar to method 2-5, but PDCCHs including the same DCI may be received through two first Type 0 PDCCH CSSs configured within the same slot. For example, when the UE receives the SS/PBCH and one of 1, 3, 5, and 7 is indicated as an index value in [Table 46] through information of the MIB, two first Type 0 PDCCH CSSs may be configured within a single slot. Here, the UE may determine that DCI including the same information is transmitted and received through each of the two first Type 0 PDCCH CSS.

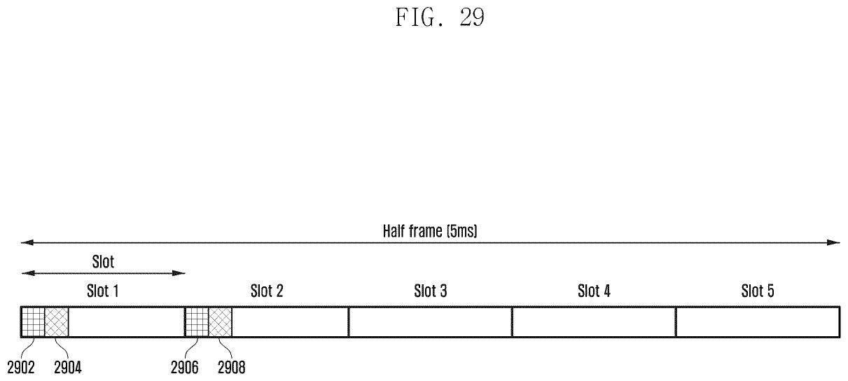

FIG. 29 illustrates PDCCH repetition transmission according to an embodiment of the disclosure. The UE may determine that a first Type 0 PDCCH CSS are transmitted in each of PDCCH 2902, 2904 of slot 1 and PDCCH 2906, 2908 of slot 2 through specific SS/PBCH index search. In this situation, the UE may determine that the same DCI is transmitted and received through each of the PDCCHs 2902 and 2904 of slot 1. Alternatively, the UE may determine that the same DCI is transmitted and received through each of the PDCCHs 2906 and 2908 of slot 2. The DCI may be transmitted and received through the same AL, the same PDCCH candidate index, and the same DCI formats in each of the PDCCHs 2902 and 2904 (or 2906 and 2908). This method may be applied only in a situation in which at least Rp values 1, 3, 5, and 7 in [Table 46] is applied through information of the MIB for [symbol] PDCCH repetition.
Method 2-7: Similar to method 2-4, PDCCHs including the same DCI may be received through the first Type 0 PDCCH CSS and the additional second Type 0 PDCCH CSS. For example, when the UE receives an SS/PBCH and at least one of index values 8 and 9 in [Table 46] is indicated through information of the MIB, the UE may configure a single first Type 0 PDCCH CSS in a single slot and then configure a single additional second Type 0 PDCCH CSS in a next slot.

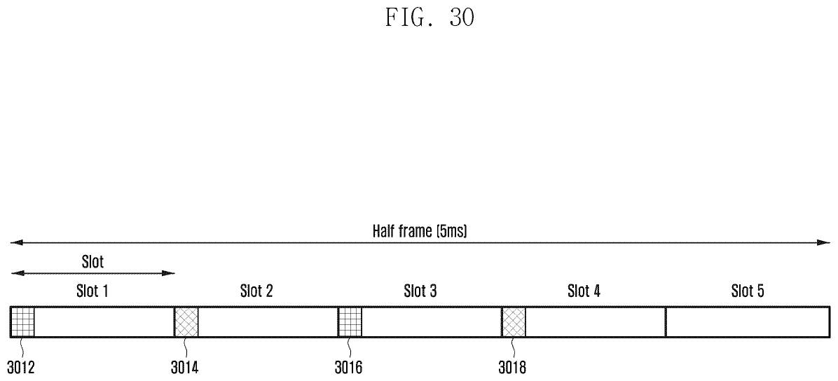

FIG. 30 illustrates PDCCH repetition transmission according to an embodiment of the disclosure. The UE may determine that DCI is transmitted and received in each of a first Type 0 PDCCH CSS 3012 of slot 1 and a second Type 0 PDCCH CSS 3014 of slot 2 through specific SS/PBCH index search. Alternatively, the UE may determine that DCI is transmitted and received in each of a first Type 0 PDCCH CSS 3016 of slot 3 and a second Type 0 PDCCH CSS 3018 of slot 4, through the specific SS/PBCH index search. In this situation, the UE may determine that the same DCI is transmitted and received through each of the PDCCHs 3012 and 3014. Alternatively, the UE may determine that the same DCI is transmitted and received through each of the PDCCHs 3016 and 3018. The DCI may be transmitted and received through the same AL, the same PDCCH candidate index, and the same DCI formats in each of the PDCCHs 3012 and 3014 (or 3016 and 3018). This method may be applied only in a situation at least one of index values 8 and 9 in [Table 46] is applied through information of the MIB for PDCCH repetition.

The above-described second Type 0 PDCCH CSS may have the same frequency resource, the same number of PDCCH candidates for each AL, and the same DCI format type and number as those of the first Type 0 PDCCH CSS, with having different transmission time resources. The first Type 0 PDCCH CSS is a resource area configured through Equation 10 and Equation 11. The second Type 0 PDCCH CSS is a CSS determined through at least one of the methods described above or some combinations thereof. When the UE receives DCI including the same information through a plurality of Type 0 PDCCH CSSs, the UE may perform demodulation/decoding through combining.

Also, although the above-described methods are described mainly based on the Type 0 PDCCH CSS, they may be expanded and applied to the Type OA PDCCH CSS, the Type 1 PDCCH CSS, or the Type 2 PDCCH CSS. For example, when providing specific search space-related configuration through the SIB, the UE may determine whether the PDCCH repetition is supported in consideration of at least one of the methods through a higher signal parameter indicating whether the PDCCH repetition is supported.

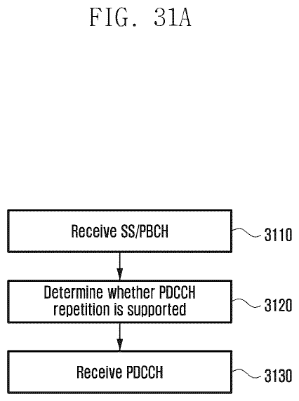

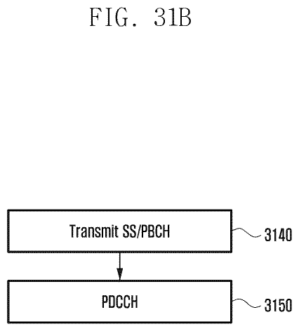

FIG. 31A is a UE flowchart for performing PDCCH repetition reception according to an embodiment of the disclosure.

In operation 3110, a UE may receive an SS/PBCH.

In operation 3120, the UE may determine whether the PDCCH repetition is supported through at least one of the methods described in the first embodiment or some combinations thereof. For example, the UE may determine whether the PDCCH repetition is supported based on information included in an MIB received through the SS/PBCH (at least one of method 1-1 to method 1-4 or some combinations thereof), may determine whether the PDCCH repetition is supported based on the frequency band in which the UE operates (method 1-5), or may identify whether the PDCCH repetition is supported through some fields of a cell ID identified based on a received synchronization signals (PSS, SSS).

When the PDCCH repetition is applied, the UE may receive the PDCCH repetition through at least one of the methods described in the second embodiment or some combinations thereof in operation 3130. That is, the UE may perform the PDCCH repetition based on a search area of a PDCCH that is determined through at least one of the methods described in the second embodiment or some combinations thereof. Here, since DCI received from a plurality of PDCCH search space areas all contains the same information, the UE may perform demodulation/decoding through combining. Here, the DCI transmitted from each PDCCH resource area may be assumed to have the same AL, the same PDCCH candidate index, and the same DCI formats. If the PDCCH repetition is not applied, the UE receives DCI in a single PDCCH area.

The methods are mainly described by limiting to a satellite network, but may be applied to a terrestrial network.

FIG. 31B is a base station flowchart for performing PDCCH repetition transmission according to an embodiment of the disclosure.

In operation 3140, a base station may transmit an SS/PBCH to a UE. Here, the base station may configure the UE with a PDCCH repetition status to the UE through at least one of the methods described in the first embodiment or some combinations thereof. For example, the base station may configure the PDCCH repetition status based on information contained in a MIB received through the SS/PBCH (at least one of method 1-1 to method 1-4 or some combinations thereof), or may configure the PDCCH repetition status through some fields of cell ID.

In operation 3150, the base station may transmit the PDCCH repetition through at least one of the methods described in the second embodiment or some combinations thereof. That is, the base station may transmit the PDCCH repetition based on a search area of a PDCCH that is determined through at least one of the methods described in the second embodiment or some combinations thereof. Here, the DCI transmitted from each PDCCH resource area may have the same AL, the same PDCCH candidate index, and the same DCI formats. If the PDCCH repetition is not applied, the base station transmits DCI in a single PDCCH area.

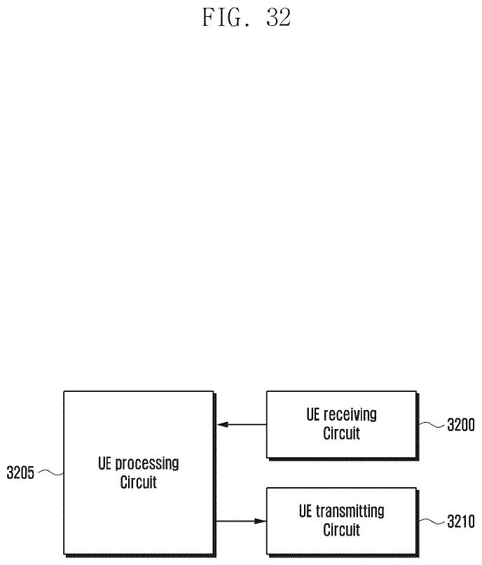

FIG. 32 is a diagram illustrating the structure of a UE in a wireless communication system according to an embodiment of the disclosure.

With reference to FIG. 32, the UE may include a transceiving unit that refers to a UE receiving circuit 3200 and a UE transmitting circuit 3210, a memory (not shown), and a UE processing circuit 3205 (or UE controller or processor). According to the communication method of the UE described above, the transceiving unit (3200, 3210), the memory, and the UE processing circuit 3205 of the UE may operate. However, the components of the UE are not limited to the above-described components. For example, the UE may include more or fewer components than the components described above. In addition, the transceiving unit, the memory, and the processor may be implemented in the form of a single chip.

The transceiving unit may transmit and receive signals to and from a base station. Here, the signal may include control information and data. To this end, the transceiving unit may include a radio frequency (RF) transmitter that up-converts and amplifies the frequency of a transmitted signal, and an RF receiver that low-noise amplifies and down-converts the frequency of a received signal. However, this is only an embodiment of the transceiving unit, and the components of the transceiving unit are not limited to the RF transmitter and the RF receiver.

Also, the transceiving unit may receive a signal through a wireless channel and output the same to the processor, and may transmit the signal output from the processor through the wireless channel.

The memory may store a program and data required to operate the UE. Also, the memory may store control information or data included in the signal transmitted or received by the UE. The memory may be configured by storage media, such as a ROM, a RAM, a hard disc, a CD-ROM, and a DVD, or a combination of the storage media. The number of memories may be plural.

Also, the processor may control a series of processes such that the UE may operate according to the above-described embodiments. For example, the processor may control each component of the UE to receive DCI including two layers and simultaneously receive a plurality of PDSCHs. The number of processors may be plural, and the processor may perform an operation of controlling the components of the UE by executing the program stored in the memory.

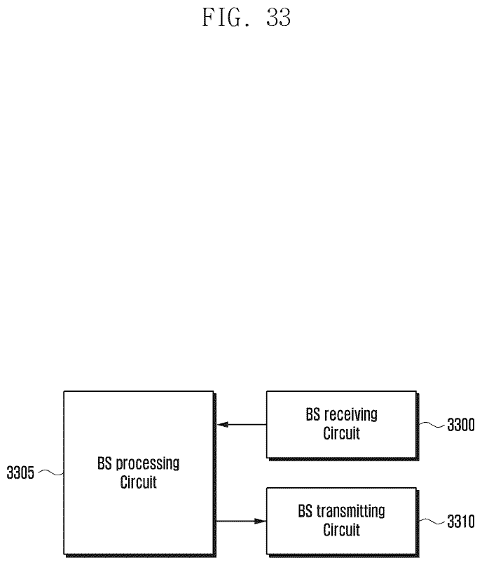

FIG. 33 is a diagram illustrating the structure of a base station in a wireless communication system according to an embodiment of the disclosure.

With reference to FIG. 33, the base station may include a transceiving unit that refers to a base station (BS) receiving circuit 3300 and a BS transmitting circuit 3310, a memory (not shown), and a BS processing circuit 3305 (or, BS controller or processor). According to the communication method of the base station described above, the transceiving unit (3300, 3310), the memory, and the BS processing circuit 3305 of the base station may operate. However, the components of the base station are not limited to the above-described examples. For example, the base station may include more or fewer components than the components described above. In addition, the transceiving unit, the memory, and the processor may be implemented in the form of a single chip.

The transceiving unit may transmit and receive signals to and from a UE. Here, the signal may include control information and data. To this end, the transceiving unit may include an RF transmitter that up-converts and amplifies the frequency of a transmitted signal, and an RF receiver that low-noise amplifies and down-converts the frequency of a received signal. However, this is only an embodiment of the transceiving unit, and the components of the transceiving unit are not limited to the RF transmitter and the RF receiver.

Also, the transceiving unit may receive a signal through a wireless channel and output the same to the processor, and may transmit the signal output from the processor through the wireless channel.

The memory may store a program and data required to operate the base station. Also, the memory may store control information or data included in the signal transmitted and received by the base station. The memory may be configured by storage media, such as a ROM, a RAM, a hard disc, a CD-ROM, and a DVD, or a combination of the storage media. The number of memories may be plural.

The processor may control a series of processes such that the base station may operate according to the embodiments of the disclosure. For example, the processor may control each component of the base station to construct and transmit DCI for each of two layers including allocation information on a plurality of PDSCHs. The number of processors may be plural, and the processor may perform an operation of controlling the components of the base station by executing the program stored in the memory.

The methods according to the embodiments described in the claims or specification of the disclosure may be implemented in the form of hardware, software, or a combination of hardware and software.

When implemented in software, a computer-readable storage medium storing one or more programs (software modules) may be provided. The one or more programs stored in the computer-readable storage medium may be configured to be executable by one or more processors within an electronic device. The one or more programs may include instructions that cause the electronic device to execute the methods according to the embodiments described in the claims or specification of the disclosure.

Such a program (software module, software) may be stored in a random access memory, a nonvolatile memory such as a flash memory, a read only memory (ROM), an electrically erasable programmable read only memory (EEPROM), a magnetic disc storage device, a compact disc ROM (CD-ROM), a digital versatile disc (DVD), other types of optical storage devices, or a magnetic cassette. Alternatively, such a program may be stored in a memory configured with a combination of some or all of them. Also, a plurality of component memories may be included.

Also, such a program may be stored in an attachable storage device that may be accessed through a communication network, such as the Internet, an intranet, a local area network (LAN), a wide LAN (WLAN), or a storage area network (SAN), or through a communication network configured with a combination thereof. Such a storage device may access the device that carries out an embodiment of the disclosure through an external port. Also, a separate storage device on a communication network may access the device that carries out an embodiment of the disclosure.

In specific embodiments of the disclosure described above, the components included in the disclosure are expressed in the singular or plural form according to the presented specific embodiment. However, the singular or plural expression is appropriately selected for ease of description according to the presented situation, and the disclosure is not limited by a single component or a plurality of components. Those components described in the plural form may be configured as a single component, and those components described in the singular form may be configured to be in the plural form.

Meanwhile, embodiments of the disclosure disclosed in this specification and drawings merely present specific examples to easily describe the technical content of the disclosure and to help understanding of the disclosure, and are not intended to limit the scope of the disclosure. That is, it will be apparent to one of ordinary skill in the art to which the disclosure pertains that other modification examples based on the technical spirit of the disclosure may be made. Also, each of the embodiments may be combined and operated if necessary. For example, portions of an embodiment and another embodiment of the disclosure may be combined to operate the base station and the UE. For example, portions of the first embodiment and the second embodiment of the disclosure may be combined to operate the base station and the UE. Also, although the embodiments are presented based on an FDD LTE system, other modification examples based on the technical spirit of the embodiment may be implemented in other systems such as a TDD LTE system and a 5G or an NR system.

Meanwhile, the order of description in the drawings that describe the method of the present disclosure does not necessarily correspond to the order of execution, and the order of precedence may be changed or executed in parallel.

Alternatively, the drawings illustrating the method of the present disclosure may omit some components and may include only some components without departing from the essence of the present disclosure.

Also, the method of the present disclosure may be implemented by combining some or all of the contents included in each embodiment without departing from the essence of the present disclosure.

Various embodiments of the disclosure are described. The above-described description of the disclosure is for examples only and the embodiments of the disclosure are not limited to the disclosed embodiments. One of ordinary skill in the art to which the disclosure pertains will understand that the disclosure may be easily modified into other specific forms without changing the technical spirit or essential features of the disclosure. The scope of the disclosure is represented by the following claims rather than the detailed description above, and all changes or modifications derived from the meaning and scope of the claims and their equivalent concepts should be interpreted as being included in the scope of the disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a communication system, the method comprising:
receiving a synchronization signal/physical broadcast channel (SS/PBCH) block including a primary synchronization signal (PSS), a secondary synchronization signal (SSS) and a physical broadcast channel (PBCH);
identifying whether physical downlink control channel (PDCCH) corresponding to type0 PDCCH common search space (CSS) is repeated based on one PBCH payload bit included in PBCH payload of the PBCH; and
monitoring the PDCCH based on the identification.

2. The method of claim 1, wherein, in case that a value of the one PBCH payload bit is 1, the PDCCH is repeated, and
wherein, in case that the value of the one PBCH payload bit is 0, the PDCCH is not repeated.

3. The method of claim 1, wherein the PBCH payload includes a₀, a₁, a₂, . . . , a_{A-1} PBCH payload bits associated with a higher layer and a_{A}, a_{A+1}, a_{A+2}, . . . , a_{A+7} PBCH payload bits associated with a physical layer, and wherein the one PBCH payload bit corresponds to a_{A+7}.

4. The method of claim 1, wherein, in case that the PDCCH is repeated, a same PDCCH candidate for aggregation level in two consecutive slots provides same information for downlink control information (DCI) with cyclic redundancy check (CRC) scrambled by a system information radio network temporary identifier (SI-RNTI).

5. The method of claim 1, wherein the PDCCH is received in a non-terrestrial network (NTN).

6. A user equipment (UE) in a communication system, the UE comprising:
a transceiver; and
a processor coupled with the transceiver and configured to:
receive a synchronization signal/physical broadcast channel (SS/PBCH) block including a primary synchronization signal (PSS), a secondary synchronization signal (SSS) and a physical broadcast channel (PBCH);
identify whether physical downlink control channel (PDCCH) corresponding to type0 PDCCH common search space (CSS) is repeated based on one PBCH payload bit included in PBCH payload of the PBCH; and
monitor the PDCCH based on the identification.

7. The UE of claim 6, wherein, in case that a value of the one PBCH payload bit is 1, the PDCCH is repeated, and wherein, in case that the value of the one PBCH payload bit is 0, the PDCCH is not repeated.

8. The UE of claim 6, wherein the PBCH payload includes a₀, a₁, a₂, . . . , a_{A-1} PBCH payload bits associated with a higher layer and a_{A}, a_{A+1}, a_{A+2}, . . . , a_{A+7} PBCH payload bits associated with a physical layer, and wherein the one PBCH payload bit corresponds to a_{A+7}.

9. The UE of claim 6, wherein, in case that the PDCCH is repeated, a same PDCCH candidate for aggregation level in two consecutive slots provides same information for downlink control information (DCI) with cyclic redundancy check (CRC) scrambled by a system information radio network temporary identifier (SI-RNTI).

10. The UE of claim 6, wherein the PDCCH is received in a non-terrestrial network (NTN).

11. A method performed by a base station in a communication system, the method comprising:
transmitting a synchronization signal/physical broadcast channel (SS/PBCH) block including a primary synchronization signal (PSS), a secondary synchronization signal (SSS) and a physical broadcast channel (PBCH), wherein one PBCH payload bit included in PBCH payload of the PBCH indicates whether physical downlink control channel (PDCCH) corresponding to type0 PDCCH common search space (CSS) is repeated; and
transmitting the PDCCH.

12. The method of claim 11, wherein, in case that a value of the one PBCH payload bit is 1, the PDCCH is repeated, and
wherein, in case that the value of the one PBCH payload bit is 0, the PDCCH is not repeated.

13. The method of claim 11, wherein the PBCH payload includes a₀, a₁, a₂, . . . , a_{A-1} PBCH payload bits associated with a higher layer and a_{A}, a_{A+1}, a_{A+2}, . . . , a_{A+7} PBCH payload bits associated with a physical layer, and
wherein the one PBCH payload bit corresponds to a_{A+7}.

14. The method of claim 11, wherein, in case that the PDCCH is repeated, a same PDCCH candidate for aggregation level in two consecutive slots provides same information for downlink control information (DCI) with cyclic redundancy check (CRC) scrambled by a system information radio network temporary identifier (SI-RNTI).

15. The method of claim 11, wherein the PDCCH is transmitted in a non-terrestrial network (NTN).

16. A base station in a communication system, the base station comprising:
a transceiver; and
a processor coupled with the transceiver and configured to:
transmit a synchronization signal/physical broadcast channel (SS/PBCH) block including a primary synchronization signal (PSS), a secondary synchronization signal (SSS) and a physical broadcast channel (PBCH), wherein one PBCH payload bit included in PBCH payload of the PBCH indicates whether physical downlink control channel (PDCCH) corresponding to type0 PDCCH common search space (CSS) is repeated; and
transmit the PDCCH.

17. The base station of claim 16, wherein, in case that a value of the one PBCH payload bit is 1, the PDCCH is repeated, and wherein, in case that the value of the one PBCH payload bit is 0, the PDCCH is not repeated.

18. The base station of claim 16, wherein the PBCH payload includes a₀, a₁, a₂, . . . a_{A-1} PBCH payload bits associated with a higher layer and a_{A}, a_{A+1}, a_{A+2}, . . . , a_{A+7} PBCH payload bits associated with a physical layer, and
wherein the one PBCH payload bit corresponds to a_{A+7}.

19. The base station of claim 16, wherein, in case that the PDCCH is repeated, a same PDCCH candidate for aggregation level in two consecutive slots provides same information for downlink control information (DCI) with cyclic redundancy check (CRC) scrambled by a system information radio network temporary identifier (SI-RNTI).

20. The base station of claim 16, wherein the PDCCH is transmitted in a non-terrestrial network (NTN).
